(19) United States
(12) Patent Application Publication
(10) Pub. No.: US 2014/0006305 A1
(43) Pub. Date: Jan. 2, 2014

(54) Consistent Interface for Confirmed Inbound Delivery

(71) Applicants: Stephan Hetzer, Oestringen-Eichelberg (DE); Amit Yaniv, Zoran (IL); Zoya Pronyakova, Ra'anana (IL); Alexander Krasinskiy, Sandhausen (DE)

(72) Inventors: Stephan Hetzer, Oestringen-Eichelberg (DE); Amit Yaniv, Zoran (IL); Zoya Pronyakova, Ra'anana (IL); Alexander Krasinskiy, Sandhausen (DE)

(73) Assignee: SAP AG

(21) Appl. No.: 13/535,600

(22) Filed: Jun. 28, 2012

(51) Int. Cl. G06Q 10/00

(52) U.S. Cl. 705/345

(57) ABSTRACT

A business object model, which reflects data that is used during a given business transaction, is utilized to generate interfaces. This business object model facilitates commercial transactions by providing consistent interfaces that are suitable for use across industries, across businesses, and across different departments within a business during a business transaction. In some operations, software creates, updates, or otherwise processes information related to a confirmed inbound delivery business object.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### CROSS-REFERENCE TO RELATED APPLICATIONS

Some details of the subject matter of this specification are described in previously-filed U.S. patent application Ser. No. 11/803,178, entitled “Consistent Set of Interfaces Derived From a Business Object Model”, filed on May 11, 2007, which is hereby incorporated by reference.

### TECHNICAL FIELD

The subject matter described herein relates generally to the generation and use of consistent interfaces (or services) derived from a business object model. More particularly, the present disclosure relates to the generation and use of consistent interfaces or services that are suitable for use across industries, across businesses, and across different departments within a business.

### BACKGROUND

Transactions are common among businesses and between business departments within a particular business. During any given transaction, these business entities exchange information. For example, during a sales transaction, numerous business entities may be involved, such as a sales entity that sells merchandise to a customer, a financial institution that handles the financial transaction, and a warehouse that sends the merchandise to the customer. The end-to-end business transaction may require a significant amount of information to be exchanged between the various business entities involved. For example, the customer may send a request for the merchandise as well as some form of payment authorization for the merchandise to the sales entity, and the sales entity may send the financial institution a request for a transfer of funds from the customer's account to the sales entity's account.

Exchanging information between different business entities is not a simple task. This is particularly true because the information used by different business entities is usually tightly tied to the business entity itself. Each business entity may have its own program for handling its part of the transaction. These programs differ from each other because they typically are created for different purposes and because each business entity may use semantics that differ from the other business entities. For example, one program may relate to accounting, another program may relate to manufacturing, and a third program may relate to inventory control. Similarly, one program may identify merchandise using the name of the product while another program may identify the same merchandise using its model number. Further, one business entity may use U.S. dollars to represent its currency while another business entity may use Japanese Yen. A simple difference in formatting, e.g., the use of upper-case lettering rather than lower-case or title-case, makes the exchange of information between businesses a difficult task. Unless the individual businesses agree upon particular semantics, human interaction typically is required to facilitate transactions between these businesses. Because these “heterogeneous” programs are used by different companies or by different business areas within a given company, a need exists for a consistent way to exchange information and perform a business transaction between the different business entities.

Currently, many standards exist that offer a variety of interfaces used to exchange business information. Most of these interfaces, however, apply to only one specific industry and are not consistent between the different standards. Moreover, a number of these interfaces are not consistent within an individual standard.

### SUMMARY

In a first aspect, a computer-readable medium includes program code for providing a message-based interface for exchanging information about confirmation of goods received. The medium comprises program code for receiving, via a message-based interface exposing at least one service as defined in a service registry and from a heterogeneous application executing in an environment of computer systems providing message-based services, a first message for providing a confirmation by a warehouse provider of goods received. The first message includes a message package hierarchically organized as an inbound delivery execution confirmation message entity and an inbound delivery execution package including an inbound delivery execution entity. The inbound delivery execution entity includes an identifier (ID), a vendor ID, a type code and a sender last change date time. The inbound delivery execution entity further includes a vendor party entity from a party package, a product recipient party entity from the party package, an arrival date time period entity from an arrival period package and at least one item entity from an item package. Each item entity includes an ID, a vendor ID, a delivery quantity and a delivery quantity type code. Each item entity further includes a product entity from a product information package. The medium further comprises program code for sending a second message to the heterogeneous application responsive to the first message.

Implementations can include the following. The inbound delivery execution entity further includes at least one of the following: a freight forwarder party entity from the party package, a ship to location entity from a location package, a text collection entity from a text collection package, an attachment folder entity from an attachment folder package, and at least one material entity from a product information package. The inbound delivery execution entity further includes at least one of the following: international commercial terms (Incoterms), a gross volume measure, and a gross weight measure.

In another aspect, a distributed system operates in a landscape of computer systems providing message-based services defined in a service registry. The system comprises a graphical user interface comprising computer readable instructions, embedded on tangible media, for providing a confirmation by a warehouse provider of goods received, the instructions using a request. The system further comprises a first memory storing a user interface controller for processing the request and involving a message including a message package hierarchically organized as an inbound delivery execution confirmation message entity and an inbound delivery execution package including an inbound delivery execution entity. The inbound delivery execution entity includes an identifier (ID), a vendor ID, a type code and a sender last change date time. The inbound delivery execution entity further includes a vendor party entity from a party package, a product recipient party entity from the party package, an arrival date time period entity from an arrival period package and at least one item entity from an item package. Each item entity includes an ID, a vendor ID, a delivery quantity and a delivery quantity type code. Each item entity further includes a product entity from a product information package. The system further comprises a second memory, remote from the graphical user interface, storing a plurality of service interfaces, wherein one of the service interfaces is operable to process the message via the service interface.

Implementations can include the following. The first memory is remote from the graphical user interface. The first memory is remote from the second memory.

### BRIEF DESCRIPTION OF THE DRAWINGS

FIG. 1 depicts a flow diagram of the overall steps performed by methods and systems consistent with the subject matter described herein.

FIG. 2 depicts a business document flow for an invoice request in accordance with methods and systems consistent with the subject matter described herein.

FIGS. 3A-B illustrate example environments implementing the transmission, receipt, and processing of data between heterogeneous applications in accordance with certain embodiments included in the present disclosure.

FIG. 4 illustrates an example application implementing certain techniques and components in accordance with one embodiment of the system of FIG. 1.

FIG. 5A depicts an example development environment in accordance with one embodiment of FIG. 1.

FIG. 5B depicts a simplified process for mapping a model representation to a runtime representation using the example development environment of FIG. 5A or some other development environment.

FIG. 6 depicts message categories in accordance with methods and systems consistent with the subject matter described herein.

FIG. 7 depicts an example of a package in accordance with methods and systems consistent with the subject matter described herein.

FIG. 8 depicts another example of a package in accordance with methods and systems consistent with the subject matter described herein.

FIG. 9 depicts a third example of a package in accordance with methods and systems consistent with the subject matter described herein.

FIG. 10 depicts a fourth example of a package in accordance with methods and systems consistent with the subject matter described herein.

FIG. 11 depicts the representation of a package in the XML schema in accordance with methods and systems consistent with the subject matter described herein.

FIG. 12 depicts a graphical representation of cardinalities between two entities in accordance with methods and systems consistent with the subject matter described herein.

FIG. 13 depicts an example of a composition in accordance with methods and systems consistent with the subject matter described herein.

FIG. 14 depicts an example of a hierarchical relationship in accordance with methods and systems consistent with the subject matter described herein.

FIG. 15 depicts an example of an aggregating relationship in accordance with methods and systems consistent with the subject matter described herein.

FIG. 16 depicts an example of an association in accordance with methods and systems consistent with the subject matter described herein.

FIG. 17 depicts an example of a specialization in accordance with methods and systems consistent with the subject matter described herein.

FIG. 18 depicts the categories of specializations in accordance with methods and systems consistent with the subject matter described herein.

FIG. 19 depicts an example of a hierarchy in accordance with methods and systems consistent with the subject matter described herein.

FIG. 20 depicts a graphical representation of a hierarchy in accordance with methods and systems consistent with the subject matter described herein.

FIGS. 21A-B depict a flow diagram of the steps performed to create a business object model in accordance with methods and systems consistent with the subject matter described herein.

FIGS. 22A-F depict a flow diagram of the steps performed to generate an interface from the business object model in accordance with methods and systems consistent with the subject matter described herein.

FIG. 23 depicts an example illustrating the transmittal of a business document in accordance with methods and systems consistent with the subject matter described herein.

FIG. 24 depicts an interface proxy in accordance with methods and systems consistent with the subject matter described herein.

FIG. 25 depicts an example illustrating the transmittal of a message using proxies in accordance with methods and systems consistent with the subject matter described herein.

FIG. 26A depicts components of a message in accordance with methods and systems consistent with the subject matter described herein.

FIG. 26B depicts IDs used in a message in accordance with methods and systems consistent with the subject matter described herein.

FIGS. 27A-E depict a hierarchization process in accordance with methods and systems consistent with the subject matter described herein.

FIG. 28 illustrates an example method for service enabling in accordance with one embodiment of the present disclosure.

FIG. 29 is a graphical illustration of an example business object and associated components as may be used in the enterprise service infrastructure system of the present disclosure.

FIG. 30 illustrates an example method for managing a process agent framework in accordance with one embodiment of the present disclosure.

FIG. 31 illustrates an example method for status and action management in accordance with one embodiment of the present disclosure.

FIG. 32 depicts an example Inbound Delivery Execution Confirmation message data type.

FIGS. 33-1 through 33-8 collectively depict an example Inbound Delivery Execution Confirmation element structure.

FIGS. 34-1 through 34-6 collectively depict an example Confirmed Inbound Delivery object model.

### DETAILED DESCRIPTION

A. Overview

Methods and systems consistent with the subject matter described herein facilitate e-commerce by providing consistent interfaces that are suitable for use across industries, across businesses, and across different departments within a business during a business transaction. To generate consistent interfaces, methods and systems consistent with the subject matter described herein utilize a business object model, which reflects the data that will be used during a given business transaction. An example of a business transaction is the exchange of purchase orders and order confirmations between a buyer and a seller. The business object model is generated in a hierarchical manner to ensure that the same type of data is represented the same way throughout the business object model. This ensures the consistency of the information in the business object model. Consistency is also reflected in the semantic meaning of the various structural elements. That is, each structural element has a consistent business meaning. For example, the location entity, regardless of in which package it is located, refers to a location.

From this business object model, various interfaces are derived to accomplish the functionality of the business transaction. Interfaces provide an entry point for components to access the functionality of an application. For example, the interface for a Purchase Order Request provides an entry point for components to access the functionality of a Purchase Order, in particular, to transmit and/or receive a Purchase Order Request. One skilled in the art will recognize that each of these interfaces may be provided, sold, distributed, utilized, or marketed as a separate product or as a major component of a separate product. Alternatively, a group of related interfaces may be provided, sold, distributed, utilized, or marketed as a product or as a major component of a separate product. Because the interfaces are generated from the business object model, the information in the interfaces is consistent, and the interfaces are consistent among the business entities. Such consistency facilitates heterogeneous business entities in cooperating to accomplish the business transaction.

Generally, the business object is a representation of a type of a uniquely identifiable business entity (an object instance) described by a structural model. In the architecture, processes may typically operate on business objects. Business objects represent a specific view on some well-defined business content. In other words, business objects represent content, which a typical business user would expect and understand with little explanation. Business objects are further categorized as business process objects and master data objects. A master data object is an object that encapsulates master data (i.e., data that is valid for a period of time). A business process object, which is the kind of business object generally found in a process component, is an object that encapsulates transactional data (i.e., data that is valid for a point in time). The term business object will be used generically to refer to a business process object and a master data object, unless the context requires otherwise. Properly implemented, business objects are implemented free of redundancies.

The architectural elements also include the process component. The process component is a software package that realizes a business process and generally exposes its functionality as services. The functionality contains business transactions. In general, the process component contains one or more semantically related business objects. Often, a particular business object belongs to no more than one process component. Interactions between process component pairs involving their respective business objects, process agents, operations, interfaces, and messages are described as process component interactions, which generally determine the interactions of a pair of process components across a deployment unit boundary. Interactions between process components within a deployment unit are typically not constrained by the architectural design and can be implemented in any convenient fashion. Process components may be modular and context-independent. In other words, process components may not be specific to any particular application and as such, may be reusable. In some implementations, the process component is the smallest (most granular) element of reuse in the architecture. An external process component is generally used to represent the external system in describing interactions with the external system; however, this should be understood to require no more of the external system than that able to produce and receive messages as required by the process component that interacts with the external system. For example, process components may include multiple operations that may provide interaction with the external system. Each operation generally belongs to one type of process component in the architecture. Operations can be synchronous or asynchronous, corresponding to synchronous or asynchronous process agents, which will be described below. The operation is often the smallest, separately-callable function, described by a set of data types used as input, output, and fault parameters serving as a signature.

The architectural elements may also include the service interface, referred to simply as the interface. The interface is a named group of operations. The interface often belongs to one process component and process component might contain multiple interfaces. In one implementation, the service interface contains only inbound or outbound operations, but not a mixture of both. One interface can contain both synchronous and asynchronous operations. Normally, operations of the same type (either inbound or outbound) which belong to the same message choreography will belong to the same interface. Thus, generally, all outbound operations to the same other process component are in one interface.

The architectural elements also include the message. Operations transmit and receive messages. Any convenient messaging infrastructure can be used. A message is information conveyed from one process component instance to another, with the expectation that activity will ensue. Operation can use multiple message types for inbound, outbound, or error messages. When two process components are in different deployment units, invocation of an operation of one process component by the other process component is accomplished by the operation on the other process component sending a message to the first process component.

The architectural elements may also include the process agent. Process agents do business processing that involves the sending or receiving of messages. Each operation normally has at least one associated process agent. Each process agent can be associated with one or more operations. Process agents can be either inbound or outbound and either synchronous or asynchronous. Asynchronous outbound process agents are called after a business object changes such as after a “create”, “update”, or “delete” of a business object instance. Synchronous outbound process agents are generally triggered directly by business object. An outbound process agent will generally perform some processing of the data of the business object instance whose change triggered the event. The outbound agent triggers subsequent business process steps by sending messages using well-defined outbound services to another process component, which generally will be in another deployment unit, or to an external system. The outbound process agent is linked to the one business object that triggers the agent, but it is sent not to another business object but rather to another process component. Thus, the outbound process agent can be implemented without knowledge of the exact business object design of the recipient process component. Alternatively, the process agent may be inbound. For example, inbound process agents may be used for the inbound part of a message-based communication. Inbound process agents are called after a message has been received. The inbound process agent starts the execution of the business process step requested in a message by creating or updating one or multiple business object instances. Inbound process agent is not generally the agent of business object but of its process component. Inbound process agent can act on multiple business objects in a process component. Regardless of whether the process agent is inbound or outbound, an agent may be synchronous if used when a process component requires a more or less immediate response from another process component, and is waiting for that response to continue its work.

The architectural elements also include the deployment unit. Each deployment unit may include one or more process components that are generally deployed together on a single computer system platform. Conversely, separate deployment units can be deployed on separate physical computing systems. The process components of one deployment unit can interact with those of another deployment unit using messages passed through one or more data communication networks or other suitable communication channels. Thus, a deployment unit deployed on a platform belonging to one business can interact with a deployment unit software entity deployed on a separate platform belonging to a different and unrelated business, allowing for business-to-business communication. More than one instance of a given deployment unit can execute at the same time, on the same computing system or on separate physical computing systems. This arrangement allows the functionality offered by the deployment unit to be scaled to meet demand by creating as many instances as needed.

Since interaction between deployment units is through process component operations, one deployment unit can be replaced by other another deployment unit as long as the new deployment unit supports the operations depended upon by other deployment units as appropriate. Thus, while deployment units can depend on the external interfaces of process components in other deployment units, deployment units are not dependent on process component interaction within other deployment units. Similarly, process components that interact with other process components or external systems only through messages, e.g., as sent and received by operations, can also be replaced as long as the replacement generally supports the operations of the original.

Services (or interfaces) may be provided in a flexible architecture to support varying criteria between services and systems. The flexible architecture may generally be provided by a service delivery business object. The system may be able to schedule a service asynchronously as necessary, or on a regular basis. Services may be planned according to a schedule manually or automatically. For example, a follow-up service may be scheduled automatically upon completing an initial service. In addition, flexible execution periods may be possible (e.g. hourly, daily, every three months, etc.). Each customer may plan the services on demand or reschedule service execution upon request.

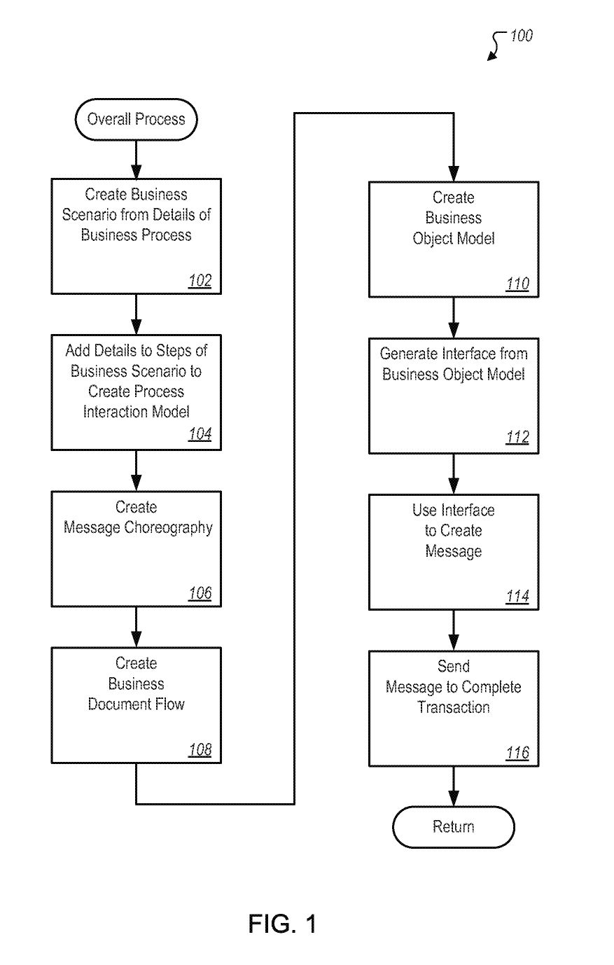

FIG. 1 depicts a flow diagram 100 showing an example technique, perhaps implemented by systems similar to those disclosed herein. Initially, to generate the business object model, design engineers study the details of a business process, and model the business process using a “business scenario” (step 102). The business scenario identifies the steps performed by the different business entities during a business process. Thus, the business scenario is a complete representation of a clearly defined business process.

After creating the business scenario, the developers add details to each step of the business scenario (step 104). In particular, for each step of the business scenario, the developers identify the complete process steps performed by each business entity. A discrete portion of the business scenario reflects a “business transaction,” and each business entity is referred to as a “component” of the business transaction. The developers also identify the messages that are transmitted between the components. A “process interaction model” represents the complete process steps between two components.

After creating the process interaction model, the developers create a “message choreography” (step 106), which depicts the messages transmitted between the two components in the process interaction model. The developers then represent the transmission of the messages between the components during a business process in a “business document flow” (step 108). Thus, the business document flow illustrates the flow of information between the business entities during a business process.

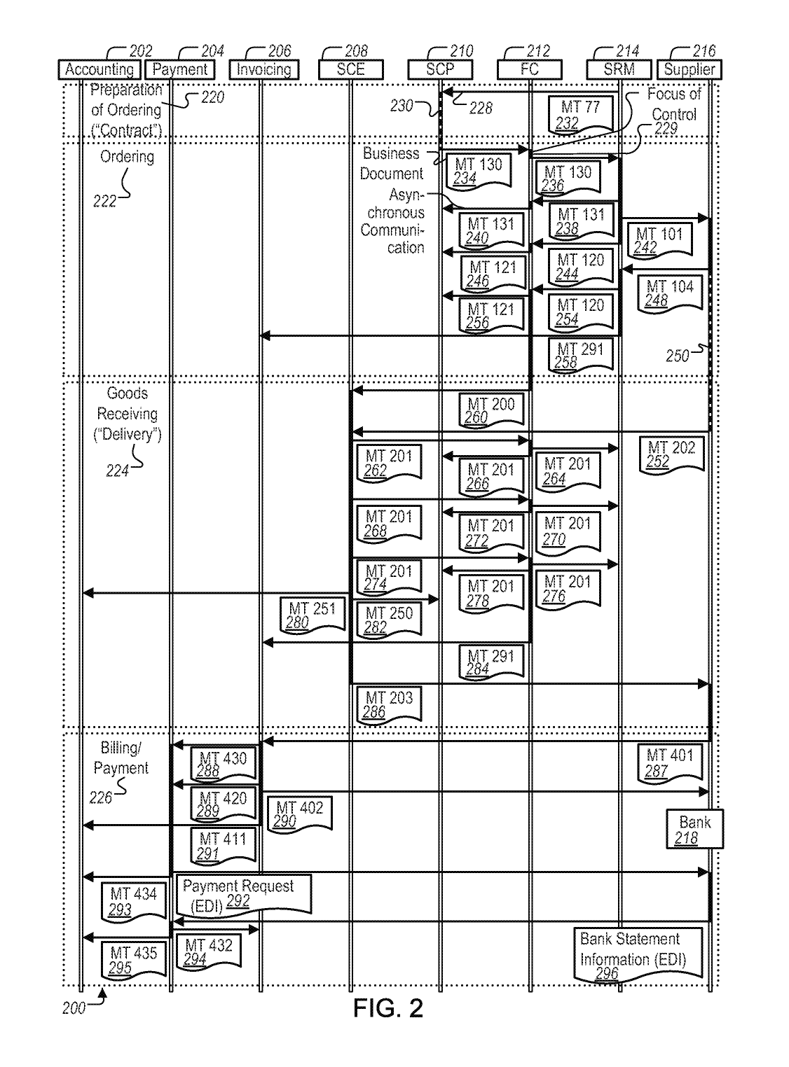

FIG. 2 depicts an example business document flow 200 for the process of purchasing a product or service. The business entities involved with the illustrative purchase process include Accounting 202, Payment 204, Invoicing 206, Supply Chain Execution (“SCE”) 208, Supply Chain Planning (“SCP”) 210, Fulfillment Coordination (“FC”) 212, Supply Relationship Management (“SRM”) 214, Supplier 216, and Bank 218. The business document flow 200 is divided into four different transactions: Preparation of Ordering (“Contract”) 220, Ordering 222, Goods Receiving (“Delivery”) 224, and Billing/Payment 226. In the business document flow, arrows 228 represent the transmittal of documents. Each document reflects a message transmitted between entities. One of ordinary skill in the art will appreciate that the messages transferred may be considered to be a communications protocol. The process flow follows the focus of control, which is depicted as a solid vertical line (e.g., 229) when the step is required, and a dotted vertical line (e.g., 230) when the step is optional.

During the Contract transaction 220, the SRM 214 sends a Source of Supply Notification 232 to the SCP 210. This step is optional, as illustrated by the optional control line 230 coupling this step to the remainder of the business document flow 200. During the Ordering transaction 222, the SCP 210 sends a Purchase Requirement Request 234 to the FC 212, which forwards a Purchase Requirement Request 236 to the SRM 214. The SRM 214 then sends a Purchase Requirement Confirmation 238 to the FC 212, and the FC 212 sends a Purchase Requirement Confirmation 240 to the SCP 210. The SRM 214 also sends a Purchase Order Request 242 to the Supplier 216, and sends Purchase Order Information 244 to the FC 212. The FC 212 then sends a Purchase Order Planning Notification 246 to the SCP 210. The Supplier 216, after receiving the Purchase Order Request 242, sends a Purchase Order Confirmation 248 to the SRM 214, which sends a Purchase Order Information confirmation message 254 to the FC 212, which sends a message 256 confirming the Purchase Order Planning Notification to the SCP 210. The SRM 214 then sends an Invoice Due Notification 258 to Invoicing 206.

During the Delivery transaction 224, the FC 212 sends a Delivery Execution Request 260 to the SCE 208. The Supplier 216 could optionally (illustrated at control line 250) send a Dispatched Delivery Notification 252 to the SCE 208. The SCE 208 then sends a message 262 to the FC 212 notifying the FC 212 that the request for the Delivery Information was created. The FC 212 then sends a message 264 notifying the SRM 214 that the request for the Delivery Information was created. The FC 212 also sends a message 266 notifying the SCP 210 that the request for the Delivery Information was created. The SCE 208 sends a message 268 to the FC 212 when the goods have been set aside for delivery. The FC 212 sends a message 270 to the SRM 214 when the goods have been set aside for delivery. The FC 212 also sends a message 272 to the SCP 210 when the goods have been set aside for delivery.

The SCE 208 sends a message 274 to the FC 212 when the goods have been delivered. The FC 212 then sends a message 276 to the SRM 214 indicating that the goods have been delivered, and sends a message 278 to the SCP 210 indicating that the goods have been delivered. The SCE 208 then sends an Inventory Change Accounting Notification 280 to Accounting 202, and an Inventory Change Notification 282 to the SCP 210. The FC 212 sends an Invoice Due Notification 284 to Invoicing 206, and SCE 208 sends a Received Delivery Notification 286 to the Supplier 216.

During the Billing/Payment transaction 226, the Supplier 216 sends an Invoice Request 287 to Invoicing 206. Invoicing 206 then sends a Payment Due Notification 288 to Payment 204, a Tax Due Notification 289 to Payment 204, an Invoice Confirmation 290 to the Supplier 216, and an Invoice Accounting Notification 291 to Accounting 202. Payment 204 sends a Payment Request 292 to the Bank 218, and a Payment Requested Accounting Notification 293 to Accounting 202. Bank 218 sends a Bank Statement Information 296 to Payment 204. Payment 204 then sends a Payment Done Information 294 to Invoicing 206 and a Payment Done Accounting Notification 295 to Accounting 202.

Within a business document flow, business documents having the same or similar structures are marked. For example, in the business document flow 200 depicted in FIG. 2, Purchase Requirement Requests 234, 236 and Purchase Requirement Confirmations 238, 240 have the same structures. Thus, each of these business documents is marked with an “O6.” Similarly, Purchase Order Request 242 and Purchase Order Confirmation 248 have the same structures. Thus, both documents are marked with an “O1.” Each business document or message is based on a message type.

From the business document flow, the developers identify the business documents having identical or similar structures, and use these business documents to create the business object model (step 110). The business object model includes the objects contained within the business documents. These objects are reflected as packages containing related information, and are arranged in a hierarchical structure within the business object model, as discussed below.

Methods and systems consistent with the subject matter described herein then generate interfaces from the business object model (step 112). The heterogeneous programs use instantiations of these interfaces (called “business document objects” below) to create messages (step 114), which are sent to complete the business transaction (step 116). Business entities use these messages to exchange information with other business entities during an end-to-end business transaction. Since the business object model is shared by heterogeneous programs, the interfaces are consistent among these programs. The heterogeneous programs use these consistent interfaces to communicate in a consistent manner, thus facilitating the business transactions.

Standardized Business-to-Business (“B2B”) messages are compliant with at least one of the e-business standards (i.e., they include the business-relevant fields of the standard). The e-business standards include, for example, RosettaNet for the high-tech industry, Chemical Industry Data Exchange (“CIDX”), Petroleum Industry Data Exchange (“PIDX”) for the oil industry, UCCnet for trade, PapiNet for the paper industry, Odette for the automotive industry, HR-XML for human resources, and XML Common Business Library (“xCBL”). Thus, B2B messages enable simple integration of components in heterogeneous system landscapes. Application-to-Application (“A2A”) messages often exceed the standards and thus may provide the benefit of the full functionality of application components. Although various steps of FIG. 1 were described as being performed manually, one skilled in the art will appreciate that such steps could be computer-assisted or performed entirely by a computer, including being performed by either hardware, software, or any other combination thereof.

B. Implementation Details

As discussed above, methods and systems consistent with the subject matter described herein create consistent interfaces by generating the interfaces from a business object model. Details regarding the creation of the business object model, the generation of an interface from the business object model, and the use of an interface generated from the business object model are provided below.

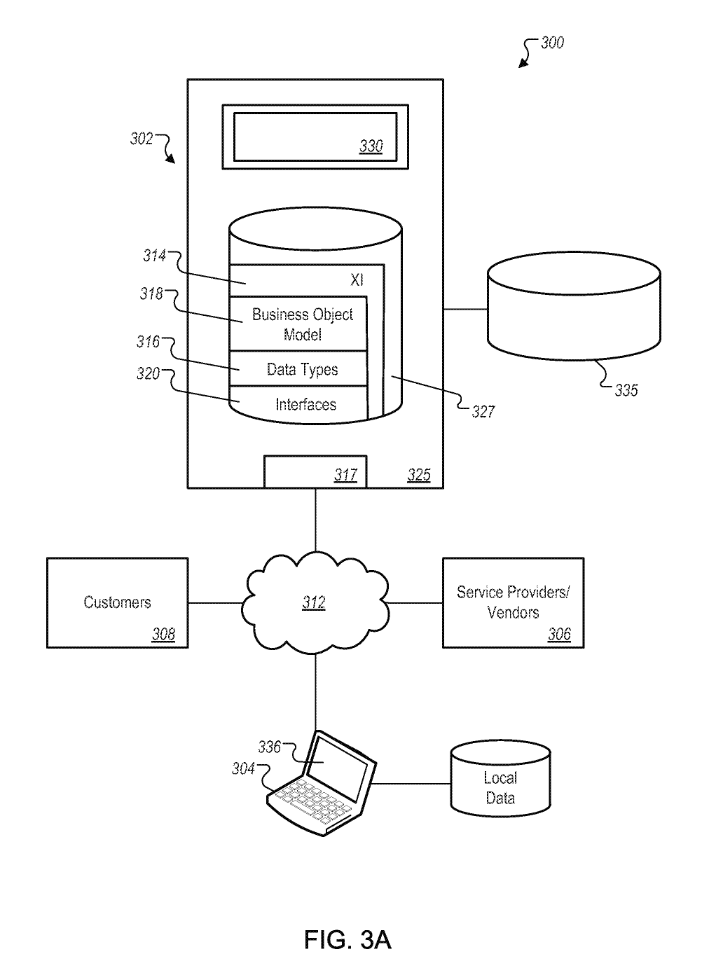

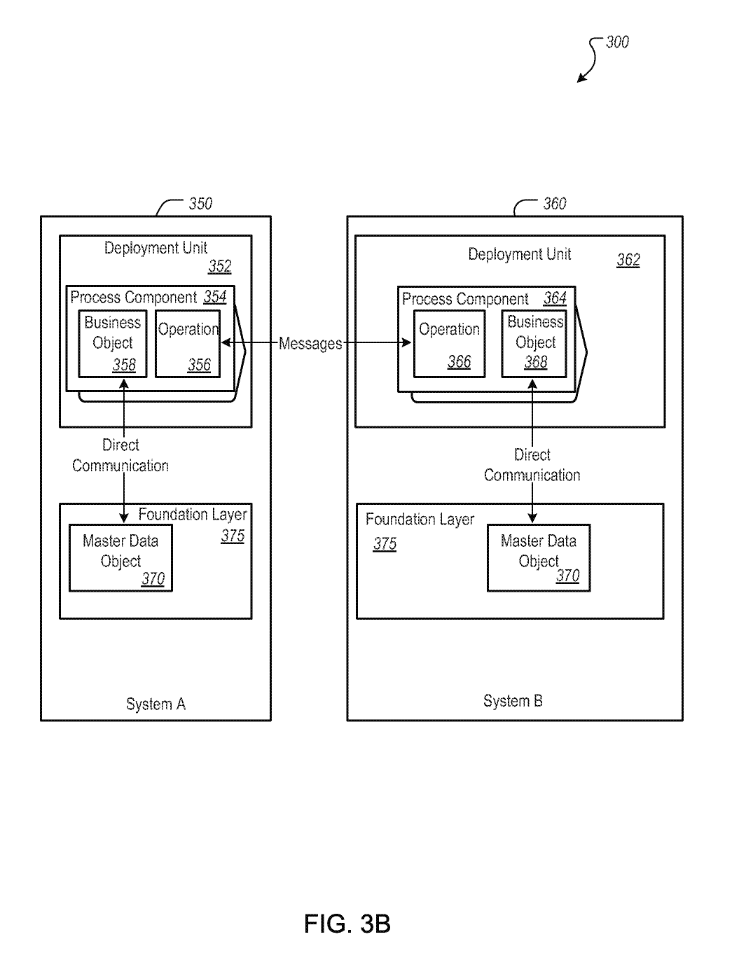

Turning to the illustrated embodiment in FIG. 3A, environment 300 includes or is communicably coupled (such as via a one-, bi- or multi-directional link or network) with server 302, one or more clients 304, one or more or vendors 306, one or more customers 308, at least some of which communicate across network 312. But, of course, this illustration is for example purposes only, and any distributed system or environment implementing one or more of the techniques described herein may be within the scope of this disclosure. Server 302 comprises an electronic computing device operable to receive, transmit, process and store data associated with environment 300. Generally, FIG. 3A provides merely one example of computers that may be used with the disclosure. Each computer is generally intended to encompass any suitable processing device. For example, although FIG. 3A illustrates one server 302 that may be used with the disclosure, environment 300 can be implemented using computers other than servers, as well as a server pool. Indeed, server 302 may be any computer or processing device such as, for example, a blade server, general-purpose personal computer (PC), Macintosh, workstation, Unix-based computer, or any other suitable device. In other words, the present disclosure contemplates computers other than general purpose computers as well as computers without conventional operating systems. Server 302 may be adapted to execute any operating system including Linux, UNIX, Windows Server, or any other suitable operating system. According to one embodiment, server 302 may also include or be communicably coupled with a web server and/or a mail server.

As illustrated (but not required), the server 302 is communicably coupled with a relatively remote repository 335 over a portion of the network 312. The repository 335 is any electronic storage facility, data processing center, or archive that may supplement or replace local memory (such as 327). The repository 335 may be a central database communicably coupled with the one or more servers 302 and the clients 304 via a virtual private network (VPN), SSH (Secure Shell) tunnel, or other secure network connection. The repository 335 may be physically or logically located at any appropriate location including in one of the example enterprises or off-shore, so long as it remains operable to store information associated with the environment 300 and communicate such data to the server 302 or at least a subset of plurality of the clients 304.

Illustrated server 302 includes local memory 327. Memory 327 may include any memory or database module and may take the form of volatile or non-volatile memory including, without limitation, magnetic media, optical media, random access memory (RAM), read-only memory (ROM), removable media, or any other suitable local or remote memory component. Illustrated memory 327 includes an exchange infrastructure (“XI”) 314, which is an infrastructure that supports the technical interaction of business processes across heterogeneous system environments. XI 314 centralizes the communication between components within a business entity and between different business entities. When appropriate, XI 314 carries out the mapping between the messages. XI 314 integrates different versions of systems implemented on different platforms (e.g., Java and ABAP). XI 314 is based on an open architecture, and makes use of open standards, such as eXtensible Markup Language (XML)™ and Java environments. XI 314 offers services that are useful in a heterogeneous and complex system landscape. In particular, XI 314 offers a runtime infrastructure for message exchange, configuration options for managing business processes and message flow, and options for transforming message contents between sender and receiver systems.

XI 314 stores data types 316, a business object model 318, and interfaces 320. The details regarding the business object model are described below. Data types 316 are the building blocks for the business object model 318. The business object model 318 is used to derive consistent interfaces 320. XI 314 allows for the exchange of information from a first company having one computer system to a second company having a second computer system over network 312 by using the standardized interfaces 320.

While not illustrated, memory 327 may also include business objects and any other appropriate data such as services, interfaces, VPN applications or services, firewall policies, a security or access log, print or other reporting files, HTML files or templates, data classes or object interfaces, child software applications or sub-systems, and others. This stored data may be stored in one or more logical or physical repositories. In some embodiments, the stored data (or pointers thereto) may be stored in one or more tables in a relational database described in terms of SQL statements or scripts. In the same or other embodiments, the stored data may also be formatted, stored, or defined as various data structures in text files, XML documents, Virtual Storage Access Method (VSAM) files, flat files, Btrieve files, comma-separated-value (CSV) files, internal variables, or one or more libraries. For example, a particular data service record may merely be a pointer to a particular piece of third party software stored remotely. In another example, a particular data service may be an internally stored software object usable by authenticated customers or internal development. In short, the stored data may comprise one table or file or a plurality of tables or files stored on one computer or across a plurality of computers in any appropriate format. Indeed, some or all of the stored data may be local or remote without departing from the scope of this disclosure and store any type of appropriate data.

Server 302 also includes processor 325. Processor 325 executes instructions and manipulates data to perform the operations of server 302 such as, for example, a central processing unit (CPU), a blade, an application specific integrated circuit (ASIC), or a field-programmable gate array (FPGA). Although FIG. 3A illustrates a single processor 325 in server 302, multiple processors 325 may be used according to particular needs and reference to processor 325 is meant to include multiple processors 325 where applicable. In the illustrated embodiment, processor 325 executes at least business application 330.

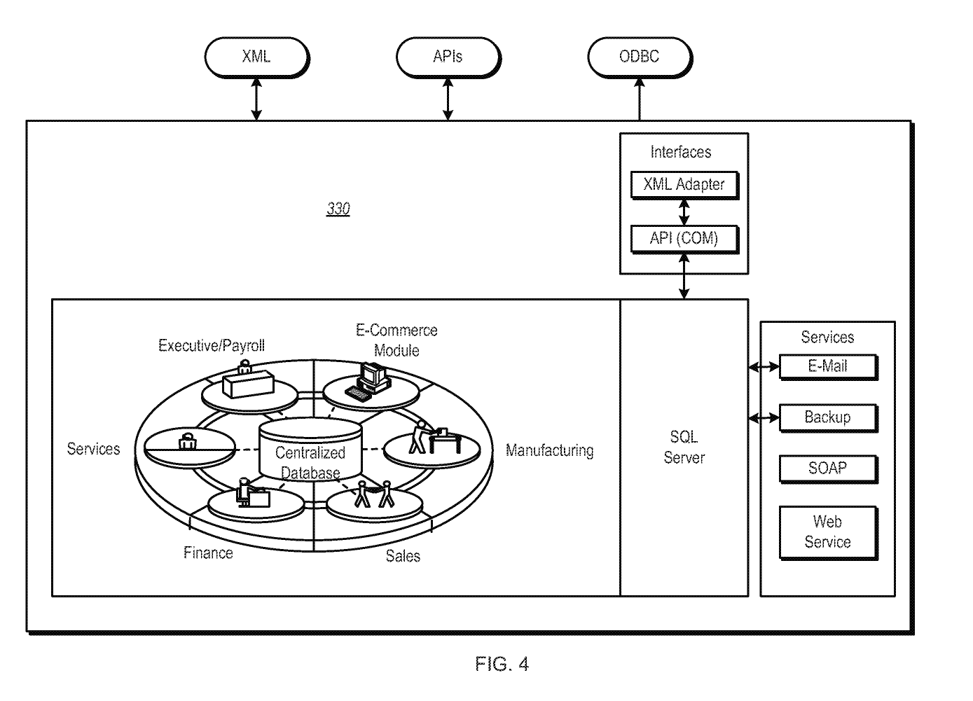

At a high level, business application 330 is any application, program, module, process, or other software that utilizes or facilitates the exchange of information via messages (or services) or the use of business objects. For example, application 330 may implement, utilize or otherwise leverage an enterprise service-oriented architecture (enterprise SOA), which may be considered a blueprint for an adaptable, flexible, and open IT architecture for developing services-based, enterprise-scale business solutions. This example enterprise service may be a series of web services combined with business logic that can be accessed and used repeatedly to support a particular business process. Aggregating web services into business-level enterprise services helps provide a more meaningful foundation for the task of automating enterprise-scale business scenarios Put simply, enterprise services help provide a holistic combination of actions that are semantically linked to complete the specific task, no matter how many cross-applications are involved. In certain cases, environment 300 may implement a composite application 330, as described below in FIG. 4. Regardless of the particular implementation, “software” may include software, firmware, wired or programmed hardware, or any combination thereof as appropriate. Indeed, application 330 may be written or described in any appropriate computer language including C, C++, Java, Visual Basic, assembler, Perl, any suitable version of 4GL, as well as others. For example, returning to the above mentioned composite application, the composite application portions may be implemented as Enterprise Java Beans (EJBs) or the design-time components may have the ability to generate run-time implementations into different platforms, such as J2EE (Java 2 Platform, Enterprise Edition), ABAP (Advanced Business Application Programming) objects, or Microsoft's .NET. It will be understood that while application 330 is illustrated in FIG. 4 as including various sub-modules, application 330 may include numerous other sub-modules or may instead be a single multi-tasked module that implements the various features and functionality through various objects, methods, or other processes. Further, while illustrated as internal to server 302, one or more processes associated with application 330 may be stored, referenced, or executed remotely. For example, a portion of application 330 may be a web service that is remotely called, while another portion of application 330 may be an interface object bundled for processing at remote client 304. Moreover, application 330 may be a child or sub-module of another software module or enterprise application (not illustrated) without departing from the scope of this disclosure. Indeed, application 330 may be a hosted solution that allows multiple related or third parties in different portions of the process to perform the respective processing.

More specifically, as illustrated in FIG. 4, application 330 may be a composite application, or an application built on other applications, that includes an object access layer (OAL) and a service layer. In this example, application 330 may execute or provide a number of application services, such as customer relationship management (CRM) systems, human resources management (HRM) systems, financial management (FM) systems, project management (PM) systems, knowledge management (KM) systems, and electronic file and mail systems. Such an object access layer is operable to exchange data with a plurality of enterprise base systems and to present the data to a composite application through a uniform interface. The example service layer is operable to provide services to the composite application. These layers may help the composite application to orchestrate a business process in synchronization with other existing processes (e.g., native processes of enterprise base systems) and leverage existing investments in the IT platform. Further, composite application 330 may run on a heterogeneous IT platform. In doing so, composite application may be cross-functional in that it may drive business processes across different applications, technologies, and organizations. Accordingly, composite application 330 may drive end-to-end business processes across heterogeneous systems or sub-systems. Application 330 may also include or be coupled with a persistence layer and one or more application system connectors. Such application system connectors enable data exchange and integration with enterprise sub-systems and may include an Enterprise Connector (EC) interface, an Internet Communication Manager/Internet Communication Framework (ICM/ICF) interface, an Encapsulated PostScript (EPS) interface, and/or other interfaces that provide Remote Function Call (RFC) capability. It will be understood that while this example describes a composite application 330, it may instead be a standalone or (relatively) simple software program. Regardless, application 330 may also perform processing automatically, which may indicate that the appropriate processing is substantially performed by at least one component of environment 300. It should be understood that automatically further contemplates any suitable administrator or other user interaction with application 330 or other components of environment 300 without departing from the scope of this disclosure.

Returning to FIG. 3A, illustrated server 302 may also include interface 317 for communicating with other computer systems, such as clients 304, over network 312 in a client-server or other distributed environment. In certain embodiments, server 302 receives data from internal or external senders through interface 317 for storage in memory 327, for storage in DB 335, and/or processing by processor 325. Generally, interface 317 comprises logic encoded in software and/or hardware in a suitable combination and operable to communicate with network 312. More specifically, interface 317 may comprise software supporting one or more communications protocols associated with communications network 312 or hardware operable to communicate physical signals.

Network 312 facilitates wireless or wireline communication between computer server 302 and any other local or remote computer, such as clients 304. Network 312 may be all or a portion of an enterprise or secured network. In another example, network 312 may be a VPN merely between server 302 and client 304 across wireline or wireless link. Such an example wireless link may be via 802.11a, 802.11b, 802.11g, 802.20, WiMax, and many others. While illustrated as a single or continuous network, network 312 may be logically divided into various sub-nets or virtual networks without departing from the scope of this disclosure, so long as at least portion of network 312 may facilitate communications between server 302 and at least one client 304. For example, server 302 may be communicably coupled to one or more “local” repositories through one sub-net while communicably coupled to a particular client 304 or “remote” repositories through another. In other words, network 312 encompasses any internal or external network, networks, sub-network, or combination thereof operable to facilitate communications between various computing components in environment 300. Network 312 may communicate, for example, Internet Protocol (IP) packets, Frame Relay frames, Asynchronous Transfer Mode (ATM) cells, voice, video, data, and other suitable information between network addresses. Network 312 may include one or more local area networks (LANs), radio access networks (RANs), metropolitan area networks (MANs), wide area networks (WANs), all or a portion of the global computer network known as the Internet, and/or any other communication system or systems at one or more locations. In certain embodiments, network 312 may be a secure network associated with the enterprise and certain local or remote vendors 306 and customers 308. As used in this disclosure, customer 308 is any person, department, organization, small business, enterprise, or any other entity that may use or request others to use environment 300. As described above, vendors 306 also may be local or remote to customer 308. Indeed, a particular vendor 306 may provide some content to business application 330, while receiving or purchasing other content (at the same or different times) as customer 308. As illustrated, customer 308 and vendor 06 each typically perform some processing (such as uploading or purchasing content) using a computer, such as client 304.

Client 304 is any computing device operable to connect or communicate with server 302 or network 312 using any communication link. For example, client 304 is intended to encompass a personal computer, touch screen terminal, workstation, network computer, kiosk, wireless data port, smart phone, personal data assistant (PDA), one or more processors within these or other devices, or any other suitable processing device used by or for the benefit of business 308, vendor 306, or some other user or entity. At a high level, each client 304 includes or executes at least GUI 336 and comprises an electronic computing device operable to receive, transmit, process and store any appropriate data associated with environment 300. It will be understood that there may be any number of clients 304 communicably coupled to server 302. Further, “client 304,” “business,” “business analyst,” “end user,” and “user” may be used interchangeably as appropriate without departing from the scope of this disclosure. Moreover, for ease of illustration, each client 304 is described in terms of being used by one user. But this disclosure contemplates that many users may use one computer or that one user may use multiple computers. For example, client 304 may be a PDA operable to wirelessly connect with external or unsecured network. In another example, client 304 may comprise a laptop that includes an input device, such as a keypad, touch screen, mouse, or other device that can accept information, and an output device that conveys information associated with the operation of server 302 or clients 304, including digital data, visual information, or GUI 336. Both the input device and output device may include fixed or removable storage media such as a magnetic computer disk, CD-ROM, or other suitable media to both receive input from and provide output to users of clients 304 through the display, namely the client portion of GUI or application interface 336.

GUI 336 comprises a graphical user interface operable to allow the user of client 304 to interface with at least a portion of environment 300 for any suitable purpose, such as viewing application or other transaction data. Generally, GUI 336 provides the particular user with an efficient and user-friendly presentation of data provided by or communicated within environment 300. For example, GUI 336 may present the user with the components and information that is relevant to their task, increase reuse of such components, and facilitate a sizable developer community around those components. GUI 336 may comprise a plurality of customizable frames or views having interactive fields, pull-down lists, and buttons operated by the user. For example, GUI 336 is operable to display data involving business objects and interfaces in a user-friendly form based on the user context and the displayed data. In another example, GUI 336 is operable to display different levels and types of information involving business objects and interfaces based on the identified or supplied user role. GUI 336 may also present a plurality of portals or dashboards. For example, GUI 336 may display a portal that allows users to view, create, and manage historical and real-time reports including role-based reporting and such. Of course, such reports may be in any appropriate output format including PDF, HTML, and printable text. Real-time dashboards often provide table and graph information on the current state of the data, which may be supplemented by business objects and interfaces. It should be understood that the term graphical user interface may be used in the singular or in the plural to describe one or more graphical user interfaces and each of the displays of a particular graphical user interface. Indeed, reference to GUI 336 may indicate a reference to the front-end or a component of business application 330, as well as the particular interface accessible via client 304, as appropriate, without departing from the scope of this disclosure. Therefore, GUI 336 contemplates any graphical user interface, such as a generic web browser or touchscreen, that processes information in environment 300 and efficiently presents the results to the user. Server 302 can accept data from client 304 via the web browser (e.g., Microsoft Internet Explorer or Netscape Navigator) and return the appropriate HTML or XML responses to the browser using network 312.

More generally in environment 300 as depicted in FIG. 3B, a Foundation Layer 375 can be deployed on multiple separate and distinct hardware platforms, e.g., System A 350 and System B 360, to support application software deployed as two or more deployment units distributed on the platforms, including deployment unit 352 deployed on System A and deployment unit 362 deployed on System B. In this example, the foundation layer can be used to support application software deployed in an application layer. In particular, the foundation layer can be used in connection with application software implemented in accordance with a software architecture that provides a suite of enterprise service operations having various application functionality. In some implementations, the application software is implemented to be deployed on an application platform that includes a foundation layer that contains all fundamental entities that can used from multiple deployment units. These entities can be process components, business objects, and reuse service components. A reuse service component is a piece of software that is reused in different transactions. A reuse service component is used by its defined interfaces, which can be, e.g., local APIs or service interfaces. As explained above, process components in separate deployment units interact through service operations, as illustrated by messages passing between service operations 356 and 366, which are implemented in process components 354 and 364, respectively, which are included in deployment units 352 and 362, respectively. As also explained above, some form of direct communication is generally the form of interaction used between a business object, e.g., business object 358 and 368, of an application deployment unit and a business object, such as master data object 370, of the Foundation Layer 375.

Various components of the present disclosure may be modeled using a model-driven environment. For example, the model-driven framework or environment may allow the developer to use simple drag-and-drop techniques to develop pattern-based or freestyle user interfaces and define the flow of data between them. The result could be an efficient, customized, visually rich online experience. In some cases, this model-driven development may accelerate the application development process and foster business-user self-service. It further enables business analysts or IT developers to compose visually rich applications that use analytic services, enterprise services, remote function calls (RFCs), APIs, and stored procedures. In addition, it may allow them to reuse existing applications and create content using a modeling process and a visual user interface instead of manual coding.

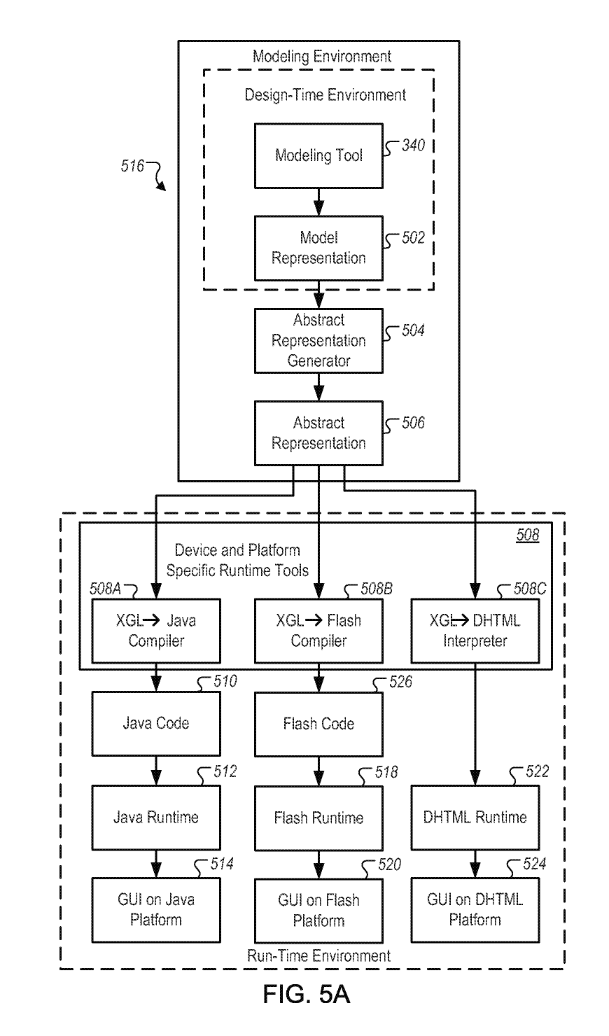

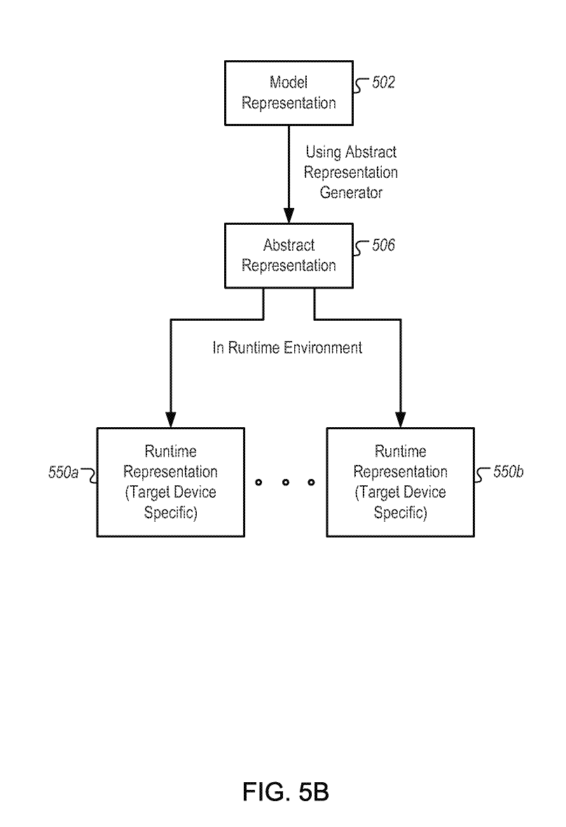

FIG. 5A depicts an example modeling environment 516, namely a modeling environment, in accordance with one embodiment of the present disclosure. Thus, as illustrated in FIG. 5A, such a modeling environment 516 may implement techniques for decoupling models created during design-time from the runtime environment. In other words, model representations for GUIs created in a design time environment are decoupled from the runtime environment in which the GUIs are executed. Often in these environments, a declarative and executable representation for GUIs for applications is provided that is independent of any particular runtime platform, GUI framework, device, or programming language.

According to some embodiments, a modeler (or other analyst) may use the model-driven modeling environment 516 to create pattern-based or freestyle user interfaces using simple drag-and-drop services. Because this development may be model-driven, the modeler can typically compose an application using models of business objects without having to write much, if any, code. In some cases, this example modeling environment 516 may provide a personalized, secure interface that helps unify enterprise applications, information, and processes into a coherent, role-based portal experience. Further, the modeling environment 516 may allow the developer to access and share information and applications in a collaborative environment. In this way, virtual collaboration rooms allow developers to work together efficiently, regardless of where they are located, and may enable powerful and immediate communication that crosses organizational boundaries while enforcing security requirements. Indeed, the modeling environment 516 may provide a shared set of services for finding, organizing, and accessing unstructured content stored in third-party repositories and content management systems across various networks 312. Classification tools may automate the organization of information, while subject-matter experts and content managers can publish information to distinct user audiences. Regardless of the particular implementation or architecture, this modeling environment 516 may allow the developer to easily model hosted business objects 140 using this model-driven approach.

In certain embodiments, the modeling environment 516 may implement or utilize a generic, declarative, and executable GUI language (generally described as XGL). This example XGL is generally independent of any particular GUI framework or runtime platform. Further, XGL is normally not dependent on characteristics of a target device on which the graphic user interface is to be displayed and may also be independent of any programming language. XGL is used to generate a generic representation (occasionally referred to as the XGL representation or XGL-compliant representation) for a design-time model representation. The XGL representation is thus typically a device-independent representation of a GUI. The XGL representation is declarative in that the representation does not depend on any particular GUI framework, runtime platform, device, or programming language. The XGL representation can be executable and therefore can unambiguously encapsulate execution semantics for the GUI described by a model representation. In short, models of different types can be transformed to XGL representations.

The XGL representation may be used for generating representations of various different GUIs and supports various GUI features including full windowing and componentization support, rich data visualizations and animations, rich modes of data entry and user interactions, and flexible connectivity to any complex application data services. While a specific embodiment of XGL is discussed, various other types of XGLs may also be used in alternative embodiments. In other words, it will be understood that XGL is used for example description only and may be read to include any abstract or modeling language that can be generic, declarative, and executable.

Turning to the illustrated embodiment in FIG. 5A, modeling tool 340 may be used by a GUI designer or business analyst during the application design phase to create a model representation 502 for a GUI application. It will be understood that modeling environment 516 may include or be compatible with various different modeling tools 340 used to generate model representation 502. This model representation 502 may be a machine-readable representation of an application or a domain specific model. Model representation 502 generally encapsulates various design parameters related to the GUI such as GUI components, dependencies between the GUI components, inputs and outputs, and the like. Put another way, model representation 502 provides a form in which the one or more models can be persisted and transported, and possibly handled by various tools such as code generators, runtime interpreters, analysis and validation tools, merge tools, and the like. In one embodiment, model representation 502 maybe a collection of XML documents with a well-formed syntax.

Illustrated modeling environment 516 also includes an abstract representation generator (or XGL generator) 504 operable to generate an abstract representation (for example, XGL representation or XGL-compliant representation) 506 based upon model representation 502. Abstract representation generator 504 takes model representation 502 as input and outputs abstract representation 506 for the model representation. Model representation 502 may include multiple instances of various forms or types depending on the tool/language used for the modeling. In certain cases, these various different model representations may each be mapped to one or more abstract representations 506. Different types of model representations may be transformed or mapped to XGL representations. For each type of model representation, mapping rules may be provided for mapping the model representation to the XGL representation 506. Different mapping rules may be provided for mapping a model representation to an XGL representation.

This XGL representation 506 that is created from a model representation may then be used for processing in the runtime environment. For example, the XGL representation 506 may be used to generate a machine-executable runtime GUI (or some other runtime representation) that may be executed by a target device. As part of the runtime processing, the XGL representation 506 may be transformed into one or more runtime representations, which may indicate source code in a particular programming language, machine-executable code for a specific runtime environment, executable GUI, and so forth, which may be generated for specific runtime environments and devices. Since the XGL representation 506, rather than the design-time model representation, is used by the runtime environment, the design-time model representation is decoupled from the runtime environment. The XGL representation 506 can thus serve as the common ground or interface between design-time user interface modeling tools and a plurality of user interface runtime frameworks. It provides a self-contained, closed, and deterministic definition of all aspects of a graphical user interface in a device-independent and programming-language independent manner. Accordingly, abstract representation 506 generated for a model representation 502 is generally declarative and executable in that it provides a representation of the GUI of model representation 502 that is not dependent on any device or runtime platform, is not dependent on any programming language, and unambiguously encapsulates execution semantics for the GUI. The execution semantics may include, for example, identification of various components of the GUI, interpretation of connections between the various GUI components, information identifying the order of sequencing of events, rules governing dynamic behavior of the GUI, rules governing handling of values by the GUI, and the like. The abstract representation 506 is also not GUI runtime-platform specific. The abstract representation 506 provides a self-contained, closed, and deterministic definition of all aspects of a graphical user interface that is device independent and language independent.

Abstract representation 506 is such that the appearance and execution semantics of a GUI generated from the XGL representation work consistently on different target devices irrespective of the GUI capabilities of the target device and the target device platform. For example, the same XGL representation may be mapped to appropriate GUIs on devices of differing levels of GUI complexity (i.e., the same abstract representation may be used to generate a GUI for devices that support simple GUIs and for devices that can support complex GUIs), the GUI generated by the devices are consistent with each other in their appearance and behavior.

Abstract representation generator 504 may be configured to generate abstract representation 506 for models of different types, which may be created using different modeling tools 340. It will be understood that modeling environment 516 may include some, none, or other sub-modules or components as those shown in this example illustration. In other words, modeling environment 516 encompasses the design-time environment (with or without the abstract generator or the various representations), a modeling toolkit (such as 340) linked with a developer's space, or any other appropriate software operable to decouple models created during design-time from the runtime environment. Abstract representation 506 provides an interface between the design time environment and the runtime environment. As shown, this abstract representation 506 may then be used by runtime processing.

As part of runtime processing, modeling environment 516 may include various runtime tools 508 and may generate different types of runtime representations based upon the abstract representation 506. Examples of runtime representations include device or language-dependent (or specific) source code, runtime platform-specific machine-readable code, GUIs for a particular target device, and the like. The runtime tools 508 may include compilers, interpreters, source code generators, and other such tools that are configured to generate runtime platform-specific or target device-specific runtime representations of abstract representation 506. The runtime tool 508 may generate the runtime representation from abstract representation 506 using specific rules that map abstract representation 506 to a particular type of runtime representation. These mapping rules may be dependent on the type of runtime tool, characteristics of the target device to be used for displaying the GUI, runtime platform, and/or other factors. Accordingly, mapping rules may be provided for transforming the abstract representation 506 to any number of target runtime representations directed to one or more target GUI runtime platforms. For example, XGL-compliant code generators may conform to semantics of XGL, as described below. XGL-compliant code generators may ensure that the appearance and behavior of the generated user interfaces is preserved across a plurality of target GUI frameworks, while accommodating the differences in the intrinsic characteristics of each and also accommodating the different levels of capability of target devices.

For example, as depicted in example FIG. 5A, an XGL-to-Java compiler 508A may take abstract representation 506 as input and generate Java code 510 for execution by a target device comprising a Java runtime 512. Java runtime 512 may execute Java code 510 to generate or display a GUI 514 on a Java-platform target device. As another example, an XGL-to-Flash compiler 508B may take abstract representation 506 as input and generate Flash code 526 for execution by a target device comprising a Flash runtime 518. Flash runtime 518 may execute Flash code 516 to generate or display a GUI 520 on a target device comprising a Flash platform. As another example, an XGL-to-DHTML (dynamic HTML) interpreter 508C may take abstract representation 506 as input and generate DHTML statements (instructions) on the fly which are then interpreted by a DHTML runtime 522 to generate or display a GUI 524 on a target device comprising a DHTML platform.

It should be apparent that abstract representation 506 may be used to generate GUIs for Extensible Application Markup Language (XAML) or various other runtime platforms and devices. The same abstract representation 506 may be mapped to various runtime representations and device-specific and runtime platform-specific GUIs. In general, in the runtime environment, machine executable instructions specific to a runtime environment may be generated based upon the abstract representation 506 and executed to generate a GUI in the runtime environment. The same XGL representation may be used to generate machine executable instructions specific to different runtime environments and target devices.

According to certain embodiments, the process of mapping a model representation 502 to an abstract representation 506 and mapping an abstract representation 506 to some runtime representation may be automated. For example, design tools may automatically generate an abstract representation for the model representation using XGL and then use the XGL abstract representation to generate GUIs that are customized for specific runtime environments and devices. As previously indicated, mapping rules may be provided for mapping model representations to an XGL representation. Mapping rules may also be provided for mapping an XGL representation to a runtime platform-specific representation.

Since the runtime environment uses abstract representation 506 rather than model representation 502 for runtime processing, the model representation 502 that is created during design-time is decoupled from the runtime environment. Abstract representation 506 thus provides an interface between the modeling environment and the runtime environment. As a result, changes may be made to the design time environment, including changes to model representation 502 or changes that affect model representation 502, generally to not substantially affect or impact the runtime environment or tools used by the runtime environment. Likewise, changes may be made to the runtime environment generally to not substantially affect or impact the design time environment. A designer or other developer can thus concentrate on the design aspects and make changes to the design without having to worry about the runtime dependencies such as the target device platform or programming language dependencies.

FIG. 5B depicts an example process for mapping a model representation 502 to a runtime representation using the example modeling environment 516 of FIG. 5A or some other modeling environment. Model representation 502 may comprise one or more model components and associated properties that describe a data object, such as hosted business objects and interfaces. As described above, at least one of these model components is based on or otherwise associated with these hosted business objects and interfaces. The abstract representation 506 is generated based upon model representation 502. Abstract representation 506 may be generated by the abstract representation generator 504. Abstract representation 506 comprises one or more abstract GUI components and properties associated with the abstract GUI components. As part of generation of abstract representation 506, the model GUI components and their associated properties from the model representation are mapped to abstract GUI components and properties associated with the abstract GUI components. Various mapping rules may be provided to facilitate the mapping. The abstract representation encapsulates both appearance and behavior of a GUI. Therefore, by mapping model components to abstract components, the abstract representation not only specifies the visual appearance of the GUI but also the behavior of the GUI, such as in response to events whether clicking/dragging or scrolling, interactions between GUI components and such.

One or more runtime representations 550a, including GUIs for specific runtime environment platforms, may be generated from abstract representation 506. A device-dependent runtime representation may be generated for a particular type of target device platform to be used for executing and displaying the GUI encapsulated by the abstract representation. The GUIs generated from abstract representation 506 may comprise various types of GUI elements such as buttons, windows, scrollbars, input boxes, etc. Rules may be provided for mapping an abstract representation to a particular runtime representation. Various mapping rules may be provided for different runtime environment platforms.

Methods and systems consistent with the subject matter described herein provide and use interfaces 320 derived from the business object model 318 suitable for use with more than one business area, for example different departments within a company such as finance, or marketing. Also, they are suitable across industries and across businesses. Interfaces 320 are used during an end-to-end business transaction to transfer business process information in an application-independent manner. For example the interfaces can be used for fulfilling a sales order.

1. Message Overview

To perform an end-to-end business transaction, consistent interfaces are used to create business documents that are sent within messages between heterogeneous programs or modules.

a) Message Categories

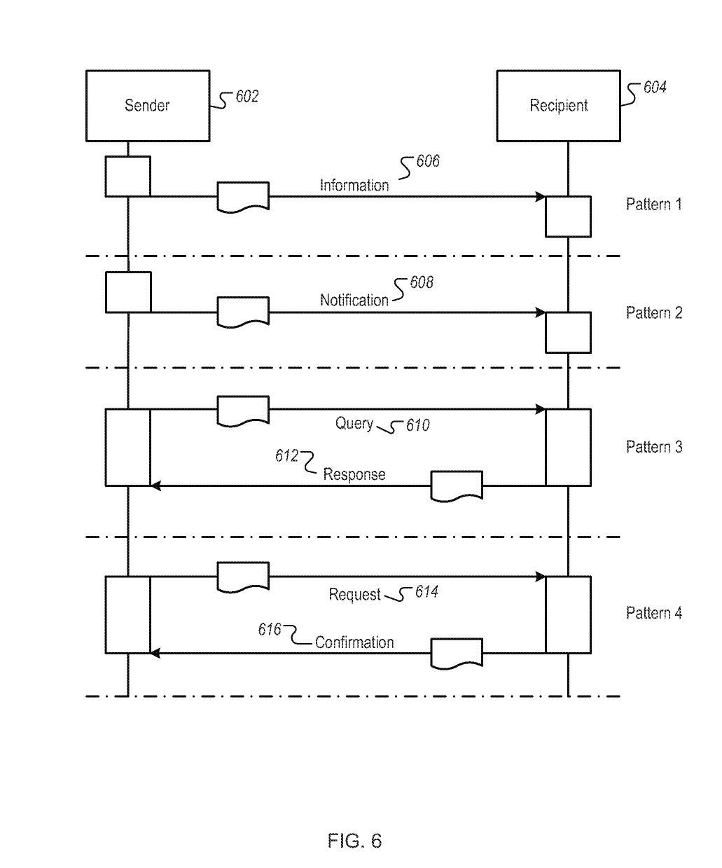

As depicted in FIG. 6, the communication between a sender 602 and a recipient 604 can be broken down into basic categories that describe the type of the information exchanged and simultaneously suggest the anticipated reaction of the recipient 604. A message category is a general business classification for the messages. Communication is sender-driven. In other words, the meaning of the message categories is established or formulated from the perspective of the sender 602. The message categories include information 606, notification 608, query 610, response 612, request 614, and confirmation 616.

(1) Information

Information 606 is a message sent from a sender 602 to a recipient 604 concerning a condition or a statement of affairs. No reply to information is expected. Information 606 is sent to make business partners or business applications aware of a situation. Information 606 is not compiled to be application-specific. Examples of “information” are an announcement, advertising, a report, planning information, and a message to the business warehouse.

(2) Notification

A notification 608 is a notice or message that is geared to a service. A sender 602 sends the notification 608 to a recipient 604. No reply is expected for a notification. For example, a billing notification relates to the preparation of an invoice while a dispatched delivery notification relates to preparation for receipt of goods.

(3) Query

A query 610 is a question from a sender 602 to a recipient 604 to which a response 612 is expected. A query 610 implies no assurance or obligation on the part of the sender 602. Examples of a query 610 are whether space is available on a specific flight or whether a specific product is available. These queries do not express the desire for reserving the flight or purchasing the product.

(4) Response

A response 612 is a reply to a query 610. The recipient 604 sends the response 612 to the sender 602. A response 612 generally implies no assurance or obligation on the part of the recipient 604. The sender 602 is not expected to reply. Instead, the process is concluded with the response 612. Depending on the business scenario, a response 612 also may include a commitment, i.e., an assurance or obligation on the part of the recipient 604. Examples of responses 612 are a response stating that space is available on a specific flight or that a specific product is available. With these responses, no reservation was made.

(5) Request

A request 614 is a binding requisition or requirement from a sender 602 to a recipient 604. Depending on the business scenario, the recipient 604 can respond to a request 614 with a confirmation 616. The request 614 is binding on the sender 602. In making the request 614, the sender 602 assumes, for example, an obligation to accept the services rendered in the request 614 under the reported conditions. Examples of a request 614 are a parking ticket, a purchase order, an order for delivery and a job application.

(6) Confirmation

A confirmation 616 is a binding reply that is generally made to a request 614. The recipient 604 sends the confirmation 616 to the sender 602. The information indicated in a confirmation 616, such as deadlines, products, quantities and prices, can deviate from the information of the preceding request 614. A request 614 and confirmation 616 may be used in negotiating processes. A negotiating process can consist of a series of several request 614 and confirmation 616 messages. The confirmation 616 is binding on the recipient 604. For example, 100 units of X may be ordered in a purchase order request; however, only the delivery of 80 units is confirmed in the associated purchase order confirmation.

b) Message Choreography

A message choreography is a template that specifies the sequence of messages between business entities during a given transaction. The sequence with the messages contained in it describes in general the message “lifecycle” as it proceeds between the business entities. If messages from a choreography are used in a business transaction, they appear in the transaction in the sequence determined by the choreography. This illustrates the template character of a choreography, i.e., during an actual transaction, it is not necessary for all messages of the choreography to appear. Those messages that are contained in the transaction, however, follow the sequence within the choreography. A business transaction is thus a derivation of a message choreography. The choreography makes it possible to determine the structure of the individual message types more precisely and distinguish them from one another.

2. Components of the Business Object Model

The overall structure of the business object model ensures the consistency of the interfaces that are derived from the business object model. The derivation ensures that the same business-related subject matter or concept is represented and structured in the same way in all interfaces.

The business object model defines the business-related concepts at a central location for a number of business transactions. In other words, it reflects the decisions made about modeling the business entities of the real world acting in business transactions across industries and business areas. The business object model is defined by the business objects and their relationship to each other (the overall net structure).

Each business object is generally a capsule with an internal hierarchical structure, behavior offered by its operations, and integrity constraints. Business objects are semantically disjoint, i.e., the same business information is represented once. In the business object model, the business objects are arranged in an ordering framework. From left to right, they are arranged according to their existence dependency to each other. For example, the customizing elements may be arranged on the left side of the business object model, the strategic elements may be arranged in the center of the business object model, and the operative elements may be arranged on the right side of the business object model. Similarly, the business objects are arranged from the top to the bottom based on defined order of the business areas, e.g., finance could be arranged at the top of the business object model with CRM below finance and SRM below CRM.

To ensure the consistency of interfaces, the business object model may be built using standardized data types as well as packages to group related elements together, and package templates and entity templates to specify the arrangement of packages and entities within the structure.

a) Data Types

Data types are used to type object entities and interfaces with a structure. This typing can include business semantic. Such data types may include those generally described at pages 96 through 1642 (which are incorporated by reference herein) of U.S. patent application Ser. No. 11/803,178, filed on May 11, 2007 and entitled “Consistent Set Of Interfaces Derived From A Business Object Model”. For example, the data type BusinessTransactionDocumentID is a unique identifier for a document in a business transaction. Also, as an example, Data type BusinessTransactionDocumentParty contains the information that is exchanged in business documents about a party involved in a business transaction, and includes the party's identity, the party's address, the party's contact person and the contact person's address. BusinessTransactionDocumentParty also includes the role of the party, e.g., a buyer, seller, product recipient, or vendor.

The data types are based on Core Component Types (“CCTs”), which themselves are based on the World Wide Web Consortium (“W3C”) data types. “Global” data types represent a business situation that is described by a fixed structure. Global data types include both context-neutral generic data types (“GDTs”) and context-based context data types (“CDTs”). GDTs contain business semantics, but are application-neutral, i.e., without context. CDTs, on the other hand, are based on GDTs and form either a use-specific view of the GDTs, or a context-specific assembly of GDTs or CDTs. A message is typically constructed with reference to a use and is thus a use-specific assembly of GDTs and CDTs. The data types can be aggregated to complex data types.

To achieve a harmonization across business objects and interfaces, the same subject matter is typed with the same data type. For example, the data type “GeoCoordinates” is built using the data type “Measure” so that the measures in a GeoCoordinate (i.e., the latitude measure and the longitude measure) are represented the same as other “Measures” that appear in the business object model.

b) Entities

Entities are discrete business elements that are used during a business transaction. Entities are not to be confused with business entities or the components that interact to perform a transaction. Rather, “entities” are one of the layers of the business object model and the interfaces. For example, a Catalogue entity is used in a Catalogue Publication Request and a Purchase Order is used in a Purchase Order Request. These entities are created using the data types defined above to ensure the consistent representation of data throughout the entities.

c) Packages

Packages group the entities in the business object model and the resulting interfaces into groups of semantically associated information. Packages also may include “sub”-packages, i.e., the packages may be nested.

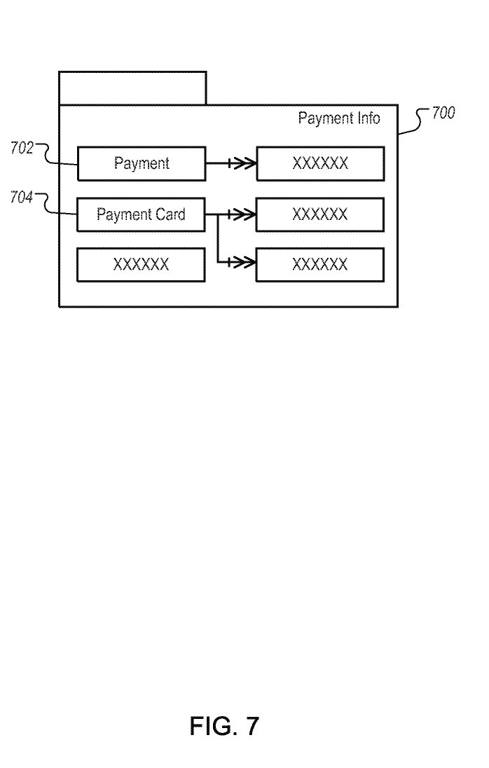

Packages may group elements together based on different factors, such as elements that occur together as a rule with regard to a business-related aspect. For example, as depicted in FIG. 7, in a Purchase Order, different information regarding the purchase order, such as the type of payment 702, and payment card 704, are grouped together via the PaymentInformation package 700.

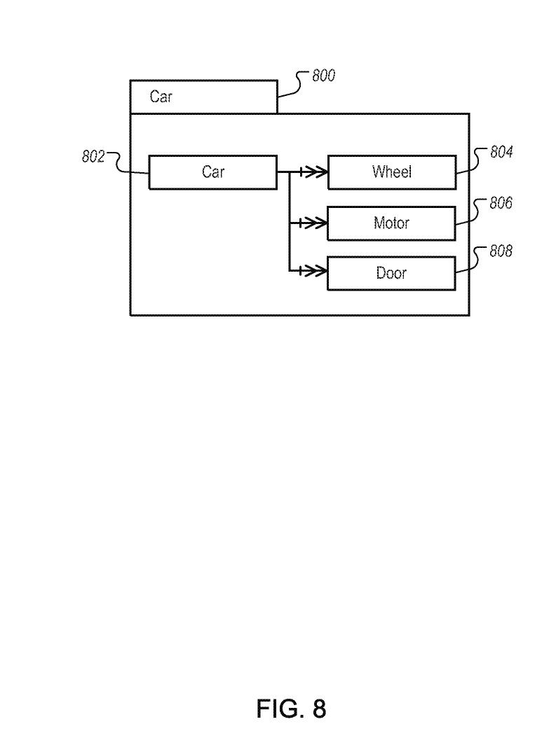

Packages also may combine different components that result in a new object. For example, as depicted in FIG. 8, the components wheels 804, motor 806, and doors 808 are combined to form a composition “Car” 802. The “Car” package 800 includes the wheels, motor and doors as well as the composition “Car.”

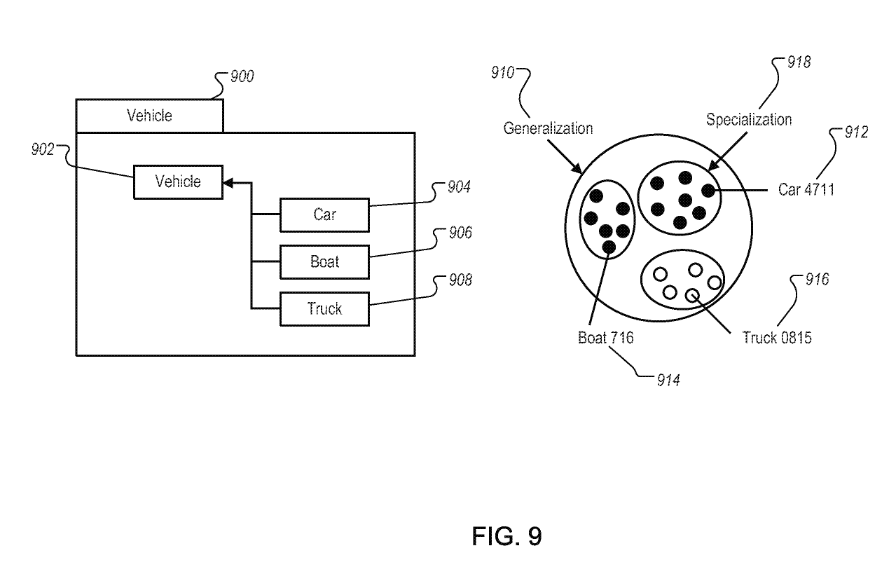

Another grouping within a package may be subtypes within a type. In these packages, the components are specialized forms of a generic package. For example, as depicted in FIG. 9, the components Car 904, Boat 906, and Truck 908 can be generalized by the generic term Vehicle 902 in Vehicle package 900. Vehicle in this case is the generic package 910, while Car 912, Boat 914, and Truck 916 are the specializations 918 of the generalized vehicle 910.

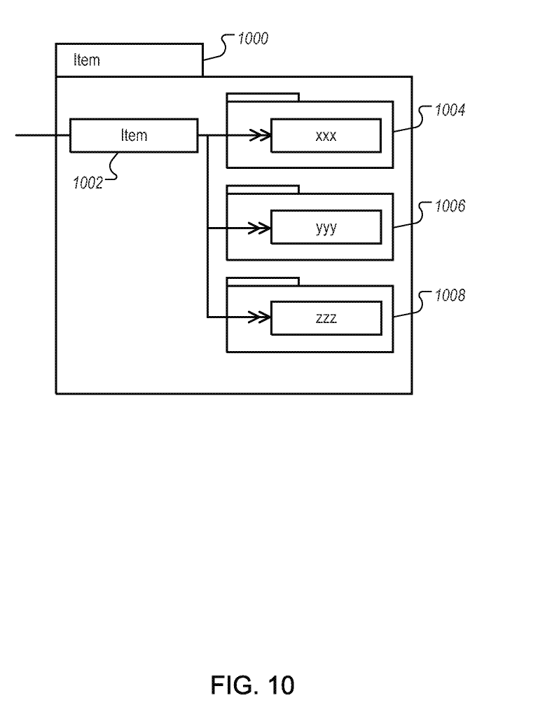

Packages also may be used to represent hierarchy levels. For example, as depicted in FIG. 10, the Item Package 1000 includes Item 1002 with subitem xxx 1004, subitem yyy 1006, and subitem zzz 1008.

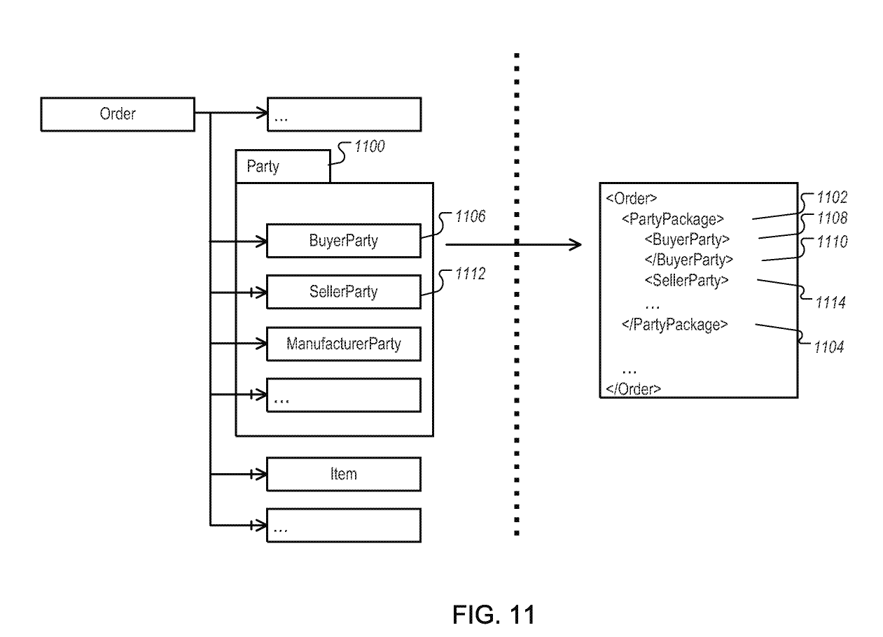

Packages can be represented in the XML schema as a comment. One advantage of this grouping is that the document structure is easier to read and is more understandable. The names of these packages are assigned by including the object name in brackets with the suffix “Package.” For example, as depicted in FIG. 11, Party package 1100 is enclosed by <PartyPackage> 1102 and </PartyPackage> 1104. Party package 1100 illustratively includes a Buyer Party 1106, identified by <BuyerParty> 1108 and </BuyerParty> 1110, and a Seller Party 1112, identified by <SellerParty> 1114 and </SellerParty>, etc.

d) Relationships

Relationships describe the interdependencies of the entities in the business object model, and are thus an integral part of the business object model.

(1) Cardinality of Relationships

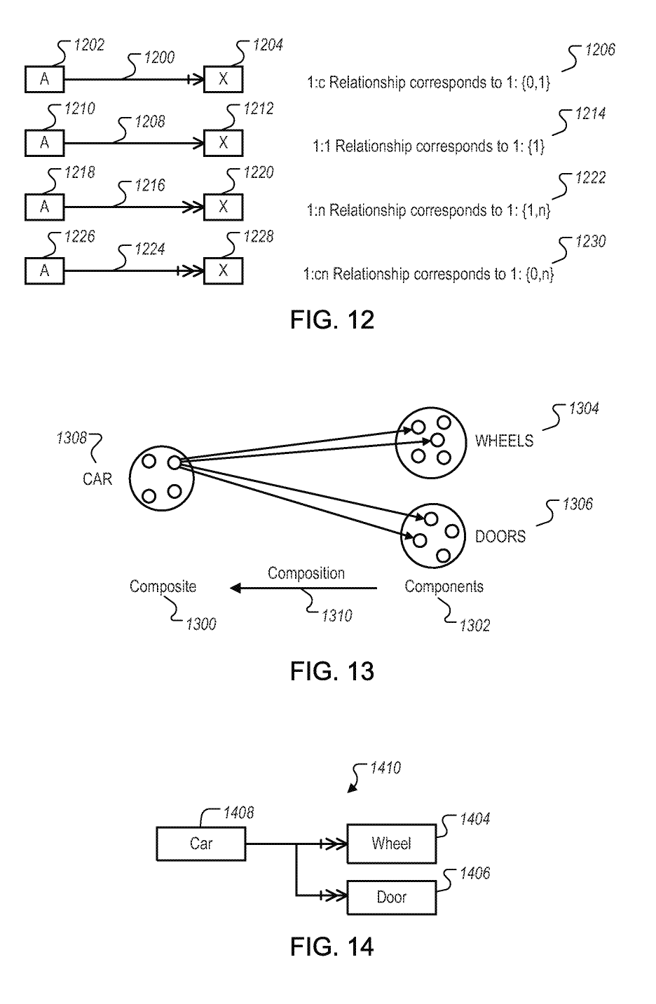

FIG. 12 depicts a graphical representation of the cardinalities between two entities. The cardinality between a first entity and a second entity identifies the number of second entities that could possibly exist for each first entity. Thus, a 1:c cardinality 1200 between entities A 1202 and X 1204 indicates that for each entity A 1202, there is either one or zero 1206 entity X 1204. A 1:1 cardinality 1208 between entities A 1210 and X 1212 indicates that for each entity A 1210, there is exactly one 1214 entity X 1212. A 1:n cardinality 1216 between entities A 1218 and X 1220 indicates that for each entity A 1218, there are one or more 1222 entity Xs 1220. A 1:cn cardinality 1224 between entities A 1226 and X 1228 indicates that for each entity A 1226, there are any number 1230 of entity Xs 1228 (i.e., 0 through n Xs for each A).

(2) Types of Relationships

(a) Composition

A composition or hierarchical relationship type is a strong whole-part relationship which is used to describe the structure within an object. The parts, or dependent entities, represent a semantic refinement or partition of the whole, or less dependent entity. For example, as depicted in FIG. 13, the components 1302, wheels 1304, and doors 1306 may be combined to form the composite 1300 “Car” 1308 using the composition 1310. FIG. 14 depicts a graphical representation of the composition 1410 between composite Car 1408 and components wheel 1404 and door 1406.

(b) Aggregation

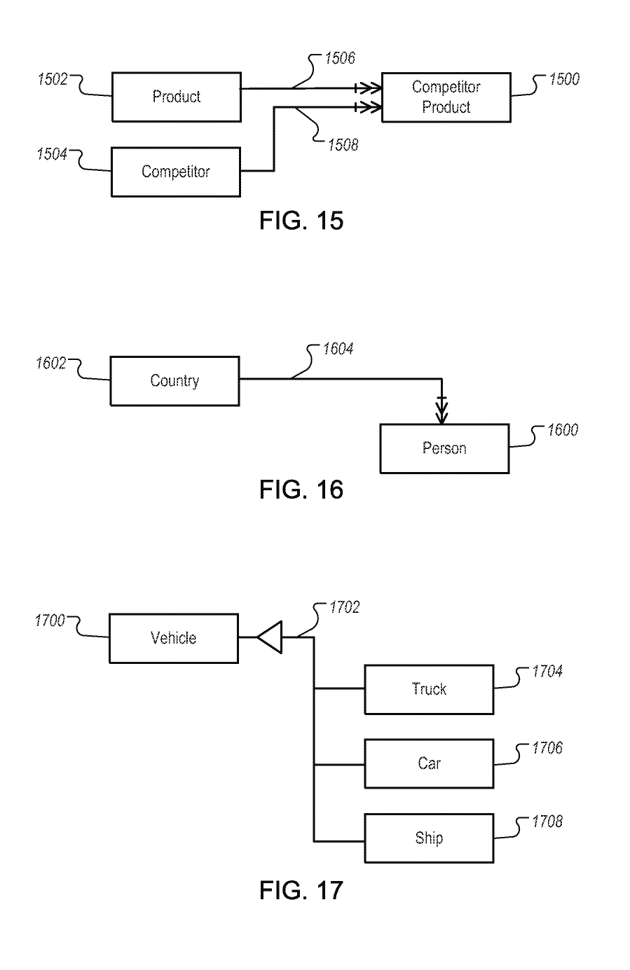

An aggregation or an aggregating relationship type is a weak whole-part relationship between two objects. The dependent object is created by the combination of one or several less dependent objects. For example, as depicted in FIG. 15, the properties of a competitor product 1500 are determined by a product 1502 and a competitor 1504. A hierarchical relationship 1506 exists between the product 1502 and the competitor product 1500 because the competitor product 1500 is a component of the product 1502. Therefore, the values of the attributes of the competitor product 1500 are determined by the product 1502. An aggregating relationship 1508 exists between the competitor 1504 and the competitor product 1500 because the competitor product 1500 is differentiated by the competitor 1504. Therefore the values of the attributes of the competitor product 1500 are determined by the competitor 1504.

(c) Association

An association or a referential relationship type describes a relationship between two objects in which the dependent object refers to the less dependent object. For example, as depicted in FIG. 16, a person 1600 has a nationality, and thus, has a reference to its country 1602 of origin. There is an association 1604 between the country 1602 and the person 1600. The values of the attributes of the person 1600 are not determined by the country 1602.

(3) Specialization

Entity types may be divided into subtypes based on characteristics of the entity types. For example, FIG. 17 depicts an entity type “vehicle” 1700 specialized 1702 into subtypes “truck” 1704, “car” 1706, and “ship” 1708. These subtypes represent different aspects or the diversity of the entity type.

Subtypes may be defined based on related attributes. For example, although ships and cars are both vehicles, ships have an attribute, “draft,” that is not found in cars. Subtypes also may be defined based on certain methods that can be applied to entities of this subtype and that modify such entities. For example, “drop anchor” can be applied to ships. If outgoing relationships to a specific object are restricted to a subset, then a subtype can be defined which reflects this subset.

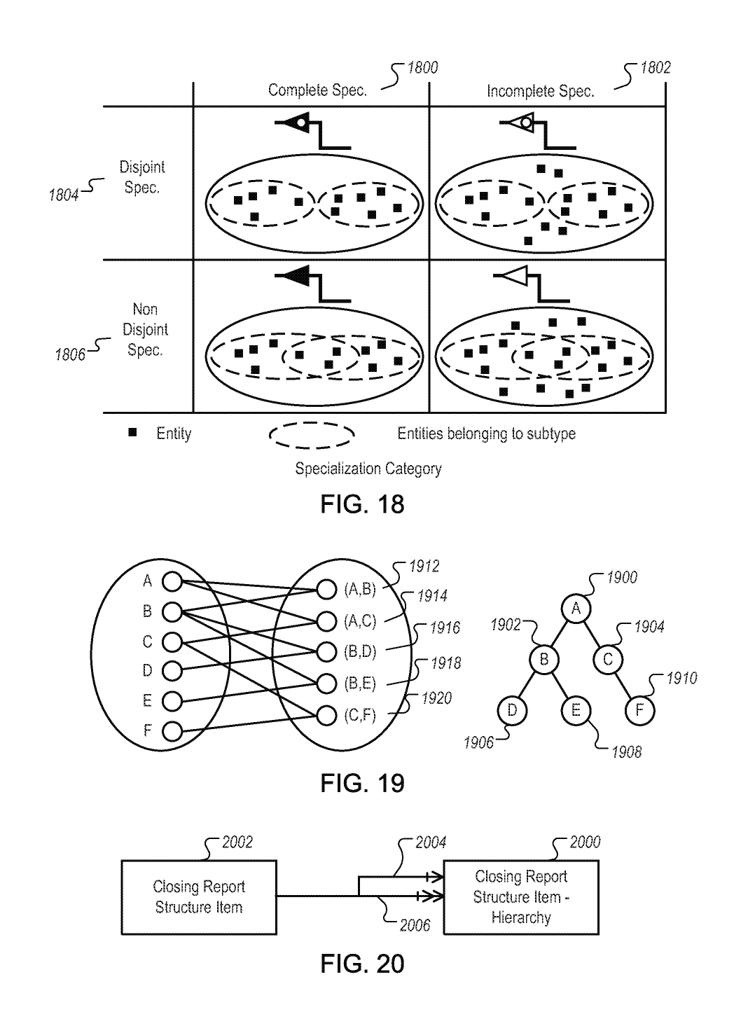

As depicted in FIG. 18, specializations may further be characterized as complete specializations 1800 or incomplete specializations 1802. There is a complete specialization 1800 where each entity of the generalized type belongs to at least one subtype. With an incomplete specialization 1802, there is at least one entity that does not belong to a subtype. Specializations also may be disjoint 1804 or nondisjoint 1806. In a disjoint specialization 1804, each entity of the generalized type belongs to a maximum of one subtype. With a nondisjoint specialization 1806, one entity may belong to more than one subtype. As depicted in FIG. 18, four specialization categories result from the combination of the specialization characteristics.

e) Structural Patterns

(1) Item

An item is an entity type which groups together features of another entity type. Thus, the features for the entity type chart of accounts are grouped together to form the entity type chart of accounts item. For example, a chart of accounts item is a category of values or value flows that can be recorded or represented in amounts of money in accounting, while a chart of accounts is a superordinate list of categories of values or value flows that is defined in accounting.

The cardinality between an entity type and its item is often either 1:n or 1:cn. For example, in the case of the entity type chart of accounts, there is a hierarchical relationship of the cardinality 1:n with the entity type chart of accounts item since a chart of accounts has at least one item in all cases.

(2) Hierarchy

A hierarchy describes the assignment of subordinate entities to superordinate entities and vice versa, where several entities of the same type are subordinate entities that have, at most, one directly superordinate entity. For example, in the hierarchy depicted in FIG. 19, entity B 1902 is subordinate to entity A 1900, resulting in the relationship (A,B) 1912. Similarly, entity C 1904 is subordinate to entity A 1900, resulting in the relationship (A,C) 1914. Entity D 1906 and entity E 1908 are subordinate to entity B 1902, resulting in the relationships (B,D) 1916 and (B,E) 1918, respectively. Entity F 1910 is subordinate to entity C 1904, resulting in the relationship (C,F) 1920.

Because each entity has at most one superordinate entity, the cardinality between a subordinate entity and its superordinate entity is 1:c. Similarly, each entity may have 0, 1 or many subordinate entities. Thus, the cardinality between a superordinate entity and its subordinate entity is 1:cn. FIG. 20 depicts a graphical representation of a Closing Report Structure Item hierarchy 2000 for a Closing Report Structure Item 2002. The hierarchy illustrates the 1:c cardinality 2004 between a subordinate entity and its superordinate entity, and the 1:cn cardinality 2006 between a superordinate entity and its subordinate entity.

3. Creation of the Business Object Model

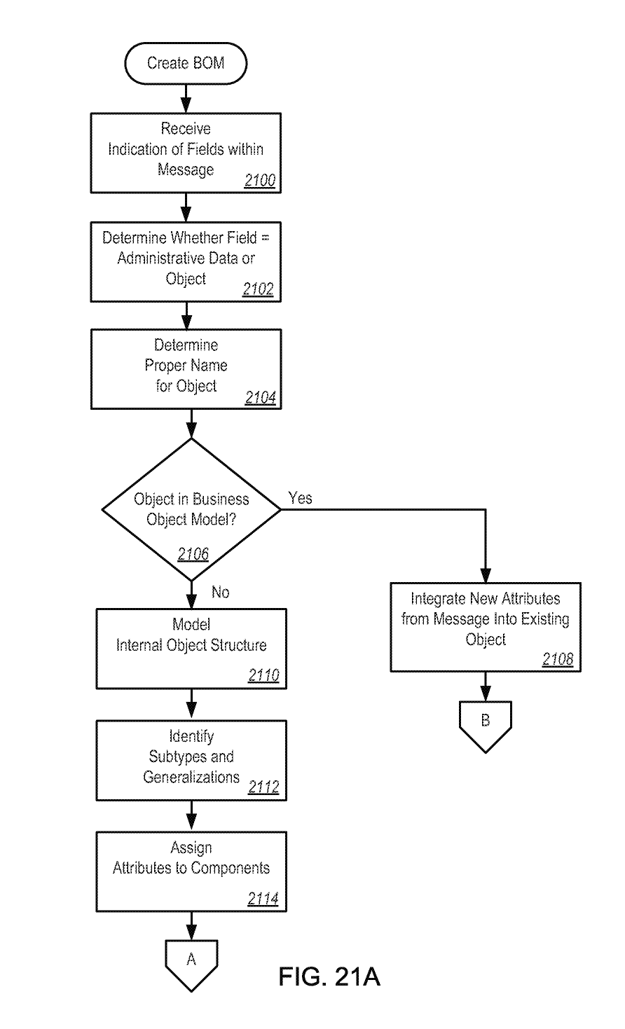

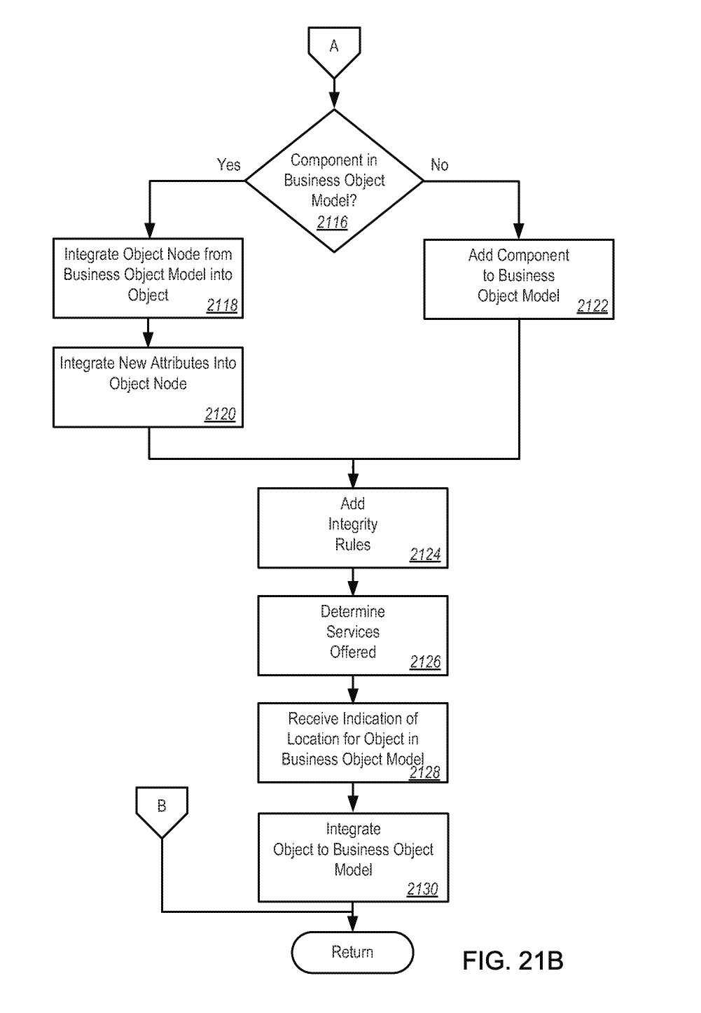

FIGS. 21A-B depict the steps performed using methods and systems consistent with the subject matter described herein to create a business object model. Although some steps are described as being performed by a computer, these steps may alternatively be performed manually, or computer-assisted, or any combination thereof. Likewise, although some steps are described as being performed by a computer, these steps may also be computer-assisted, or performed manually, or any combination thereof.

As discussed above, the designers create message choreographies that specify the sequence of messages between business entities during a transaction. After identifying the messages, the developers identify the fields contained in one of the messages (step 2100, FIG. 21A). The designers then determine whether each field relates to administrative data or is part of the object (step 2102). Thus, the first eleven fields identified below in the left column are related to administrative data, while the remaining fields are part of the object.

| | |
|---|---|
| MessageID | Admin |
| ReferenceID | |
| CreationDate | |
| SenderID | |
| AdditionalSenderID | |
| ContactPersonID | |
| SenderAddress | |
| RecipientID | |
| AdditionalRecipientID | |
| ContactPersonID | |
| RecipientAddress | |
| ID | Main Object |
| AdditionalID | |
| PostingDate | |
| LastChangeDate | |
| AcceptanceStatus | |
| Note | |
| CompleteTransmission Indicator | |
| Buyer | |
| BuyerOrganisationName | |
| Person Name | |
| FunctionalTitle | |
| DepartmentName | |
| CountryCode | |
| StreetPostalCode | |
| POBox Postal Code | |
| Company Postal Code | |
| City Name | |
| DistrictName | |
| PO Box ID | |
| PO Box Indicator | |
| PO Box Country Code | |
| PO Box Region Code | |
| PO Box City Name | |
| Street Name | |
| House ID | |
| Building ID | |
| Floor ID | |
| Room ID | |
| Care Of Name | |
| AddressDescription | |
| Telefonnumber | |
| MobileNumber | |
| Facsimile | |
| Email | |
| Seller | |
| SellerAddress | |
| Location | |
| LocationType | |
| DeliveryItemGroupID | |
| DeliveryPriority | |
| DeliveryCondition | |
| TransferLocation | |
| NumberofPartialDelivery | |
| QuantityTolerance | |
| MaximumLeadTime | |
| TransportServiceLevel | |
| TranportCondition | |
| TransportDescription | |
| CashDiscountTerms | |
| PaymentForm | |
| PaymentCardID | |
| PaymentCardReferenceID | |
| SequenceID | |
| Holder | |
| ExpirationDate | |
| AttachmentID | |
| AttachmentFilename | |
| DescriptionofMessage | |
| ConfirmationDescriptionof Message | |
| FollowUpActivity | |
| ItemID | |
| ParentItemID | |
| HierarchyType | |
| ProductID | |
| ProductType | |
| ProductNote | |
| ProductCategoryID | |
| Amount | |
| BaseQuantity | |
| ConfirmedAmount | |
| ConfirmedBaseQuantity | |
| ItemBuyer | |
| ItemBuyerOrganisationName | |
| Person Name | |
| FunctionalTitle | |
| DepartmentName | |
| CountryCode | |
| StreetPostalCode | |
| POBox Postal Code | |
| Company Postal Code | |
| City Name | |
| DistrictName | |
| PO Box ID | |
| PO Box Indicator | |
| PO Box Country Code | |
| PO Box Region Code | |
| PO Box City Name | |
| Street Name | |
| House ID | |
| Building ID | |
| Floor ID | |
| Room ID | |
| Care Of Name | |
| AddressDescription | |
| Telefonnumber | |
| MobilNumber | |
| Facsimile | |
| Email | |
| ItemSeller | |
| ItemSellerAddress | |
| ItemLocation | |
| ItemLocationType | |
| ItemDeliveryItemGroupID | |
| ItemDeliveryPriority | |
| ItemDeliveryCondition | |
| ItemTransferLocation | |
| ItemNumberofPartialDelivery | |
| ItemQuantityTolerance | |
| ItemMaximumLeadTime | |
| ItemTransportServiceLevel | |
| ItemTranportCondition | |
| ItemTransportDescription | |
| ContractReference | |
| QuoteReference | |
| CatalogueReference | |
| ItemAttachmentID | |
| ItemAttachmentFilename | |
| ItemDescription | |
| ScheduleLineID | |
| DeliveryPeriod | |
| Quantity | |
| ConfirmedScheduleLineID | |
| ConfirmedDeliveryPeriod | |
| ConfirmedQuantity | |

Next, the designers determine the proper name for the object according to the ISO 11179 naming standards (step 2104). In the example above, the proper name for the “Main Object” is “Purchase Order.” After naming the object, the system that is creating the business object model determines whether the object already exists in the business object model (step 2106). If the object already exists, the system integrates new attributes from the message into the existing object (step 2108), and the process is complete.

If at step 2106 the system determines that the object does not exist in the business object model, the designers model the internal object structure (step 2110). To model the internal structure, the designers define the components. For the above example, the designers may define the components identified below.

| | | | |
|---|---|---|---|
| ID | Purchase | | |
| AdditionalID | Order | | |
| PostingDate | | | |
| LastChangeDate | | | |
| AcceptanceStatus | | | |
| Note | | | |
| CompleteTransmission | | | |
| Indicator | | | |
| Buyer | | Buyer | |
| BuyerOrganisationName | | | |
| Person Name | | | |
| FunctionalTitle | | | |
| DepartmentName | | | |
| CountryCode | | | |
| StreetPostalCode | | | |
| POBox Postal Code | | | |
| Company Postal Code | | | |
| City Name | | | |
| DistrictName | | | |
| PO Box ID | | | |
| PO Box Indicator | | | |
| PO Box Country Code | | | |
| PO Box Region Code | | | |
| PO Box City Name | | | |
| Street Name | | | |
| House ID | | | |
| Building ID | | | |
| Floor ID | | | |
| Room ID | | | |
| Care Of Name | | | |
| AddressDescription | | | |
| Telefonnumber | | | |
| MobileNumber | | | |
| Facsimile | | | |
| Email | | | |
| Seller | | Seller | |
| SellerAddress | | | |
| Location | | Location | |
| LocationType | | | |
| DeliveryItemGroupID | | DeliveryTerms | |
| DeliveryPriority | | | |
| DeliveryCondition | | | |
| TransferLocation | | | |
| NumberofPartialDelivery | | | |
| QuantityTolerance | | | |
| MaximumLeadTime | | | |
| TransportServiceLevel | | | |
| TranportCondition | | | |
| TransportDescription | | | |
| CashDiscountTerms | | | |
| PaymentForm | | Payment | |
| PaymentCardID | | | |
| PaymentCardReferenceID | | | |
| SequenceID | | | |
| Holder | | | |
| ExpirationDate | | | |
| AttachmentID | | | |
| AttachmentFilename | | | |
| DescriptionofMessage | | | |
| ConfirmationDescriptionof | | | |
| Message | | | |
| FollowUpActivity | | | |
| ItemID | | Purchase Order | |
| ParentItemID | | Item | |
| HierarchyType | | | |
| ProductID | | | Product |
| ProductType | | | |
| ProductNote | | | |
| ProductCategoryID | | | ProductCategory |
| Amount | | | |
| BaseQuantity | | | |
| ConfirmedAmount | | | |
| ConfirmedBaseQuantity | | | |
| ItemBuyer | | | Buyer |
| ItemBuyerOrganisation | | | |
| Name | | | |
| Person Name | | | |
| FunctionalTitle | | | |
| DepartmentName | | | |
| CountryCode | | | |
| StreetPostalCode | | | |
| POBox Postal Code | | | |
| Company Postal Code | | | |
| City Name | | | |
| DistrictName | | | |
| PO Box ID | | | |
| PO Box Indicator | | | |
| PO Box Country Code | | | |
| PO Box Region Code | | | |
| PO Box City Name | | | |
| Street Name | | | |
| House ID | | | |
| Building ID | | | |
| Floor ID | | | |
| Room ID | | | |
| Care Of Name | | | |
| AddressDescription | | | |
| Telefonnumber | | | |
| MobilNumber | | | |
| Facsimile | | | |
| Email | | | |
| ItemSeller | | | Seller |
| ItemSellerAddress | | | |
| ItemLocation | | | Location |
| ItemLocationType | | | |
| ItemDeliveryItemGroupID | | | |
| ItemDeliveryPriority | | | |
| ItemDeliveryCondition | | | |
| ItemTransferLocation | | | |
| ItemNumberofPartial | | | |
| Delivery | | | |
| ItemQuantityTolerance | | | |
| ItemMaximumLeadTime | | | |
| ItemTransportServiceLevel | | | |
| ItemTranportCondition | | | |
| ItemTransportDescription | | | |
| ContractReference | | | Contract |
| QuoteReference | | | Quote |
| CatalogueReference | | | Catalogue |
| ItemAttachmentID | | | |
| ItemAttachmentFilename | | | |
| ItemDescription | | | |
| ScheduleLineID | | | |
| DeliveryPeriod | | | |
| Quantity | | | |
| ConfirmedScheduleLineID | | | |
| ConfirmedDeliveryPeriod | | | |
| ConfirmedQuantity | | | |

During the step of modeling the internal structure, the designers also model the complete internal structure by identifying the compositions of the components and the corresponding cardinalities, as shown below.

| | | | | |
|---|---|---|---|---|
| Purchase | | | | 1 |
| Order | | | | |
| | Buyer | | | 0 . . . 1 |
| | | Address | | 0 . . . 1 |
| | | ContactPerson | | 0 . . . 1 |
| | | | Address | 0 . . . 1 |
| | Seller | | | 0 . . . 1 |
| | Location | | | 0 . . . 1 |
| | | Address | | 0 . . . 1 |
| | DeliveryTerms | | | 0 . . . 1 |
| | | Incoterms | | 0 . . . 1 |
| | | PartialDelivery | | 0 . . . 1 |
| | | QuantityTolerance | | 0 . . . 1 |
| | | Transport | | 0 . . . 1 |
| | CashDiscount | | | 0 . . . 1 |
| | Terms | | | |
| | | MaximumCash | | 0 . . . 1 |
| | | Discount | | |
| | | NormalCash | | 0 . . . 1 |
| | | Discount | | |
| | PaymentForm | | | 0 . . . 1 |
| | | PaymentCard | | 0 . . . 1 |
| | Attachment | | | 0 . . . n |
| | Description | | | 0 . . . 1 |
| | Confirmation | | | 0 . . . 1 |
| | Description | | | |
| | Item | | | 0 . . . n |
| | | Hierarchy | | 0 . . . 1 |
| | | Relationship | | |
| | | Product | | 0 . . . 1 |
| | | ProductCategory | | 0 . . . 1 |
| | | Price | | 0 . . . 1 |
| | | | NetunitPrice | 0 . . . 1 |
| | | ConfirmedPrice | | 0 . . . 1 |
| | | | NetunitPrice | 0 . . . 1 |
| | | Buyer | | 0 . . . 1 |
| | | Seller | | 0 . . . 1 |
| | | Location | | 0 . . . 1 |
| | | DeliveryTerms | | 0 . . . 1 |
| | | Attachment | | 0 . . . n |
| | | Description | | 0 . . . 1 |
| | | Confirmation | | 0 . . . 1 |
| | | Description | | |
| | | ScheduleLine | | 0 . . . n |
| | | | DeliveryPeriod | 1 |
| | | Confirmed | | 0 . . . n |
| | | ScheduleLine | | |

After modeling the internal object structure, the developers identify the subtypes and generalizations for all objects and components (step 2112). For example, the Purchase Order may have subtypes Purchase Order Update, Purchase Order Cancellation and Purchase Order Information. Purchase Order Update may include Purchase Order Request, Purchase Order Change, and Purchase Order Confirmation. Moreover, Party may be identified as the generalization of Buyer and Seller. The subtypes and generalizations for the above example are shown below.

| | | | | | |
|---|---|---|---|---|---|
| Purchase | | | | | 1 |
| Order | | | | | |
| | PurchaseOrder | | | | |
| | Update | | | | |
| | | PurchaseOrder | | | |
| | | Request | | | |
| | | PurchaseOrder | | | |
| | | Change | | | |
| | | PurchaseOrder | | | |
| | | Confirmation | | | |
| | PurchaseOrder | | | | |
| | Cancellation | | | | |
| | PurchaseOrder | | | | |
| | Information | | | | |
| | Party | | | | |
| | | BuyerParty | | | 0 . . . 1 |
| | | | Address | | 0 . . . 1 |
| | | | Contact | | 0 . . . 1 |
| | | | Person | | |
| | | | | Address | 0 . . . 1 |
| | | SellerParty | | | 0 . . . 1 |
| | Location | | | | |
| | | ShipTo | | | 0 . . . 1 |
| | | Location | | | |
| | | | Address | | 0 . . . 1 |
| | | ShipFrom | | | 0 . . . 1 |
| | | Location | | | |
| | | | Address | | 0 . . . 1 |
| | DeliveryTerms | | | | 0 . . . 1 |
| | | Incoterms | | | 0 . . . 1 |
| | | PartialDelivery | | | 0 . . . 1 |
| | | Quantity | | | 0 . . . 1 |
| | | Tolerance | | | |
| | | Transport | | | 0 . . . 1 |
| | CashDiscount | | | | 0 . . . 1 |
| | Terms | | | | |
| | | MaximumCash | | | 0 . . . 1 |
| | | Discount | | | |
| | | NormalCash | | | 0 . . . 1 |
| | | Discount | | | |
| | PaymentForm | | | | 0 . . . 1 |
| | | PaymentCard | | | 0 . . . 1 |
| | Attachment | | | | 0 . . . n |
| | Description | | | | 0 . . . 1 |
| | Confirmation | | | | 0 . . . 1 |
| | Description | | | | |
| | Item | | | | 0 . . . n |
| | | Hierarchy | | | 0 . . . 1 |
| | | Relationship | | | |
| | | Product | | | 0 . . . 1 |
| | | Product | | | 0 . . . 1 |
| | | Category | | | |
| | | Price | | | 0 . . . 1 |
| | | | Netunit | | 0 . . . 1 |
| | | | Price | | |
| | | Confirmed | | | 0 . . . 1 |
| | | Price | | | |
| | | | Netunit | | 0 . . . 1 |
| | | | Price | | |
| | | Party | | | |
| | | | BuyerParty | | 0 . . . 1 |
| | | | SellerParty | | 0 . . . 1 |
| | | Location | | | |
| | | | ShipTo | | 0 . . . 1 |
| | | | Location | | |
| | | | ShipFrom | | 0 . . . 1 |
| | | | Location | | |
| | | DeliveryTerms | | | 0 . . . 1 |
| | | Attachment | | | 0 . . . n |
| | | Description | | | 0 . . . 1 |
| | | Confirmation | | | 0 . . . 1 |
| | | Description | | | |
| | | ScheduleLine | | | 0 . . . n |
| | | | Delivery | | 1 |
| | | | Period | | |
| | | Confirmed | | | 0 . . . n |
| | | Schedule | | | |
| | | Line | | | |

After identifying the subtypes and generalizations, the developers assign the attributes to these components (step 2114). The attributes for a portion of the components are shown below.

| | | | | |
|---|---|---|---|---|
| Purchase- | | | | 1 |
| Order | | | | |
| | ID | | | 1 |
| | SellerID | | | 0 . . . 1 |
| | BuyerPosting- | | | 0 . . . 1 |
| | DateTime | | | |
| | BuyerLast- | | | 0 . . . 1 |
| | ChangeDate- | | | |
| | Time | | | |
| | SellerPosting- | | | 0 . . . 1 |
| | DateTime | | | |
| | SellerLast- | | | 0 . . . 1 |
| | ChangeDate | | | |
| | Time | | | |
| | Acceptance- | | | 0 . . . 1 |
| | StatusCode | | | |
| | Note | | | 0 . . . 1 |
| | ItemList- | | | 0 . . . 1 |
| | Complete- | | | |
| | Transmission- | | | |
| | Indicator | | | |
| | BuyerParty | | | 0 . . . 1 |
| | | StandardID | | 0 . . . n |
| | | BuyerID | | 0 . . . 1 |
| | | SellerID | | 0 . . . 1 |
| | | Address | | 0 . . . 1 |
| | | ContactPerson | | 0 . . . 1 |
| | | | BuyerID | 0 . . . 1 |
| | | | SellerID | 0 . . . 1 |
| | | | Address | 0 . . . 1 |
| | SellerParty | | | 0 . . . 1 |
| | Product- | | | 0 . . . 1 |
| | RecipientParty | | | |
| | VendorParty | | | 0 . . . 1 |
| | Manufacturer- | | | 0 . . . 1 |
| | Party | | | |
| | BillToParty | | | 0 . . . 1 |
| | PayerParty | | | 0 . . . 1 |
| | CarrierParty | | | 0 . . . 1 |
| | ShipTo- | | | 0 . . . 1 |
| | Location | | | |
| | | StandardID | | 0 . . . n |
| | | BuyerID | | 0 . . . 1 |
| | | SellerID | | 0 . . . 1 |
| | | Address | | 0 . . . 1 |
| | ShipFrom- | | | 0 . . . 1 |
| | Location | | | |

The system then determines whether the component is one of the object nodes in the business object model (step 2116, FIG. 21B). If the system determines that the component is one of the object nodes in the business object model, the system integrates a reference to the corresponding object node from the business object model into the object (step 2118). In the above example, the system integrates the reference to the Buyer party represented by an ID and the reference to the ShipToLocation represented by an into the object, as shown below. The attributes that were formerly located in the PurchaseOrder object are now assigned to the new found object party. Thus, the attributes are removed from the PurchaseOrder object.

| | | |
|---|---|---|
| PurchaseOrder | | |
| | ID | |
| | SellerID | |
| | BuyerPostingDateTime | |
| | BuyerLastChangeDateTime | |
| | SellerPostingDateTime | |
| | SellerLastChangeDateTime | |
| | AcceptanceStatusCode | |
| | Note | |
| | ItemListComplete | |
| | TransmissionIndicator | |
| | BuyerParty | |
| | | ID |
| | SellerParty | |
| | ProductRecipientParty | |
| | VendorParty | |
| | ManufacturerParty | |
| | BillToParty | |
| | PayerParty | |
| | CarrierParty | |
| | ShipToLocation | |
| | | ID |
| | ShipFromLocation | |

During the integration step, the designers classify the relationship (i.e., aggregation or association) between the object node and the object being integrated into the business object model. The system also integrates the new attributes into the object node (step 2120). If at step 2116, the system determines that the component is not in the business object model, the system adds the component to the business object model (step 2122).

Regardless of whether the component was in the business object model at step 2116, the next step in creating the business object model is to add the integrity rules (step 2124). There are several levels of integrity rules and constraints which should be described. These levels include consistency rules between attributes, consistency rules between components, and consistency rules to other objects. Next, the designers determine the services offered, which can be accessed via interfaces (step 2126). The services offered in the example above include PurchaseOrderCreateRequest, PurchaseOrderCancellationRequest, and PurchaseOrderReleaseRequest. The system then receives an indication of the location for the object in the business object model (step 2128). After receiving the indication of the location, the system integrates the object into the business object model (step 2130).

4. Structure of the Business Object Model

The business object model, which serves as the basis for the process of generating consistent interfaces, includes the elements contained within the interfaces. These elements are arranged in a hierarchical structure within the business object model.

5. Interfaces Derived from Business Object Model

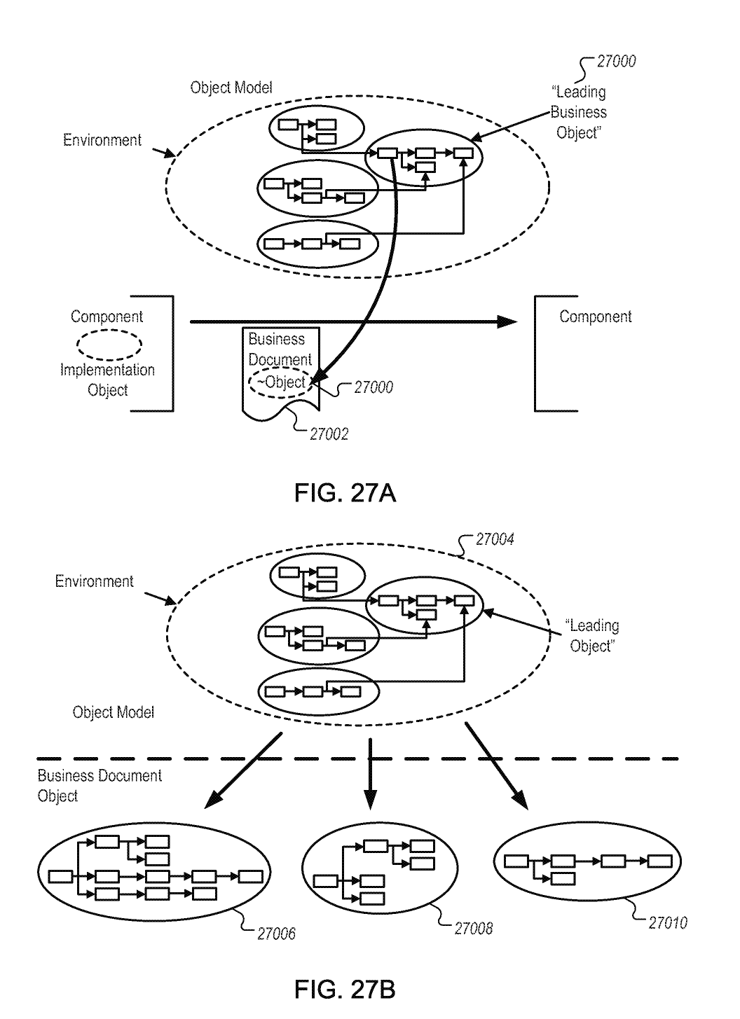

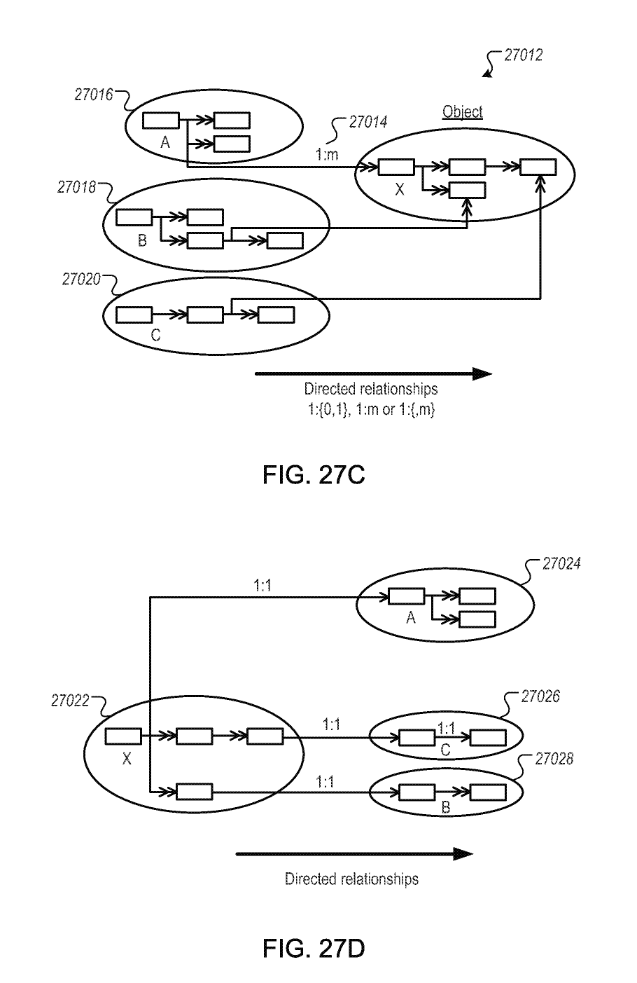

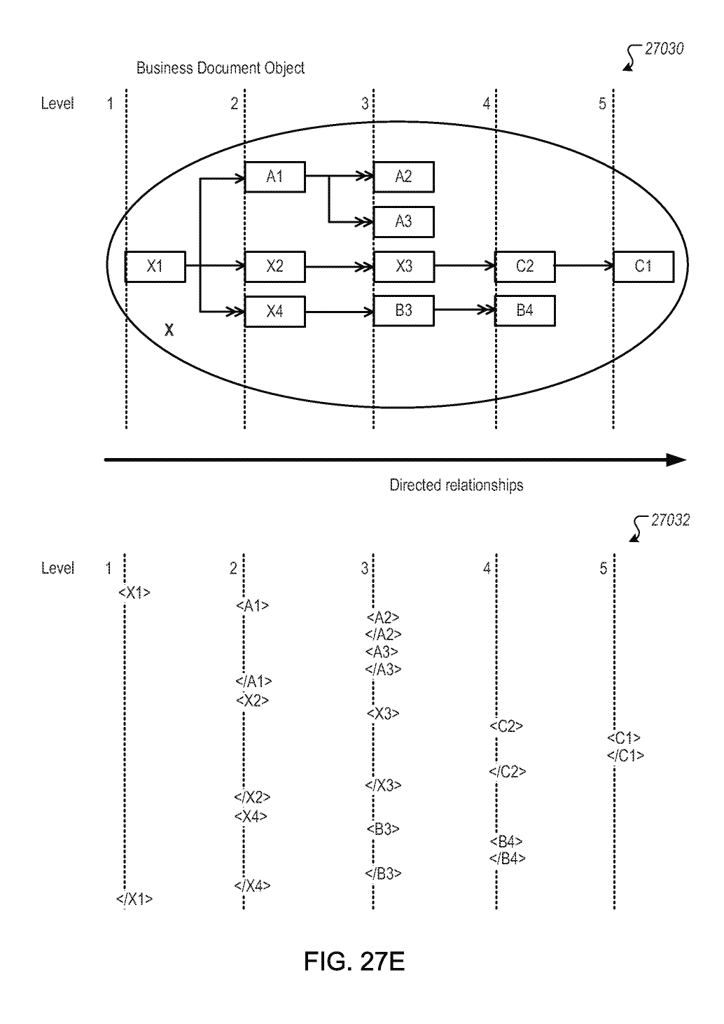

Interfaces are the starting point of the communication between two business entities. The structure of each interface determines how one business entity communicates with another business entity. The business entities may act as a unified whole when, based on the business scenario, the business entities know what an interface contains from a business perspective and how to fill the individual elements or fields of the interface. As illustrated in FIG. 27A, communication between components takes place via messages that contain business documents (e.g., business document 27002). The business document 27002 ensures a holistic business-related understanding for the recipient of the message. The business documents are created and accepted or consumed by interfaces, specifically by inbound and outbound interfaces. The interface structure and, hence, the structure of the business document are derived by a mapping rule. This mapping rule is known as “hierarchization.” An interface structure thus has a hierarchical structure created based on the leading business object 27000. The interface represents a usage-specific, hierarchical view of the underlying usage-neutral object model.

As illustrated in FIG. 27B, several business document objects 27006, 27008, and 27010 as overlapping views may be derived for a given leading object 27004. Each business document object results from the object model by hierarchization.

To illustrate the hierarchization process, FIG. 27C depicts an example of an object model 27012 (i.e., a portion of the business object model) that is used to derive a service operation signature (business document object structure). As depicted, leading object X 27014 in the object model 27012 is integrated in a net of object A 27016, object B 27018, and object C 27020. Initially, the parts of the leading object 27014 that are required for the business object document are adopted. In one variation, all parts required for a business document object are adopted from leading object 27014 (making such an operation a maximal service operation). Based on these parts, the relationships to the superordinate objects (i.e., objects A, B, and C from which object X depends) are inverted. In other words, these objects are adopted as dependent or subordinate objects in the new business document object.

For example, object A 27016, object B 27018, and object C 27020 have information that characterize object X. Because object A 27016, object B 27018, and object C 27020 are superordinate to leading object X 27014, the dependencies of these relationships change so that object A 27016, object B 27018, and object C 27020 become dependent and subordinate to leading object X 27014. This procedure is known as “derivation of the business document object by hierarchization.”

Business-related objects generally have an internal structure (parts). This structure can be complex and reflect the individual parts of an object and their mutual dependency. When creating the operation signature, the internal structure of an object is strictly hierarchized. Thus, dependent parts keep their dependency structure, and relationships between the parts within the object that do not represent the hierarchical structure are resolved by prioritizing one of the relationships.

Relationships of object X to external objects that are referenced and whose information characterizes object X are added to the operation signature. Such a structure can be quite complex (see, for example, FIG. 27D). The cardinality to these referenced objects is adopted as 1:1 or 1:C, respectively. By this, the direction of the dependency changes. The required parts of this referenced object are adopted identically, both in their cardinality and in their dependency arrangement.

The newly created business document object contains all required information, including the incorporated master data information of the referenced objects. As depicted in FIG. 27D, components Xi in leading object X 27022 are adopted directly. The relationship of object X 27022 to object A 27024, object B 27028, and object C 27026 are inverted, and the parts required by these objects are added as objects that depend from object X 27022. As depicted, all of object A 27024 is adopted. B3 and B4 are adopted from object B 27028, but B1 is not adopted. From object C 27026, C2 and C1 are adopted, but C3 is not adopted.

FIG. 27E depicts the business document object X 27030 created by this hierarchization process. As shown, the arrangement of the elements corresponds to their dependency levels, which directly leads to a corresponding representation as an XML structure 27032.

The following provides certain rules that can be adopted singly or in combination with regard to the hierarchization process. A business document object always refers to a leading business document object and is derived from this object. The name of the root entity in the business document entity is the name of the business object or the name of a specialization of the business object or the name of a service specific view onto the business object. The nodes and elements of the business object that are relevant (according to the semantics of the associated message type) are contained as entities and elements in the business document object.

The name of a business document entity is predefined by the name of the corresponding business object node. The name of the superordinate entity is not repeated in the name of the business document entity. The “full” semantic name results from the concatenation of the entity names along the hierarchical structure of the business document object.

The structure of the business document object is, except for deviations due to hierarchization, the same as the structure of the business object. The cardinalities of the business document object nodes and elements are adopted identically or more restrictively to the business document object. An object from which the leading business object is dependent can be adopted to the business document object. For this arrangement, the relationship is inverted, and the object (or its parts, respectively) are hierarchically subordinated in the business document object.

Nodes in the business object representing generalized business information can be adopted as explicit entities to the business document object (generally speaking, multiply TypeCodes out). When this adoption occurs, the entities are named according to their more specific semantic (name of TypeCode becomes prefix). Party nodes of the business object are modeled as explicit entities for each party role in the business document object. These nodes are given the name <Prefix><Party Role>Party, for example, BuyerParty, ItemBuyerParty. BTDReference nodes are modeled as separate entities for each reference type in the business document object. These nodes are given the name <Qualifier><BO><Node>Reference, for example SalesOrderReference, OriginSalesOrderReference, SalesOrderItemReference. A product node in the business object comprises all of the information on the Product, ProductCategory, and Batch. This information is modeled in the business document object as explicit entities for Product, ProductCategory, and Batch.

Entities which are connected by a 1:1 relationship as a result of hierarchization can be combined to a single entity, if they are semantically equivalent. Such a combination can often occurs if a node in the business document object that results from an assignment node is removed because it does not have any elements.

The message type structure is typed with data types. Elements are typed by GDTs according to their business objects. Aggregated levels are typed with message type specific data types (Intermediate Data Types), with their names being built according to the corresponding paths in the message type structure. The whole message type structured is typed by a message data type with its name being built according to the root entity with the suffix “Message”. For the message type, the message category (e.g., information, notification, query, response, request, confirmation, etc.) is specified according to the suited transaction communication pattern.

In one variation, the derivation by hierarchization can be initiated by specifying a leading business object and a desired view relevant for a selected service operation. This view determines the business document object. The leading business object can be the source object, the target object, or a third object. Thereafter, the parts of the business object required for the view are determined. The parts are connected to the root node via a valid path along the hierarchy. Thereafter, one or more independent objects (object parts, respectively) referenced by the leading object which are relevant for the service may be determined (provided that a relationship exists between the leading object and the one or more independent objects).

Once the selection is finalized, relevant nodes of the leading object node that are structurally identical to the message type structure can then be adopted. If nodes are adopted from independent objects or object parts, the relationships to such independent objects or object parts are inverted. Linearization can occur such that a business object node containing certain TypeCodes is represented in the message type structure by explicit entities (an entity for each value of the TypeCode). The structure can be reduced by checking all 1:1 cardinalities in the message type structure. Entities can be combined if they are semantically equivalent, one of the entities carries no elements, or an entity solely results from an n:m assignment in the business object.

After the hierarchization is completed, information regarding transmission of the business document object (e.g., CompleteTransmissionIndicator, ActionCodes, message category, etc.) can be added. A standardized message header can be added to the message type structure and the message structure can be typed. Additionally, the message category for the message type can be designated.

Invoice Request and Invoice Confirmation are examples of interfaces. These invoice interfaces are used to exchange invoices and invoice confirmations between an invoicing party and an invoice recipient (such as between a seller and a buyer) in a B2B process. Companies can create invoices in electronic as well as in paper form. Traditional methods of communication, such as mail or fax, for invoicing are cost intensive, prone to error, and relatively slow, since the data is recorded manually. Electronic communication eliminates such problems. The motivating business scenarios for the Invoice Request and Invoice Confirmation interfaces are the Procure to Stock (PTS) and Sell from Stock (SFS) scenarios. In the PTS scenario, the parties use invoice interfaces to purchase and settle goods. In the SFS scenario, the parties use invoice interfaces to sell and invoice goods. The invoice interfaces directly integrate the applications implementing them and also form the basis for mapping data to widely-used XML standard formats such as RosettaNet, PIDX, xCBL, and CIDX.

The invoicing party may use two different messages to map a B2B invoicing process: (1) the invoicing party sends the message type InvoiceRequest to the invoice recipient to start a new invoicing process; and (2) the invoice recipient sends the message type InvoiceConfirmation to the invoicing party to confirm or reject an entire invoice or to temporarily assign it the status “pending.”

An InvoiceRequest is a legally binding notification of claims or liabilities for delivered goods and rendered services—usually, a payment request for the particular goods and services. The message type InvoiceRequest is based on the message data type InvoiceMessage. The InvoiceRequest message (as defined) transfers invoices in the broader sense. This includes the specific invoice (request to settle a liability), the debit memo, and the credit memo.

InvoiceConfirmation is a response sent by the recipient to the invoicing party confirming or rejecting the entire invoice received or stating that it has been assigned temporarily the status “pending.” The message type InvoiceConfirmation is based on the message data type InvoiceMessage. An InvoiceConfirmation is not mandatory in a B2B invoicing process, however, it automates collaborative processes and dispute management.

Usually, the invoice is created after it has been confirmed that the goods were delivered or the service was provided. The invoicing party (such as the seller) starts the invoicing process by sending an InvoiceRequest message. Upon receiving the InvoiceRequest message, the invoice recipient (for instance, the buyer) can use the InvoiceConfirmation message to completely accept or reject the invoice received or to temporarily assign it the status “pending.” The InvoiceConfirmation is not a negotiation tool (as is the case in order management), since the options available are either to accept or reject the entire invoice. The invoice data in the InvoiceConfirmation message merely confirms that the invoice has been forwarded correctly and does not communicate any desired changes to the invoice. Therefore, the InvoiceConfirmation includes the precise invoice data that the invoice recipient received and checked. If the invoice recipient rejects an invoice, the invoicing party can send a new invoice after checking the reason for rejection (AcceptanceStatus and ConfirmationDescription at Invoice and InvoiceItem level). If the invoice recipient does not respond, the invoice is generally regarded as being accepted and the invoicing party can expect payment.

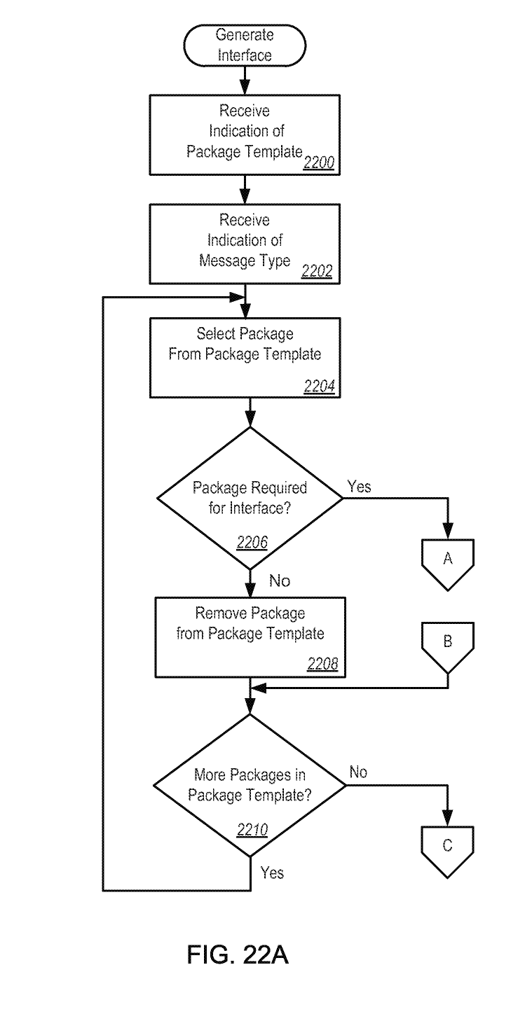

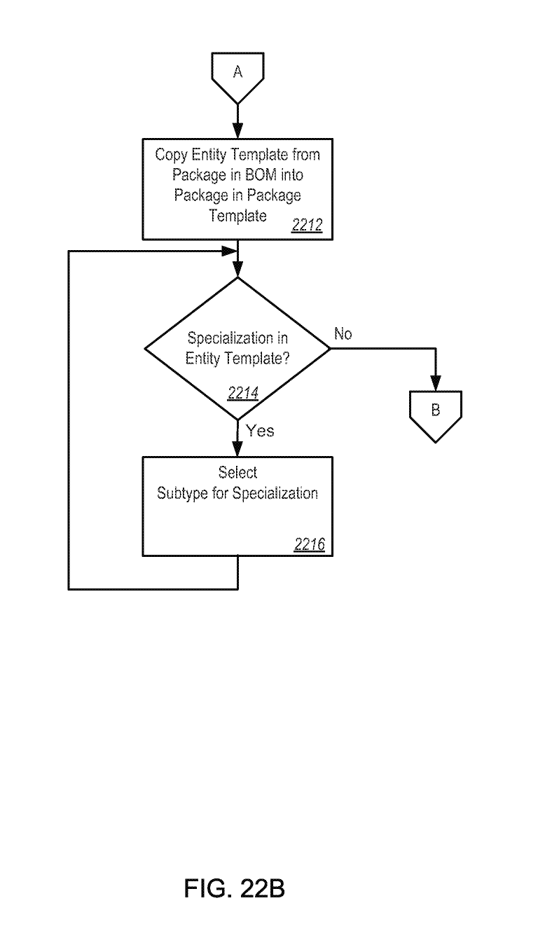

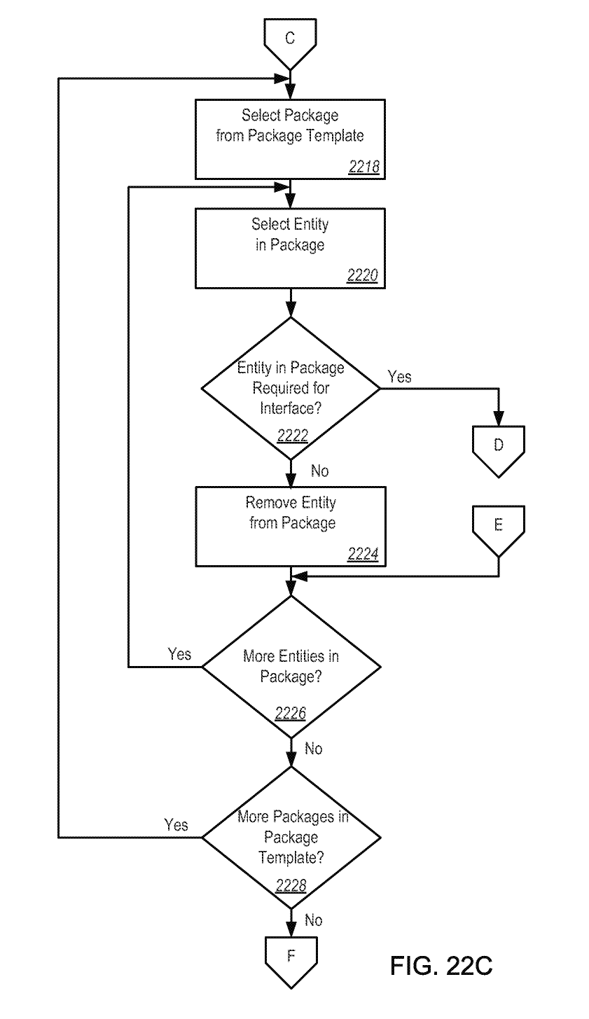

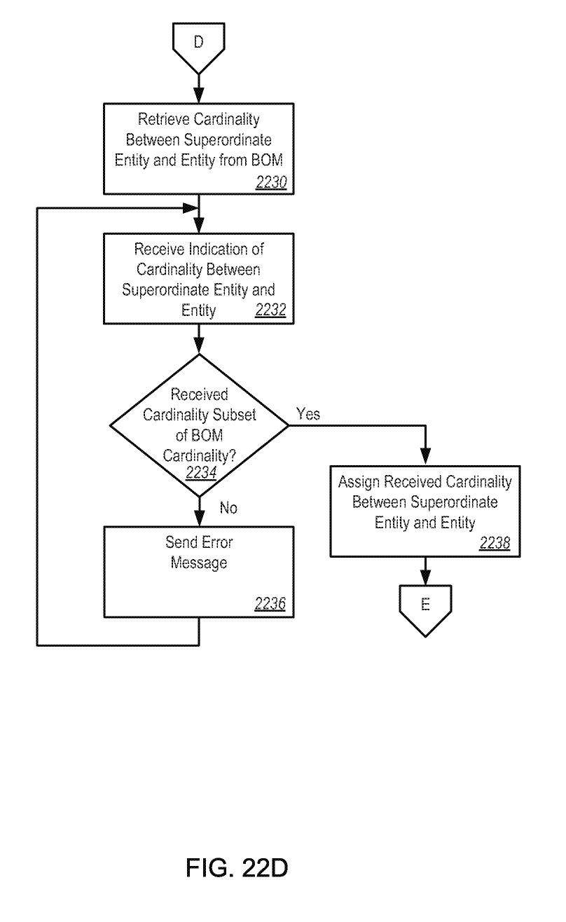

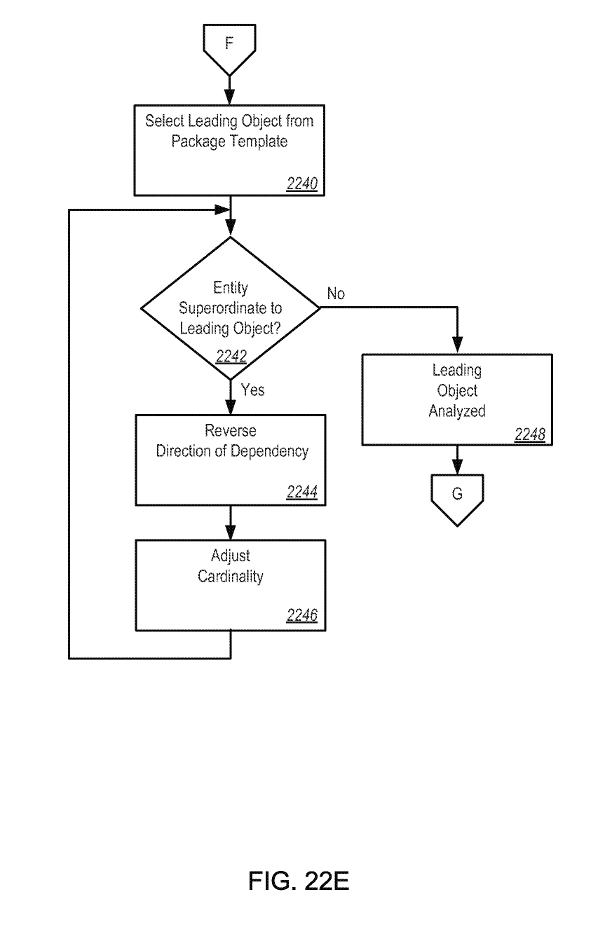

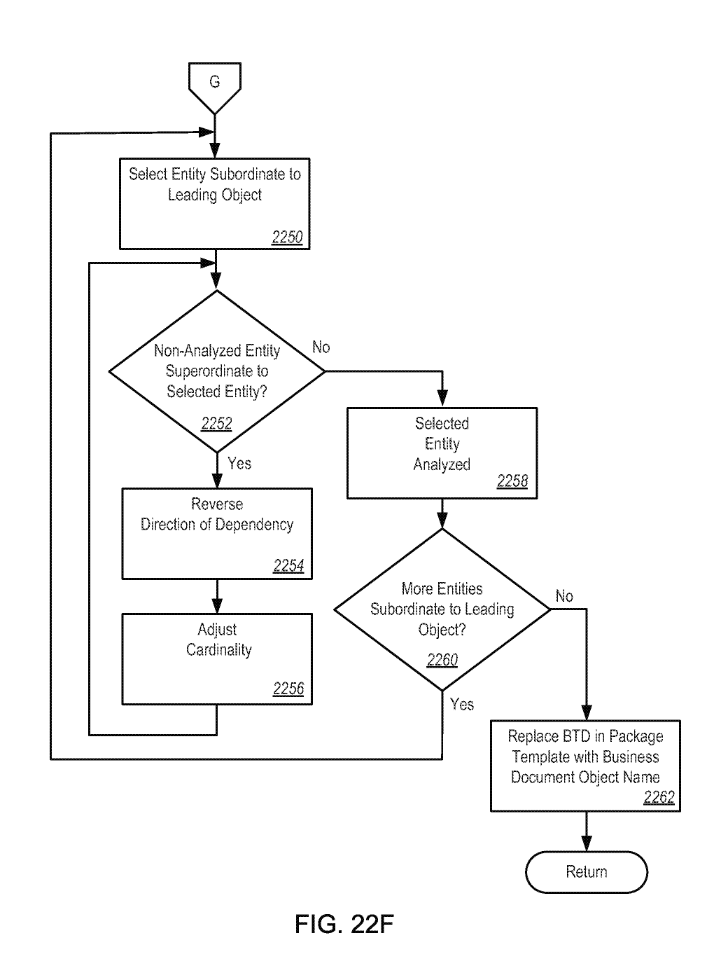

FIGS. 22A-F depict a flow diagram of the steps performed by methods and systems consistent with the subject matter described herein to generate an interface from the business object model. Although described as being performed by a computer, these steps may alternatively be performed manually, or using any combination thereof. The process begins when the system receives an indication of a package template from the designer, i.e., the designer provides a package template to the system (step 2200).

Package templates specify the arrangement of packages within a business transaction document. Package templates are used to define the overall structure of the messages sent between business entities. Methods and systems consistent with the subject matter described herein use package templates in conjunction with the business object model to derive the interfaces.

The system also receives an indication of the message type from the designer (step 2202). The system selects a package from the package template (step 2204), and receives an indication from the designer whether the package is required for the interface (step 2206). If the package is not required for the interface, the system removes the package from the package template (step 2208). The system then continues this analysis for the remaining packages within the package template (step 2210).

If, at step 2206, the package is required for the interface, the system copies the entity template from the package in the business object model into the package in the package template (step 2212, FIG. 22B). The system determines whether there is a specialization in the entity template (step 2214). If the system determines that there is a specialization in the entity template, the system selects a subtype for the specialization (step 2216). The system may either select the subtype for the specialization based on the message type, or it may receive this information from the designer. The system then determines whether there are any other specializations in the entity template (step 2214). When the system determines that there are no specializations in the entity template, the system continues this analysis for the remaining packages within the package template (step 2210, FIG. 22A).

At step 2210, after the system completes its analysis for the packages within the package template, the system selects one of the packages remaining in the package template (step 2218, FIG. 22C), and selects an entity from the package (step 2220). The system receives an indication from the designer whether the entity is required for the interface (step 2222). If the entity is not required for the interface, the system removes the entity from the package template (step 2224). The system then continues this analysis for the remaining entities within the package (step 2226), and for the remaining packages within the package template (step 2228).

If, at step 2222, the entity is required for the interface, the system retrieves the cardinality between a superordinate entity and the entity from the business object model (step 2230, FIG. 22D). The system also receives an indication of the cardinality between the superordinate entity and the entity from the designer (step 2232). The system then determines whether the received cardinality is a subset of the business object model cardinality (step 2234). If the received cardinality is not a subset of the business object model cardinality, the system sends an error message to the designer (step 2236). If the received cardinality is a subset of the business object model cardinality, the system assigns the received cardinality as the cardinality between the superordinate entity and the entity (step 2238). The system then continues this analysis for the remaining entities within the package (step 2226, FIG. 22C), and for the remaining packages within the package template (step 2228).

The system then selects a leading object from the package template (step 2240, FIG. 22E). The system determines whether there is an entity superordinate to the leading object (step 2242). If the system determines that there is an entity superordinate to the leading object, the system reverses the direction of the dependency (step 2244) and adjusts the cardinality between the leading object and the entity (step 2246). The system performs this analysis for entities that are superordinate to the leading object (step 2242). If the system determines that there are no entities superordinate to the leading object, the system identifies the leading object as analyzed (step 2248).

The system then selects an entity that is subordinate to the leading object (step 2250, FIG. 22F). The system determines whether any non-analyzed entities are superordinate to the selected entity (step 2252). If a non-analyzed entity is superordinate to the selected entity, the system reverses the direction of the dependency (step 2254) and adjusts the cardinality between the selected entity and the non-analyzed entity (step 2256). The system performs this analysis for non-analyzed entities that are superordinate to the selected entity (step 2252). If the system determines that there are no non-analyzed entities superordinate to the selected entity, the system identifies the selected entity as analyzed (step 2258), and continues this analysis for entities that are subordinate to the leading object (step 2260). After the packages have been analyzed, the system substitutes the BusinessTransactionDocument (“BTD”) in the package template with the name of the interface (step 2262). This includes the “BTD” in the BTDItem package and the “BTD” in the BTDItemScheduleLine package.

6. Use of an Interface

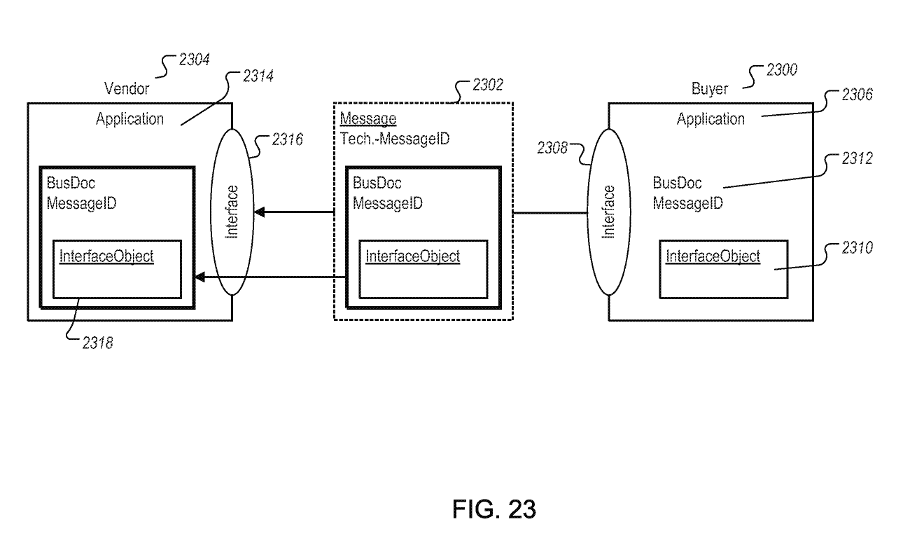

The XI stores the interfaces (as an interface type). At runtime, the sending party's program instantiates the interface to create a business document, and sends the business document in a message to the recipient. The messages are preferably defined using XML. In the example depicted in FIG. 23, the Buyer 2300 uses an application 2306 in its system to instantiate an interface 2308 and create an interface object or business document object 2310. The Buyer's application 2306 uses data that is in the sender's component-specific structure and fills the business document object 2310 with the data. The Buyer's application 2306 then adds message identification 2312 to the business document and places the business document into a message 2302. The Buyer's application 2306 sends the message 2302 to the Vendor 2304. The Vendor 2304 uses an application 2314 in its system to receive the message 2302 and store the business document into its own memory. The Vendor's application 2314 unpacks the message 2302 using the corresponding interface 2316 stored in its XI to obtain the relevant data from the interface object or business document object 2318.

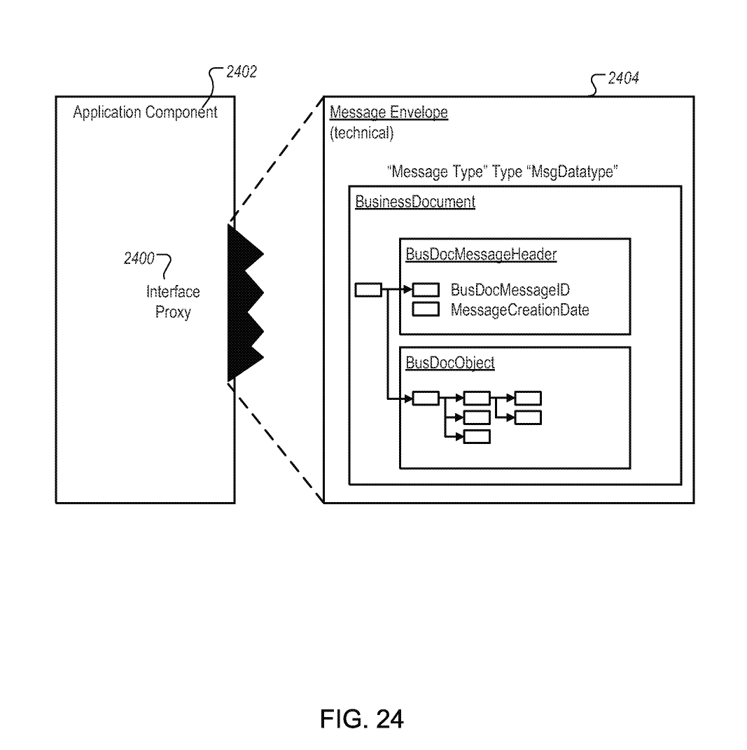

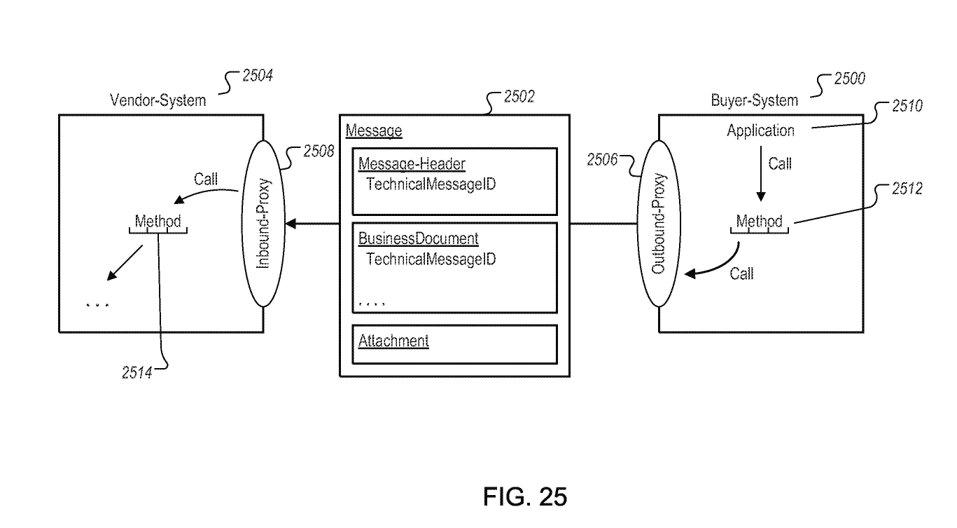

From the component's perspective, the interface is represented by an interface proxy 2400, as depicted in FIG. 24. The proxies 2400 shield the components 2402 of the sender and recipient from the technical details of sending messages 2404 via XI. In particular, as depicted in FIG. 25, at the sending end, the Buyer 2500 uses an application 2510 in its system to call an implemented method 2512, which generates the outbound proxy 2506. The outbound proxy 2506 parses the internal data structure of the components and converts them to the XML structure in accordance with the business document object. The outbound proxy 2506 packs the document into a message 2502. Transport, routing and mapping the XML message to the recipient 28304 is done by the routing system (XI, modeling environment 516, etc.).

When the message arrives, the recipient's inbound proxy 2508 calls its component-specific method 2514 for creating a document. The proxy 2508 at the receiving end downloads the data and converts the XML structure into the internal data structure of the recipient component 2504 for further processing.

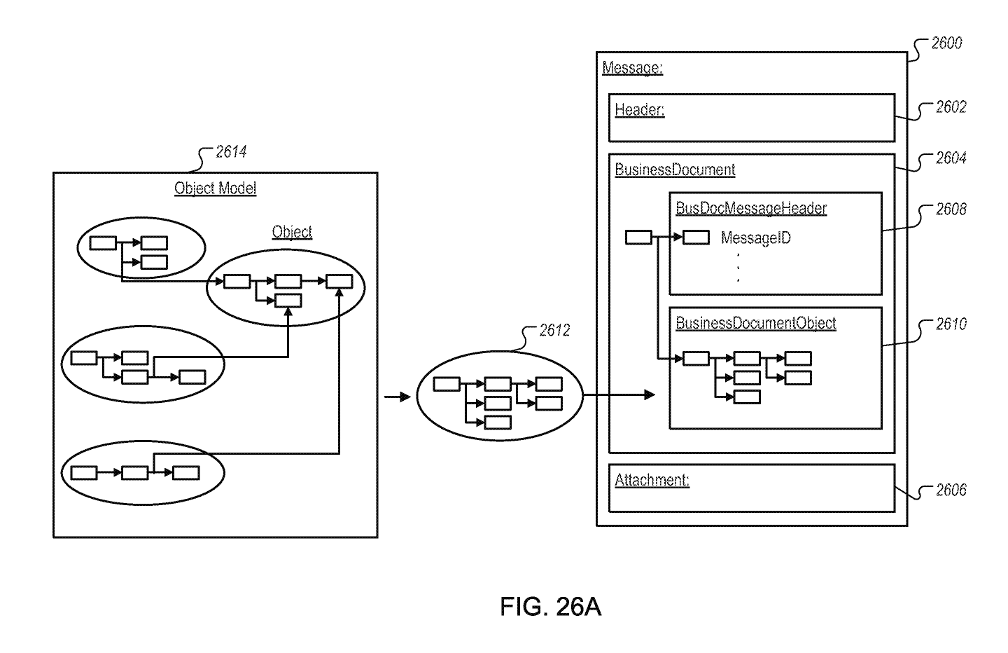

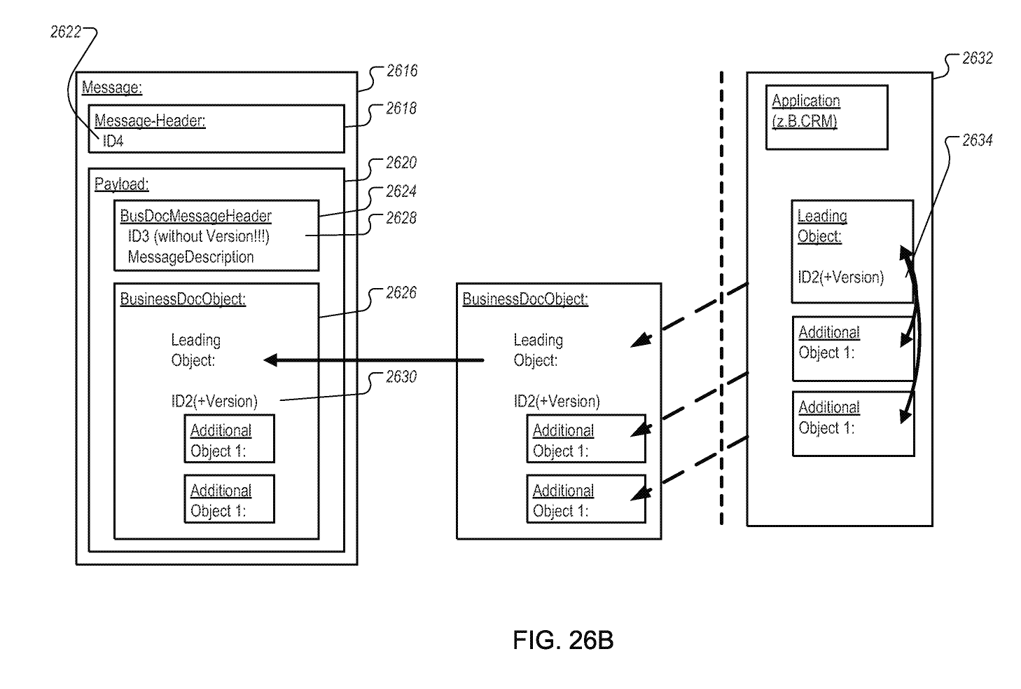

As depicted in FIG. 26A, a message 2600 includes a message header 2602 and a business document 2604. The message 2600 also may include an attachment 2606. For example, the sender may attach technical drawings, detailed specifications or pictures of a product to a purchase order for the product. The business document 2604 includes a business document message header 2608 and the business document object 2610. The business document message header 2608 includes administrative data, such as the message ID and a message description. As discussed above, the structure 2612 of the business document object 2610 is derived from the business object model 2614. Thus, there is a strong correlation between the structure of the business document object and the structure of the business object model. The business document object 2610 forms the core of the message 2600.

In collaborative processes as well as Q&A processes, messages should refer to documents from previous messages. A simple business document object ID or object ID is insufficient to identify individual messages uniquely because several versions of the same business document object can be sent during a transaction. A business document object ID with a version number also is insufficient because the same version of a business document object can be sent several times. Thus, messages require several identifiers during the course of a transaction.

As depicted in FIG. 26B, the message header 2618 in message 2616 includes a technical ID (“ID4”) 2622 that identifies the address for a computer to route the message. The sender's system manages the technical ID 2622.

The administrative information in the business document message header 2624 of the payload or business document 2620 includes a BusinessDocumentMessageID (“ID3”) 2628. The business entity or component 2632 of the business entity manages and sets the BusinessDocumentMessageID 2628. The business entity or component 2632 also can refer to other business documents using the BusinessDocumentMessageID 2628. The receiving component 2632 requires no knowledge regarding the structure of this ID. The BusinessDocumentMessageID 2628 is, as an ID, unique. Creation of a message refers to a point in time. No versioning is typically expressed by the ID. Besides the BusinessDocumentMessageID 2628, there also is a business document object ID 2630, which may include versions.

The component 2632 also adds its own component object ID 2634 when the business document object is stored in the component. The component object ID 2634 identifies the business document object when it is stored within the component. However, not all communication partners may be aware of the internal structure of the component object ID 2634. Some components also may include a versioning in their ID 2634.

7. Use of Interfaces Across Industries

Methods and systems consistent with the subject matter described herein provide interfaces that may be used across different business areas for different industries. Indeed, the interfaces derived using methods and systems consistent with the subject matter described herein may be mapped onto the interfaces of different industry standards. Unlike the interfaces provided by any given standard that do not include the interfaces required by other standards, methods and systems consistent with the subject matter described herein provide a set of consistent interfaces that correspond to the interfaces provided by different industry standards. Due to the different fields provided by each standard, the interface from one standard does not easily map onto another standard. By comparison, to map onto the different industry standards, the interfaces derived using methods and systems consistent with the subject matter described herein include most of the fields provided by the interfaces of different industry standards. Missing fields may easily be included into the business object model. Thus, by derivation, the interfaces can be extended consistently by these fields. Thus, methods and systems consistent with the subject matter described herein provide consistent interfaces or services that can be used across different industry standards.

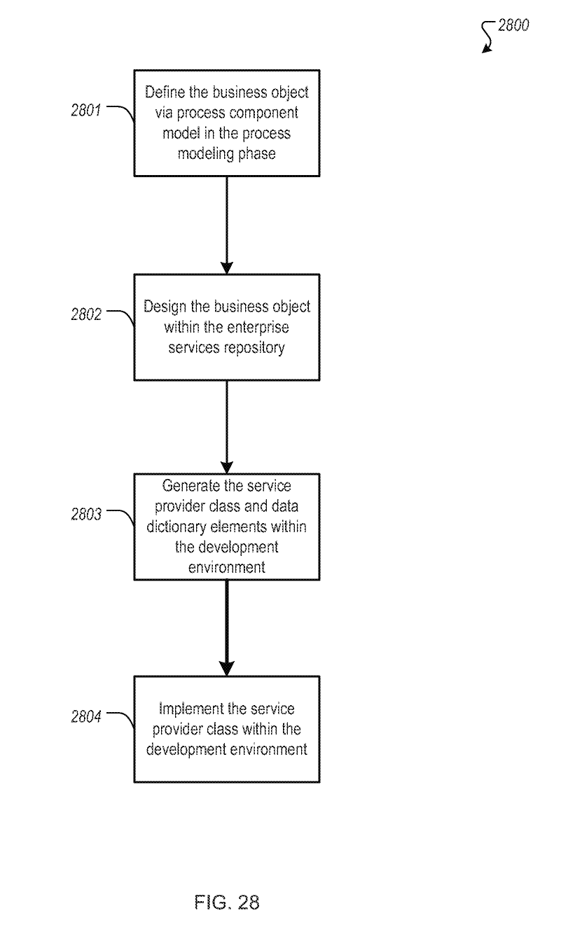

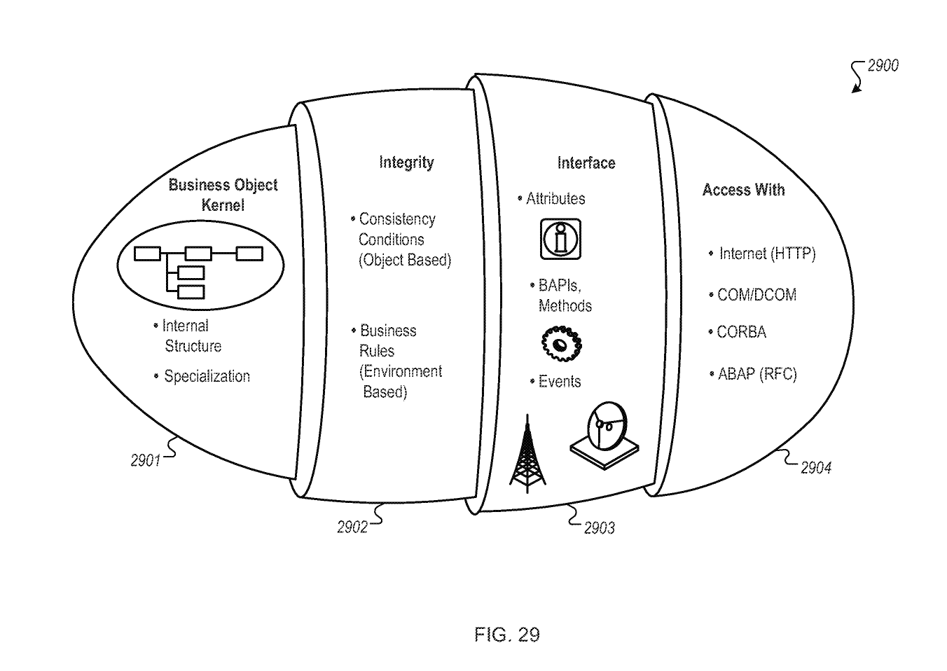

For example, FIG. 28 illustrates an example method 2800 for service enabling. In this example, the enterprise services infrastructure may offer one common and standard-based service infrastructure. Further, one central enterprise services repository may support uniform service definition, implementation and usage of services for user interface, and cross-application communication. In step 2801, a business object is defined via a process component model in a process modeling phase. Next, in step 2802, the business object is designed within an enterprise services repository. For example, FIG. 29 provides a graphical representation of one of the business objects 2900. As shown, an innermost layer or kernel 2901 of the business object may represent the business object's inherent data. Inherent data may include, for example, an employee's name, age, status, position, address, etc. A second layer 2902 may be considered the business object's logic. Thus, the layer 2902 includes the rules for consistently embedding the business object in a system environment as well as constraints defining values and domains applicable to the business object. For example, one such constraint may limit sale of an item only to a customer with whom a company has a business relationship. A third layer 2903 includes validation options for accessing the business object. For example, the third layer 2903 defines the business object's interface that may be interfaced by other business objects or applications. A fourth layer 2904 is the access layer that defines technologies that may externally access the business object.

Accordingly, the third layer 2903 separates the inherent data of the first layer 2901 and the technologies used to access the inherent data. As a result of the described structure, the business object reveals only an interface that includes a set of clearly defined methods. Thus, applications access the business object via those defined methods. An application wanting access to the business object and the data associated therewith usually includes the information or data to execute the clearly defined methods of the business object's interface. Such clearly defined methods of the business object's interface represent the business object's behavior. That is, when the methods are executed, the methods may change the business object's data. Therefore, an application may utilize any business object by providing the information or data without having any concern for the details related to the internal operation of the business object. Returning to method 2800, a service provider class and data dictionary elements are generated within a development environment at step 2803. In step 2804, the service provider class is implemented within the development environment.

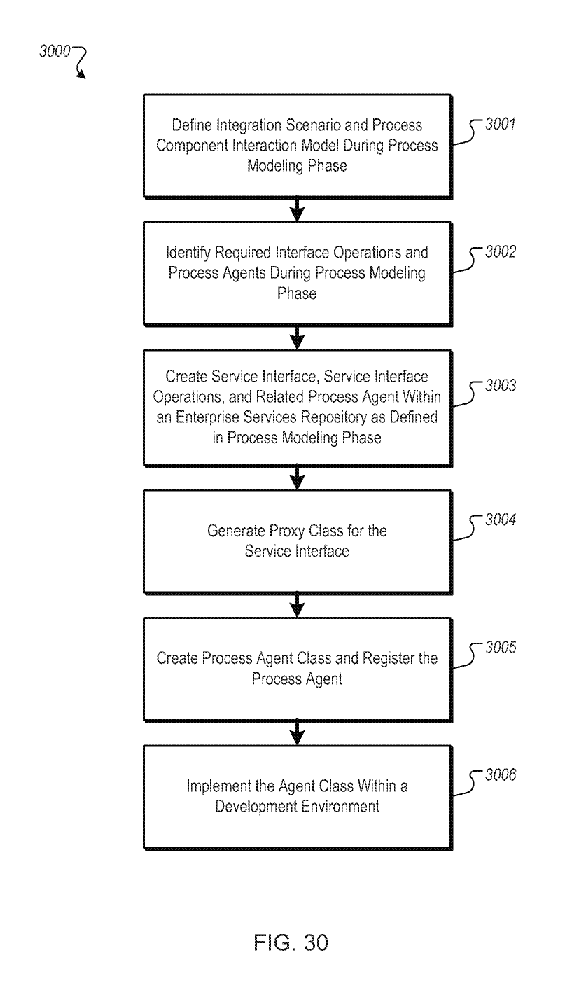

FIG. 30 illustrates an example method 3000 for a process agent framework. For example, the process agent framework may be the basic infrastructure to integrate business processes located in different deployment units. It may support a loose coupling of these processes by message based integration. A process agent may encapsulate the process integration logic and separate it from business logic of business objects. As shown in FIG. 30, an integration scenario and a process component interaction model are defined during a process modeling phase in step 3001. In step 3002, required interface operations and process agents are identified during the process modeling phase also. Next, in step 3003, a service interface, service interface operations, and the related process agent are created within an enterprise services repository as defined in the process modeling phase. In step 3004, a proxy class for the service interface is generated. Next, in step 3005, a process agent class is created and the process agent is registered. In step 3006, the agent class is implemented within a development environment.

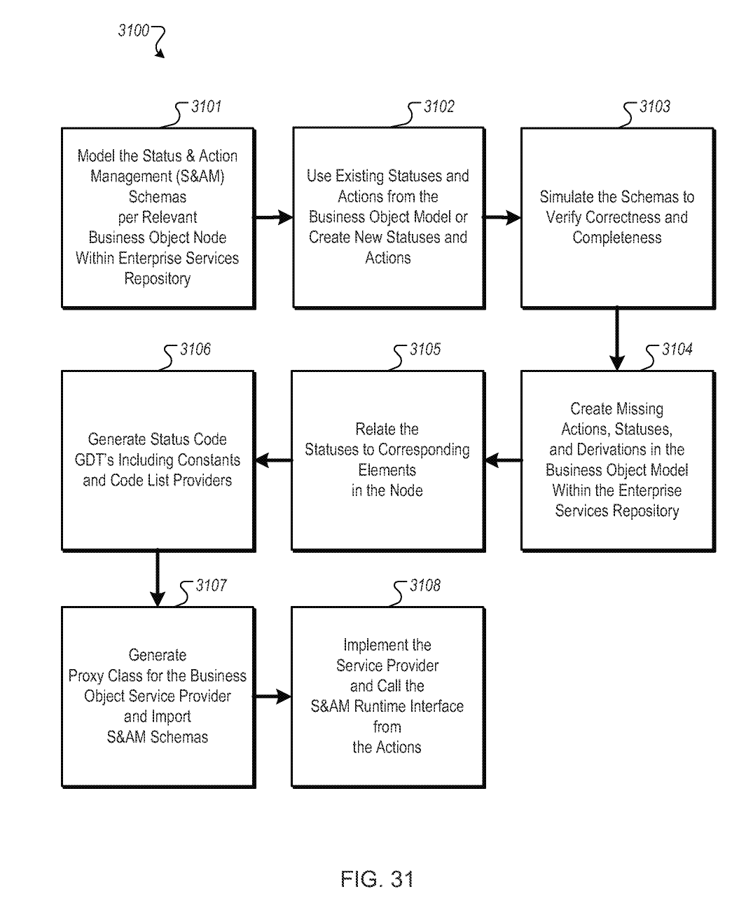

FIG. 31 illustrates an example method 3100 for status and action management (S&AM). For example, status and action management may describe the life cycle of a business object (node) by defining actions and statuses (as their result) of the business object (node), as well as, the constraints that the statuses put on the actions. In step 3101, the status and action management schemas are modeled per a relevant business object node within an enterprise services repository. In step 3102, existing statuses and actions from the business object model are used or new statuses and actions are created. Next, in step 3103, the schemas are simulated to verify correctness and completeness. In step 3104, missing actions, statuses, and derivations are created in the business object model with the enterprise services repository. Continuing with method 3100, the statuses are related to corresponding elements in the node in step 3105. In step 3106, status code GDT's are generated, including constants and code list providers. Next, in step 3107, a proxy class for a business object service provider is generated and the proxy class S&AM schemas are imported. In step 3108, the service provider is implemented and the status and action management runtime interface is called from the actions.

Regardless of the particular hardware or software architecture used, the disclosed systems or software are generally capable of implementing business objects and deriving (or otherwise utilizing) consistent interfaces that are suitable for use across industries, across businesses, and across different departments within a business in accordance with some or all of the following description. In short, system 100 contemplates using any appropriate combination and arrangement of logical elements to implement some or all of the described functionality.

Moreover, the preceding flowcharts and accompanying description illustrate example methods. The present services environment contemplates using or implementing any suitable technique for performing these and other tasks. It will be understood that these methods are for illustration purposes only and that the described or similar techniques may be performed at any appropriate time, including concurrently, individually, or in combination. In addition, many of the steps in these flowcharts may take place simultaneously and/or in different orders than as shown. Moreover, the services environment may use methods with additional steps, fewer steps, and/or different steps, so long as the methods remain appropriate.

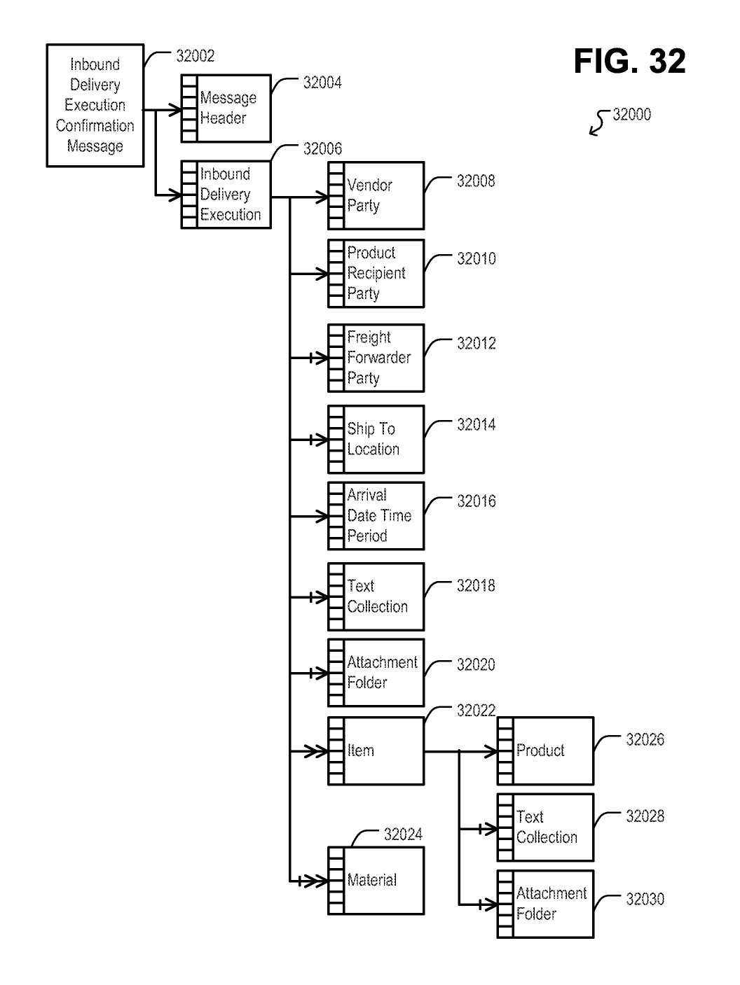

FIG. 32 illustrates one example logical configuration of an Inbound Delivery Execution Confirmation Message 32000. Specifically, this figure depicts the arrangement and hierarchy of various components such as one or more levels of packages, entities, and data types, shown here as 32002 through 32030. As described above, packages may be used to represent hierarchy levels, and different types of cardinality relationships among entities can be represented using different arrowhead styles. Entities are discrete business elements that are used during a business transaction. Data types are used to type object entities and interfaces with a structure. For example, the Inbound Delivery Execution Confirmation Message 32000 includes, among other things, the Inbound Delivery Execution entity 32006. Accordingly, heterogeneous applications may communicate using this consistent message configured as such.

The message type Inbound Delivery Execution Confirmation is derived from the business object Confirmed Inbound Delivery as a leading object together with its operation signature. The message type Inbound Delivery Execution Confirmation is a confirmation by a warehouse provider of goods received. The structure of the message type Inbound Delivery Execution Confirmation is determined by the message data type InboundDeliveryExecutionConfirmationMessage. The message data type InboundDeliveryExecutionConfirmationMessage includes the MessageHeader package and the InboundDeliveryExecution package. The package MessageHeader includes the sub-packages Party and Business Scope and the entity MessageHeader. MessageHeader is typed by datatype BusinessDocumentMessageHeader.

The package InboundDeliveryExecution includes the sub-packages Party, Location, ArrivalPeriod, TextCollection, AttachmentFolder, and ProductInformation, and the entity InboundDeliveryExecution. InboundDeliveryExecution includes the following non-node elements: ID, VendorID, TypeCode, Incoterms, GrossVolumeMeasure, GrossWeightMeasure, and SenderLastChangeDateTime.

ID may have a multiplicity of 1 and may be based on datatype BGDT:BusinessTransactionDocumentID. VendorID may have a multiplicity of 1 and may be based on datatype BGDT:BusinessTransactionDocumentID. TypeCode may have a multiplicity of 1 and may be based on datatype BGDT:BusinessTransactionDocumentTypeCode. Incoterms may have a multiplicity of 0.1 and may be based on datatype AGDT:Incoterms. GrossVolumeMeasure may have a multiplicity of 0.1 and may be based on datatype CDT:Measure. GrossWeightMeasure may have a multiplicity of 0.1 and may be based on datatype CDT:Measure. SenderLastChangeDateTime may have a multiplicity of 1 and may be based on datatype CDT: GLOBAL_DateTime.

InboundDeliveryExecution includes the following node elements: Vendor Party, with a cardinality of 1:1; ProductRecipientParty, with a cardinality of 1:1; FreightForwarderParty, with a cardinality of 1:C; ShipToLocation, with a cardinality of 1:C; ArrivalDateTimePeriod, with a cardinality of 1:1; TextCollection, with a cardinality of 1:C; AttachmentFolder, with a cardinality of 1:C; Item, with a cardinality of 1:N; and Material, with a cardinality of 1:CN.

The package InboundDeliveryExecutionParty includes the entities Vendor Party, ProductRecipientParty, and FreightForwarderParty. Vendor Party is typed by datatype BusinessTransactionDocumentParty. ProductRecipientParty is typed by datatype BusinessTransactionDocumentParty. FreightForwarderParty is typed by datatype BusinessTransactionDocumentParty.

The package InboundDeliveryExecutionLocation includes the entity ShipToLocation. ShipToLocation is typed by datatype BusinessTransactionDocumentLocation. The package InboundDeliveryExecutionArrivalPeriod includes the entity ArrivalDateTimePeriod. ArrivalDateTimePeriod is typed by datatype DateTimePeriod. The package InboundDeliveryExecutionTextCollection includes the sub-package Text and the entity TextCollection. TextCollection is typed by datatype TextCollection. The package InboundDeliveryExecutionAttachmentFolder includes the sub-package Document and the entity AttachmentFolder. AttachmentFolder is typed by datatype AttachmentFolder.

The package InboundDeliveryExecution includes the sub-packages ProductInformation, TextCollection, and AttachmentFolder, and the entity Item. Item includes the following non-node elements: ID, VendorID, PurchaseOrderReference, DeliveryQuantity, DeliveryQuantityTypeCode, DeliveryNoteQuantity, and DeliveryNoteQuantityTypeCode. ID may have a multiplicity of 1 and may be based on datatype BGDT:BusinessTransactionDocumentItemID VendorID may have a multiplicity of and may be based on datatype BGDT:BusinessTransactionDocumentItemID PurchaseOrderReference may have a multiplicity of 0.1 and may be based on datatype AGDT:BusinessTransactionDocumentReference. DeliveryQuantity may have a multiplicity of 1 and may be based on datatype CDT:Quantity. DeliveryQuantityTypeCode may have a multiplicity of 1 and may be based on datatype BGDT:QuantityTypeCode. DeliveryNoteQuantity may have a multiplicity of 0.1 and may be based on datatype CDT:Quantity. DeliveryNoteQuantityTypeCode may have a multiplicity of 0.1 and may be based on datatype BGDT:QuantityTypeCode.

Item includes the following node elements: Product, with a cardinality of 1:1; TextCollection, with a cardinality of 1:C; and AttachmentFolder, with a cardinality of 1:C. The package InboundDeliveryExecutionProductInformation includes the entity Product. Product is typed by datatype BusinessTransactionDocumentProduct.

The package InboundDeliveryExecutionTextCollection includes the sub-package Text and the entity TextCollection. TextCollection is typed by datatype TextCollection. The package InboundDeliveryExecutionAttachmentFolder includes the sub-package Document and the entity AttachmentFolder. AttachmentFolder is typed by datatype AttachmentFolder.

The package InboundDeliveryExecutionProductInformation includes the entity Material. Material includes the following non-node elements: ItemID, DeliveryQuantity, DeliveryQuantityTypeCode, DeliveryRestrictedQuantity, DeliveryRestrictedQuantityTypeCode, IdentifiedStockID, and SerialID. ItemID may have a multiplicity of 1 and may be based on datatype BGDT:BusinessTransactionDocumentItemID DeliveryQuantity may have a multiplicity of 1 and may be based on datatype CDT:Quantity. DeliveryQuantityTypeCode may have a multiplicity of 1 and may be based on datatype BGDT:QuantityTypeCode. DeliveryRestrictedQuantity may have a multiplicity of 0.1 and may be based on datatype CDT:Quantity. DeliveryRestrictedQuantityTypeCode may have a multiplicity of 0 . . . 1 and may be based on datatype BGDT:QuantityTypeCode. IdentifiedStockID may have a multiplicity of 0 . . . 1 and may be based on datatype BGDT:IdentifiedStockID. SerialID may have a multiplicity of 0 . . . * and may be based on datatype BGDT:SerialID.

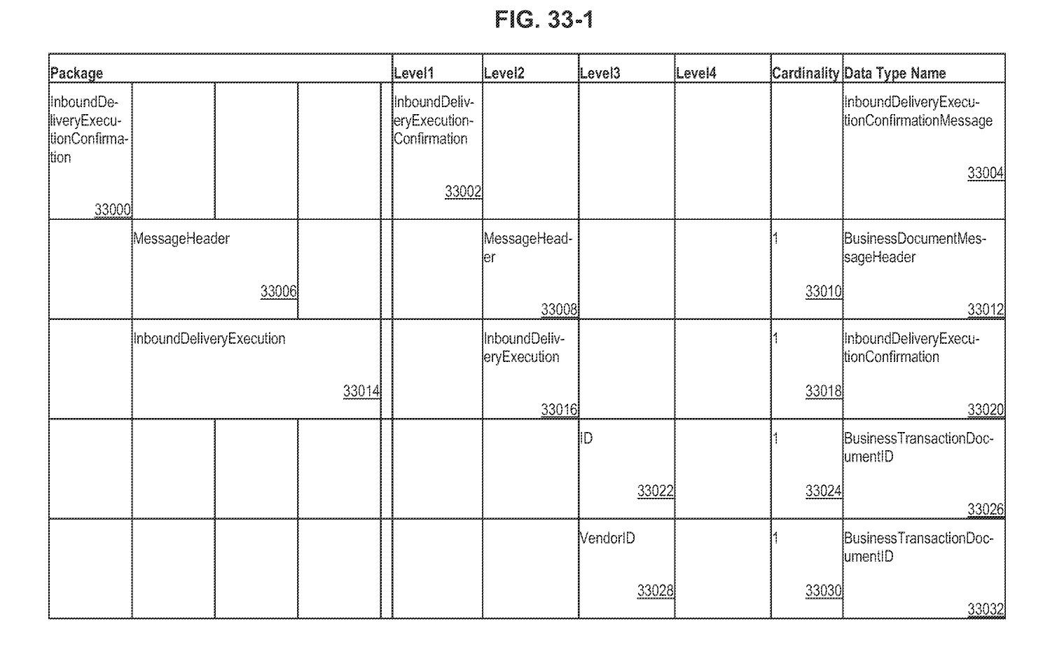

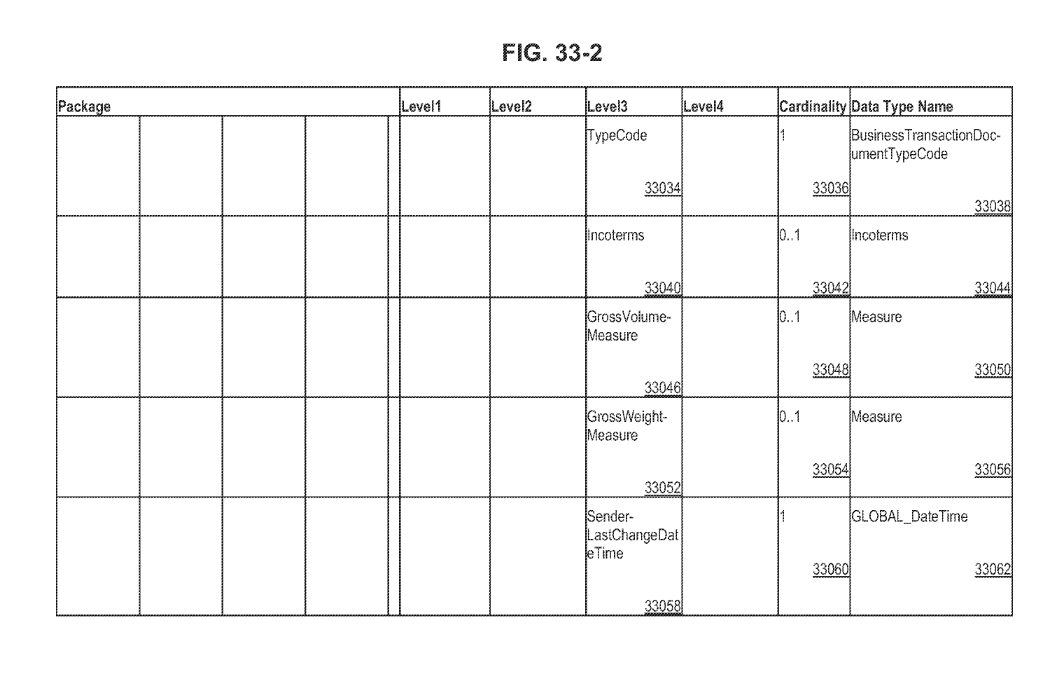

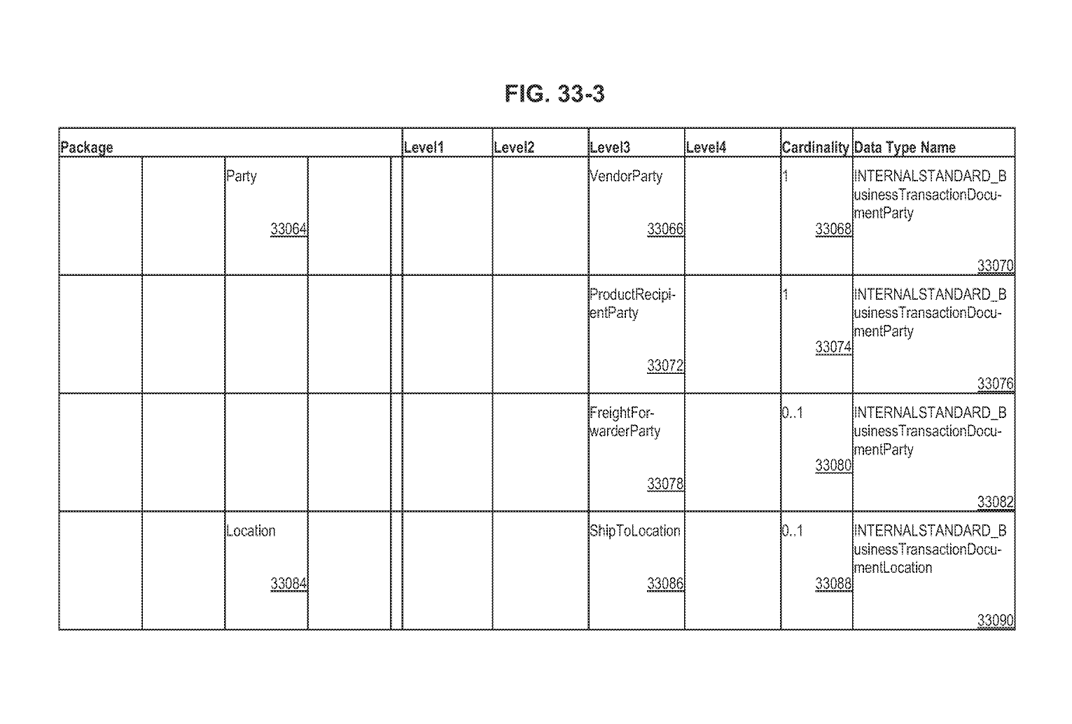

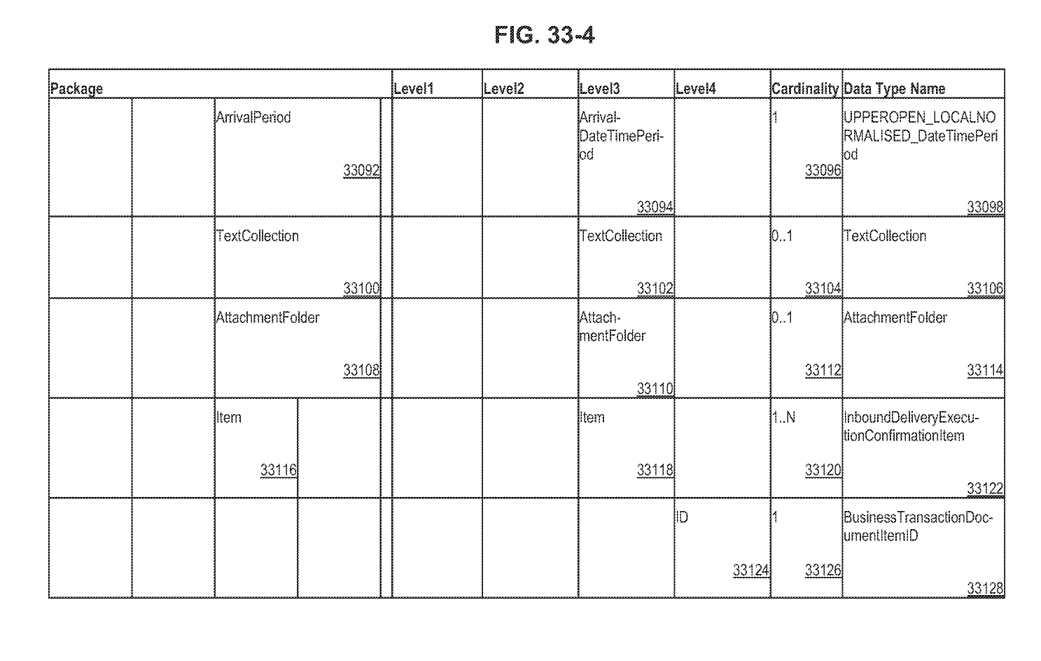

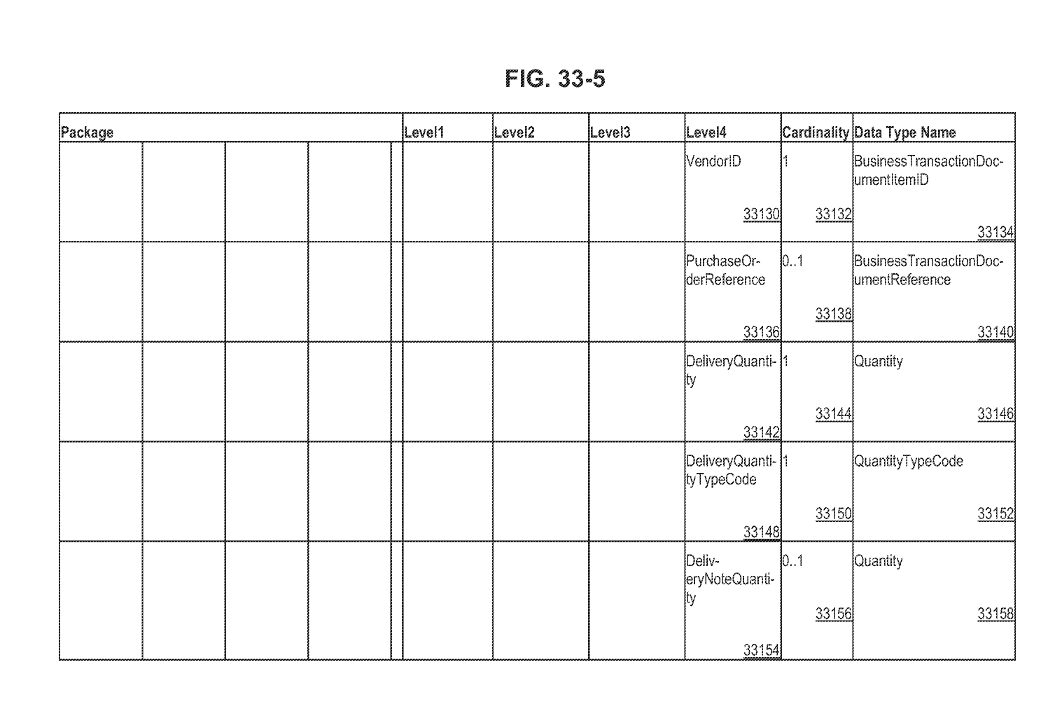

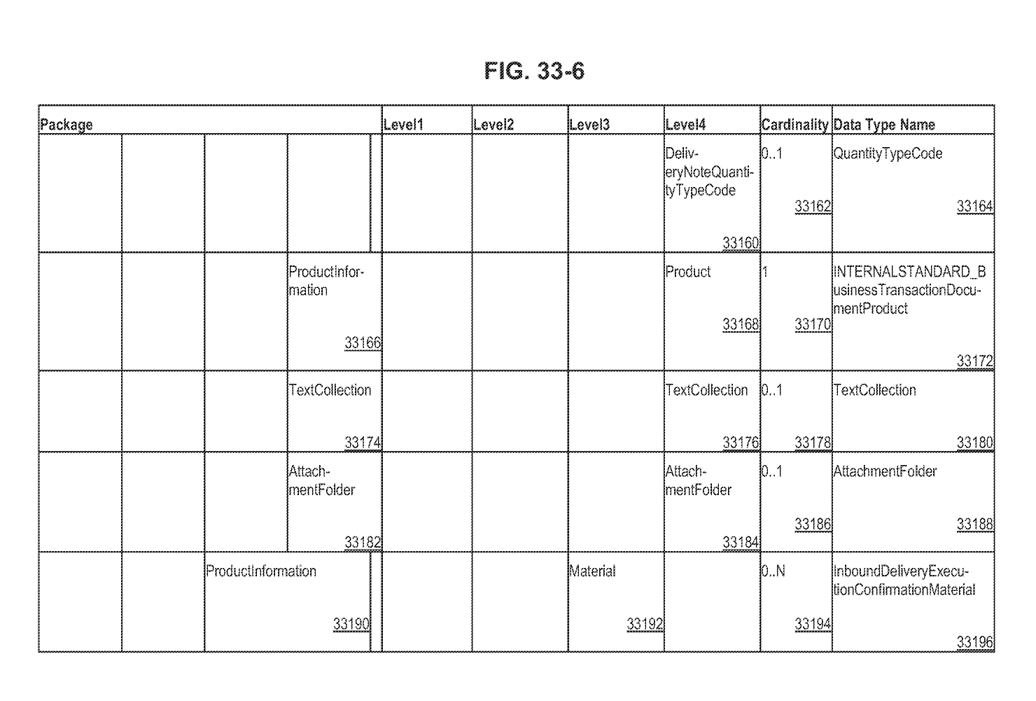

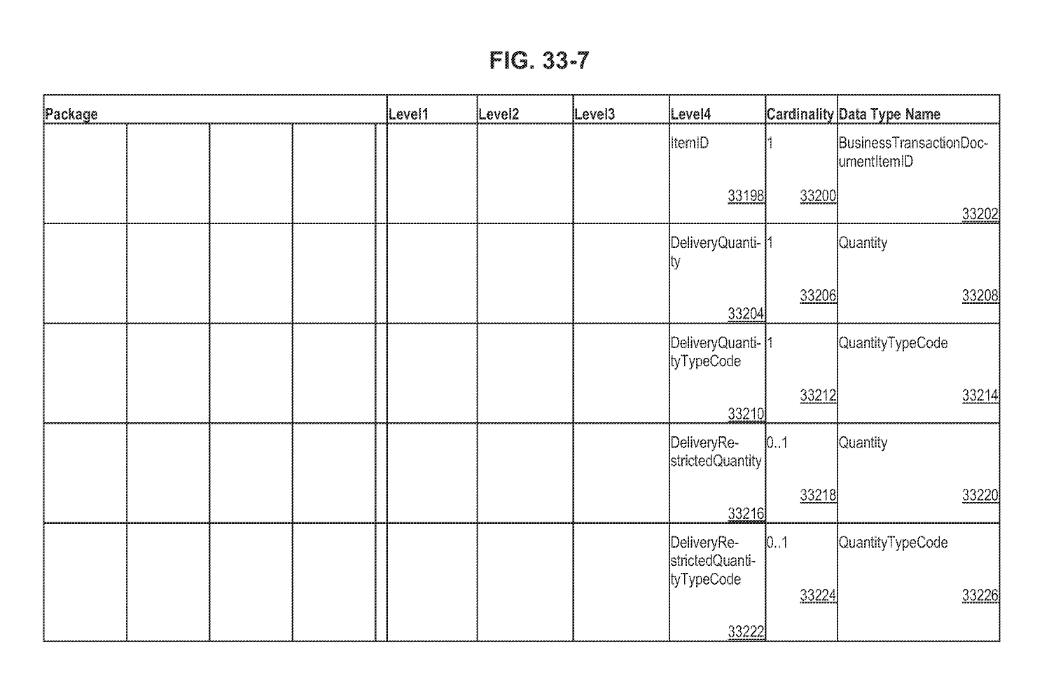

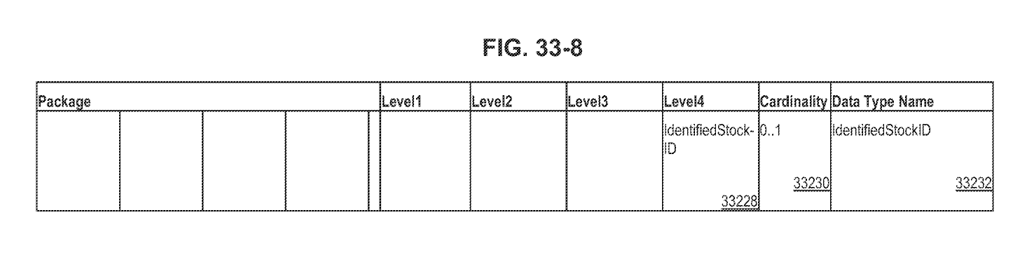

FIGS. 33-1 through 33-8 show an example configuration of an Element Structure that includes an InboundDeliveryExecutionConfirmation 33000 package. Specifically, these figures depict the arrangement and hierarchy of various components such as one or more levels of packages, entities, and datatypes, shown here as 33000 through 33232. As described above, packages may be used to represent hierarchy levels. Entities are discrete business elements that are used during a business transaction. Data types are used to type object entities and interfaces with a structure. For example, the InboundDeliveryExecutionConfirmation 33000 includes, among other things, an InboundDeliveryExecutionConfirmation 33002. Accordingly, heterogeneous applications may communicate using this consistent message configured as such.

The InboundDeliveryExecutionConfirmation 33000 package is an InboundDeliveryExecutionConfirmationMessage 33004 data type. The InboundDeliveryExecutionConfirmation 33000 package includes an InboundDeliveryExecutionConfirmation 33002 entity. The InboundDeliveryExecutionConfirmation 33000 package includes various packages, namely a MessageHeader 33006 and an InboundDeliveryExecution 33014.

The MessageHeader 33006 package is a BusinessDocumentMessageHeader 33012 data type. The MessageHeader 33006 package includes a MessageHeader 33008 entity. The MessageHeader 33008 entity has a cardinality of 1 33010 meaning that for each instance of the MessageHeader 33006 package there is one MessageHeader 33008 entity.

The InboundDeliveryExecution 33014 package is an InboundDeliveryExecutionConfirmation 33020 data type. The InboundDeliveryExecution 33014 package includes an InboundDeliveryExecution 33016 entity. The InboundDeliveryExecution 33014 package includes various packages, namely a Party 33064, a Location 33084, an ArrivalPeriod 33092, a TextCollection 33100, an AttachmentFolder 33108, an Item 33116 and a ProductInformation 33190. The InboundDeliveryExecution 33016 entity has a cardinality of 1 33018 meaning that for each instance of the InboundDeliveryExecution 33014 package there is one InboundDeliveryExecution 33016 entity. The InboundDeliveryExecution 33016 entity includes various attributes, namely an ID 33022, a VendorID 33028, a TypeCode 33034, an Incoterms 33040, a GrossVolumeMeasure 33046, a GrossWeightMeasure 33052 and a SenderLastChangeDateTime 33058.

The ID 33022 attribute is a BusinessTransactionDocumentID 33026 data type. The ID 33022 attribute has a cardinality of 1 33024 meaning that for each instance of the InboundDeliveryExecution 33016 entity there is one ID 33022 attribute. The VendorID 33028 attribute is a BusinessTransactionDocumentID 33032 data type. The VendorID 33028 attribute has a cardinality of 1 33030 meaning that for each instance of the InboundDeliveryExecution 33016 entity there is one VendorID 33028 attribute.

The TypeCode 33034 attribute is a BusinessTransactionDocumentTypeCode 33038 data type. The TypeCode 33034 attribute has a cardinality of 1 33036 meaning that for each instance of the InboundDeliveryExecution 33016 entity there is one TypeCode 33034 attribute. The Incoterms 33040 attribute is an Incoterms 33044 data type. The Incoterms 33040 attribute has a cardinality of 0 . . . 1 33042 meaning that for each instance of the InboundDeliveryExecution 33016 entity there may be one Incoterms 33040 attribute.

The GrossVolumeMeasure 33046 attribute is a Measure 33050 data type. The GrossVolumeMeasure 33046 attribute has a cardinality of 0 . . . 1 33048 meaning that for each instance of the InboundDeliveryExecution 33016 entity there may be one GrossVolumeMeasure 33046 attribute. The GrossWeightMeasure 33052 attribute is a Measure 33056 data type. The GrossWeightMeasure 33052 attribute has a cardinality of 0 . . . 1 33054 meaning that for each instance of the InboundDeliveryExecution 33016 entity there may be one GrossWeightMeasure 33052 attribute. The SenderLastChangeDateTime 33058 attribute is a GLOBAL_DateTime 33062 data type. The SenderLastChangeDateTime 33058 attribute has a cardinality of 1 33060 meaning that for each instance of the InboundDeliveryExecution 33016 entity there is one SenderLastChangeDateTime 33058 attribute.

The Party 33064 package is an INTERNALSTANDARD_BusinessTransactionDocumentParty 33070 data type. The Party 33064 package includes various entities, namely a Vendor Party 33066, a ProductRecipientParty 33072 and a FreightForwarderParty 33078.

The Vendor Party 33066 entity has a cardinality of 1 33068 meaning that for each instance of the Party 33064 package there is one Vendor Party 33066 entity. The ProductRecipientParty 33072 entity has a cardinality of 1 33074 meaning that for each instance of the Party 33064 package there is one ProductRecipientParty 33072 entity. The FreightForwarderParty 33078 entity has a cardinality of 0 . . . 1 33080 meaning that for each instance of the Party 33064 package there may be one FreightForwarderParty 33078 entity.

The Location 33084 package is an INTERNALSTANDARD_BusinessTransactionDocumentLocation 33090 data type. The Location 33084 package includes a ShipToLocation 33086 entity. The ShipToLocation 33086 entity has a cardinality of 0 . . . 1 33088 meaning that for each instance of the Location 33084 package there may be one ShipToLocation 33086 entity.

The ArrivalPeriod 33092 package is an UPPEROPEN_LOCALNORMALISED_DateTimePeriod 33098 data type. The ArrivalPeriod 33092 package includes an ArrivalDateTimePeriod 33094 entity. The ArrivalDateTimePeriod 33094 entity has a cardinality of 1 33096 meaning that for each instance of the ArrivalPeriod 33092 package there is one ArrivalDateTimePeriod 33094 entity.

The TextCollection 33100 package is a TextCollection 33106 data type. The TextCollection 33100 package includes a TextCollection 33102 entity. The TextCollection 33102 entity has a cardinality of 0 . . . 1 33104 meaning that for each instance of the TextCollection 33100 package there may be one TextCollection 33102 entity. The AttachmentFolder 33108 package is an AttachmentFolder 33114 data type. The AttachmentFolder 33108 package includes an AttachmentFolder 33110 entity. The AttachmentFolder 33110 entity has a cardinality of 0 . . . 1 33112 meaning that for each instance of the AttachmentFolder 33108 package there may be one AttachmentFolder 33110 entity.

The Item 33116 package is an InboundDeliveryExecutionConfirmationItem 33122 data type. The Item 33116 package includes an Item 33118 entity. The Item 33116 package includes various packages, namely a ProductInformation 33166, a TextCollection 33174 and an AttachmentFolder 33182. The Item 33118 entity has a cardinality of 1 . . . N 33120 meaning that for each instance of the Item 33116 package there are one or more Item 33118 entities. The Item 33118 entity includes various attributes, namely an ID 33124, a VendorID 33130, a PurchaseOrderReference 33136, a DeliveryQuantity 33142, a DeliveryQuantityTypeCode 33148, a DeliveryNoteQuantity 33154 and a DeliveryNoteQuantityTypeCode 33160.

The ID 33124 attribute is a BusinessTransactionDocumentItemID 33128 data type. The ID 33124 attribute has a cardinality of 1 33126 meaning that for each instance of the Item 33118 entity there is one ID 33124 attribute. The VendorID 33130 attribute is a BusinessTransactionDocumentItemID 33134 data type. The VendorID 33130 attribute has a cardinality of 1 33132 meaning that for each instance of the Item 33118 entity there is one VendorID 33130 attribute.

The PurchaseOrderReference 33136 attribute is a BusinessTransactionDocumentReference 33140 data type. The PurchaseOrderReference 33136 attribute has a cardinality of 0 . . . 1 33138 meaning that for each instance of the Item 33118 entity there may be one PurchaseOrderReference 33136 attribute. The DeliveryQuantity 33142 attribute is a Quantity 33146 data type. The DeliveryQuantity 33142 attribute has a cardinality of 1 33144 meaning that for each instance of the Item 33118 entity there is one DeliveryQuantity 33142 attribute.

The DeliveryQuantityTypeCode 33148 attribute is a QuantityTypeCode 33152 data type. The DeliveryQuantityTypeCode 33148 attribute has a cardinality of 1 33150 meaning that for each instance of the Item 33118 entity there is one DeliveryQuantityTypeCode 33148 attribute. The DeliveryNoteQuantity 33154 attribute is a Quantity 33158 data type. The DeliveryNoteQuantity 33154 attribute has a cardinality of 0 . . . 1 33156 meaning that for each instance of the Item 33118 entity there may be one DeliveryNoteQuantity 33154 attribute. The DeliveryNoteQuantityTypeCode 33160 attribute is a QuantityTypeCode 33164 data type. The DeliveryNoteQuantityTypeCode 33160 attribute has a cardinality of 0 . . . 1 33162 meaning that for each instance of the Item 33118 entity there may be one DeliveryNoteQuantityTypeCode 33160 attribute.

The ProductInformation 33166 package is an INTERNALSTANDARD_BusinessTransactionDocumentProduct 33172 data type. The ProductInformation 33166 package includes a Product 33168 entity. The Product 33168 entity has a cardinality of 1 33170 meaning that for each instance of the ProductInformation 33166 package there is one Product 33168 entity.

The TextCollection 33174 package is a TextCollection 33180 data type. The TextCollection 33174 package includes a TextCollection 33176 entity. The TextCollection 33176 entity has a cardinality of 0 . . . 1 33178 meaning that for each instance of the TextCollection 33174 package there may be one TextCollection 33176 entity.

The AttachmentFolder 33182 package is an AttachmentFolder 33188 data type. The AttachmentFolder 33182 package includes an AttachmentFolder 33184 entity. The AttachmentFolder 33184 entity has a cardinality of 0 . . . 1 33186 meaning that for each instance of the AttachmentFolder 33182 package there may be one AttachmentFolder 33184 entity.

The ProductInformation 33190 package is an InboundDeliveryExecutionConfirmationMaterial 33196 data type. The ProductInformation 33190 package includes a Material 33192 entity. The Material 33192 entity has a cardinality of 0 . . . N 33194 meaning that for each instance of the ProductInformation 33190 package there may be one or more Material 33192 entities. The Material 33192 entity includes various attributes, namely an ItemID 33198, a DeliveryQuantity 33204, a DeliveryQuantityTypeCode 33210, a DeliveryRestrictedQuantity 33216, a DeliveryRestrictedQuantityTypeCode 33222 and an IdentifiedStockID 33228.

The ItemID 33198 attribute is a BusinessTransactionDocumentItemID 33202 data type. The ItemID 33198 attribute has a cardinality of 1 33200 meaning that for each instance of the Material 33192 entity there is one ItemID 33198 attribute. The DeliveryQuantity 33204 attribute is a Quantity 33208 data type. The DeliveryQuantity 33204 attribute has a cardinality of 1 33206 meaning that for each instance of the Material 33192 entity there is one DeliveryQuantity 33204 attribute.

The DeliveryQuantityTypeCode 33210 attribute is a QuantityTypeCode 33214 data type. The DeliveryQuantityTypeCode 33210 attribute has a cardinality of 1 33212 meaning that for each instance of the Material 33192 entity there is one DeliveryQuantityTypeCode 33210 attribute. The DeliveryRestrictedQuantity 33216 attribute is a Quantity 33220 data type. The DeliveryRestrictedQuantity 33216 attribute has a cardinality of 0 . . . 1 33218 meaning that for each instance of the Material 33192 entity there may be one DeliveryRestrictedQuantity 33216 attribute.

The DeliveryRestrictedQuantityTypeCode 33222 attribute is a QuantityTypeCode 33226 data type. The DeliveryRestrictedQuantityTypeCode 33222 attribute has a cardinality of 0 . . . 1 33224 meaning that for each instance of the Material 33192 entity there may be one DeliveryRestrictedQuantityTypeCode 33222 attribute. The IdentifiedStockID 33228 attribute is an IdentifiedStockID 33232 data type. The IdentifiedStockID 33228 attribute has a cardinality of 0 . . . 1 33230 meaning that for each instance of the Material 33192 entity there may be one IdentifiedStockID 33228 attribute.

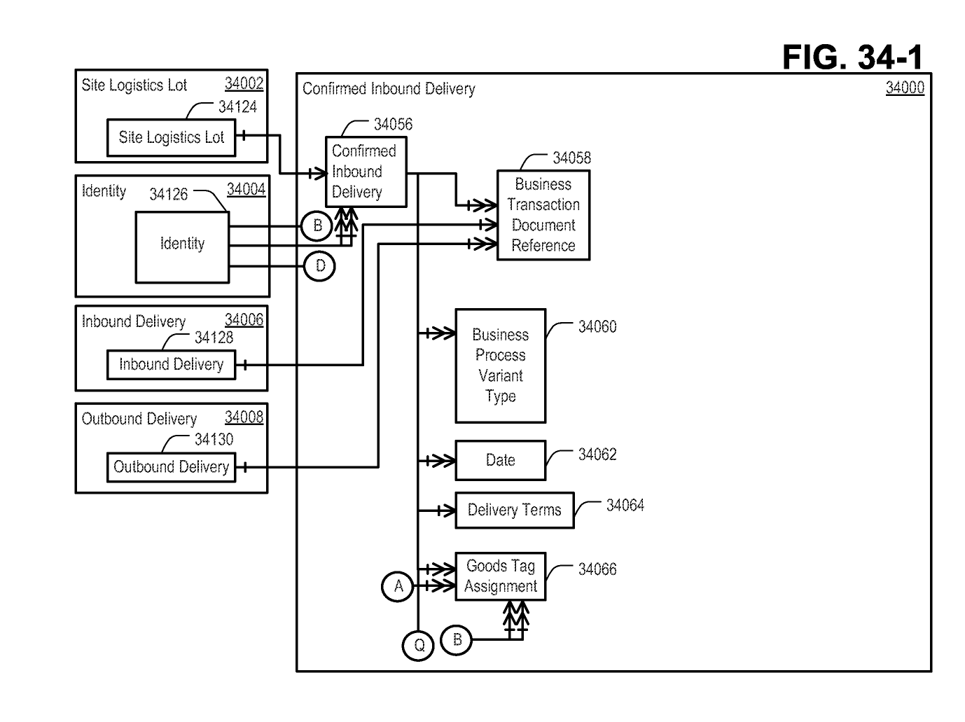

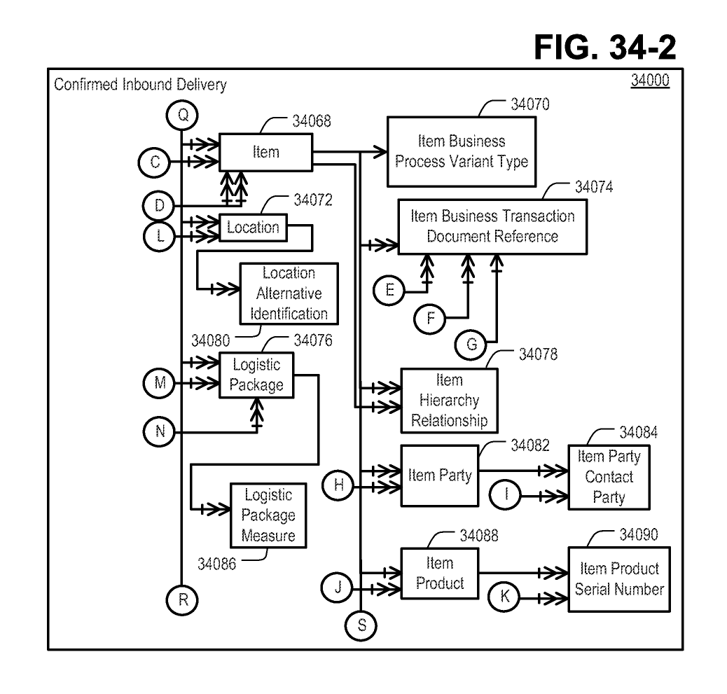

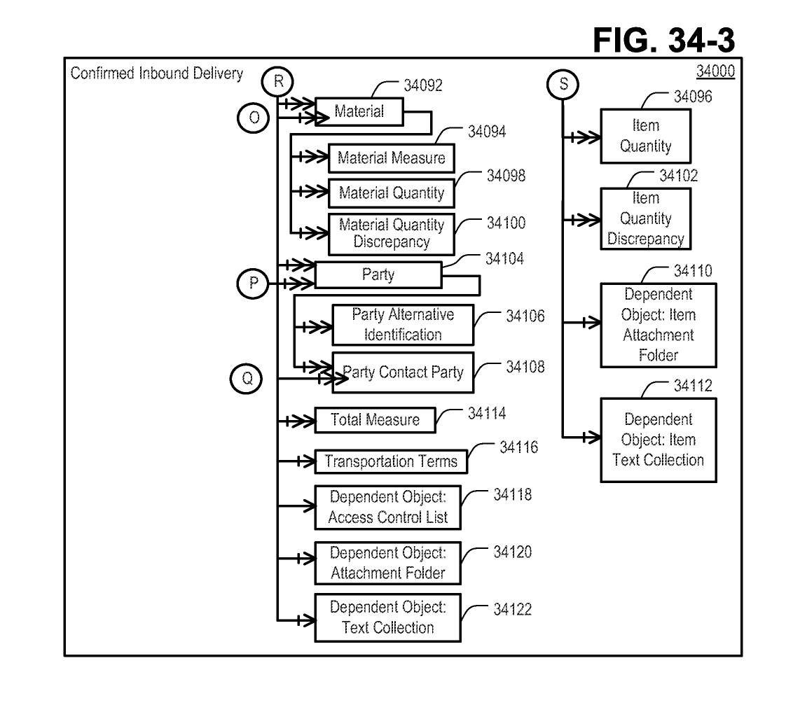

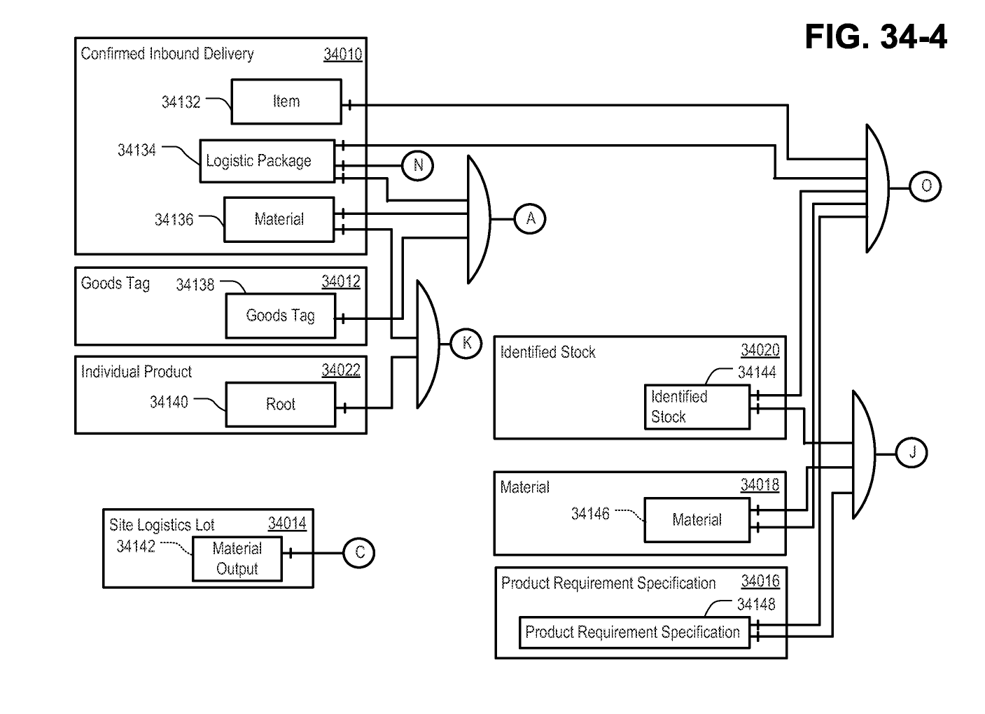

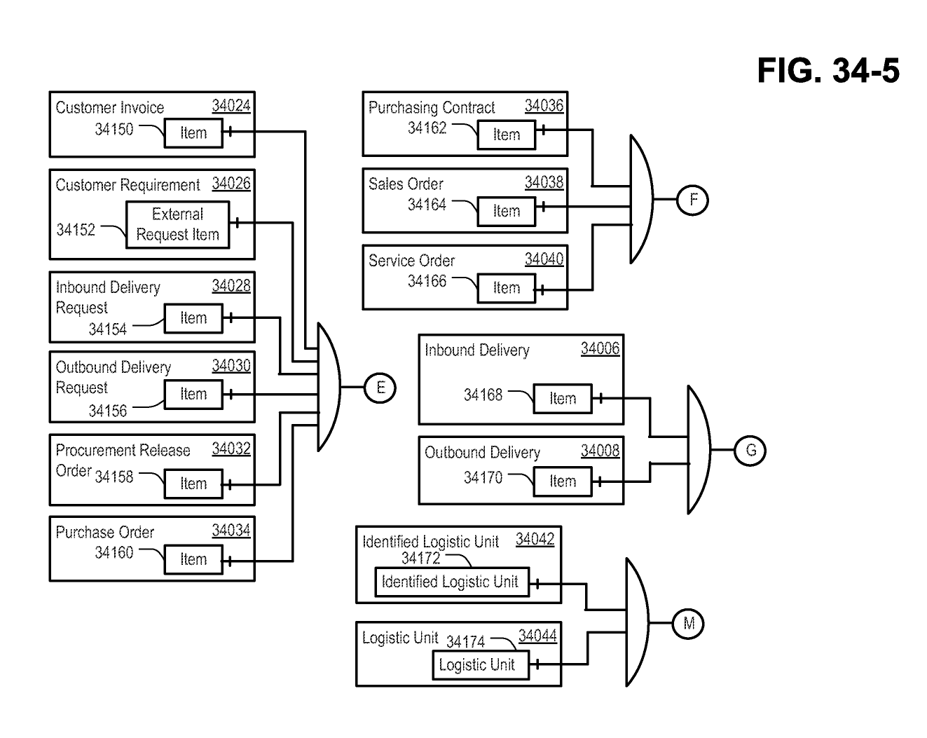

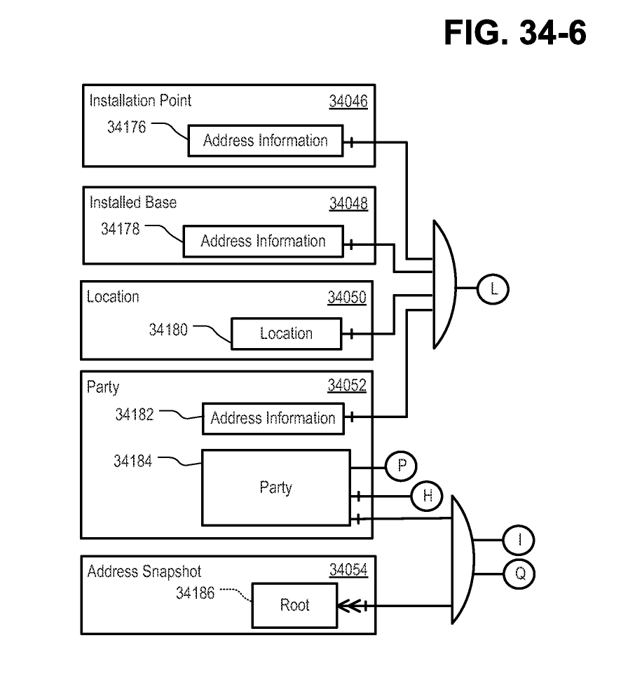

FIGS. 34-1 through 34-6 collectively illustrate an example object model for a Confirmed Inbound Delivery business object 34000. Specifically, the object model depicts interactions among various components of the Confirmed Inbound Delivery business object 34000, as well as external components that interact with the Confirmed Inbound Delivery business object 34000 (shown here as 34002 through 34054 and 34124 through 34186). The Confirmed Inbound Delivery business object 34000 includes elements 34056 through 34122, which can be hierarchical, as depicted. For example, the Confirmed Inbound Delivery entity 34056 hierarchically includes zero or more Business Transaction Document Reference entities 34058, zero or more Business Process Variant Type entities 34060, zero or more Date entities 34062, and one or more Delivery Terms Entities 34064, among others. Some or all of the entities 34056 through 34122 can correspond to packages and/or entities in the message data types described below.

The business object Confirmed Inbound Delivery is a confirmation that a certain composition of goods has been received by a product recipient. The Confirmed Inbound Delivery business object belongs to the process component Inbound Delivery Processing. The Confirmed Inbound Delivery business object belongs to the deployment unit Production and Site Logistics Execution. The Confirmed Inbound Delivery business object is a projection of a Delivery_Template template. A Confirmed Outbound Delivery, which is based on a Proof of Delivery (PoD) sent by a product recipient, can be used to identify a discrepancy between an order and a delivery and can serve as a basis for customer invoicing and billing adjustments. A Confirmed Inbound Delivery includes the following items: a Root node, including information about parties, locations, status, dates and agreements as well as information about packaging of delivered goods; and an Item node, including information about a delivered product and quantities as well as about parties and status. The business object Confirmed Inbound Delivery has an object category of Business Transaction Document and a technical category of Standard Business Object.

The business object Confirmed Inbound Delivery is involved in the following Process Component Interactions Inbound Delivery Processing_Customer Return Processing, Inbound Delivery Processing_Inbound Delivery Processing at Warehouse Provider_Inbound Delivery Execution, Inbound Delivery Processing_Intrastat Valuation, and Inbound Delivery Processing_Supplier Invoice Processing.

A service interface Business Transaction Document Intrastat Valuation Notification Out has a technical name of InboundDeliveryProcessingBusinessTransactionDocumentIntrastatValuationNotificationOut. The service interface Business Transaction Document Intrastat Valuation Notification Out is part of the process component interaction Inbound Delivery Processing_Intrastat Valuation, and is an interface to send a notification about a released, posted, or cancelled business transaction document to Intrastat Valuation. A Notify Of Confirmed Inbound Delivery operation has a technical name of InboundDeliveryProcessingBusinessTransactionDocumentIntrastatValuationNotificationOut. NotifyOfConfirmedInboundDelivery, can be used to send a notification about a released or canceled confirmed inbound delivery, and can be based on a message type Business Transaction Document Intrastat Valuation Notification that is derived from the business object Intrastat Valuation.

A service interface Inbound Delivery Execution In has a technical name of InboundDeliveryExecutionIn. The service interface Inbound Delivery Execution In is part of the process component interaction Inbound Delivery Processing_Inbound Delivery Processing at Warehouse Provider_Inbound Delivery Execution, and is an interface to process an inbound delivery execution confirmation. A Process Inbound Delivery Execution Confirmation operation has a technical name of InboundDeliveryExecutionIn.ProcessInboundDeliveryExecutionConfirmation, can be used to process an inbound delivery execution confirmation, and can be based on a message type Inbound Delivery Execution Confirmation that is derived from the business object Confirmed Inbound Delivery.

A service interface Invoice Verification Out has a technical name of InboundDeliveryProcessingInvoiceVerificationOut. The service interface Invoice Verification Out is part of the process component interaction Inbound Delivery Processing_Supplier Invoice Processing and is an interface to request a supplier invoice. A Notify of Invoicing Due operation has a technical name of InboundDeliveryProcessingInvoiceVerificationOut.NotifyOfInvoicingDue, can be used to send a request to create, update or cancel a supplier invoice, and may be based on a message type Invoicing Due Notification that is derived from the business object Supplier Invoice Request.

A service interface Request Customer Return Execution Out has a technical name of InboundDeliveryProcessingRequestCustomerReturnExecutionOut. The service interface Request Customer Return Execution Out is part of the process component interaction Inbound Delivery Processing_Customer Return Processing, and is an interface to request a customer return to be processed. A Request Customer Return Execution operation has a technical name of InboundDeliveryProcessingRequestCustomerReturnExecutionOut.RequestCustomerReturnExecution, can be used to send a customer return request, and may be based on a message type Customer Return Execution Request that is derived from the business object Customer Return.

The business object Confirmed Inbound Delivery has a root Node, which may be time dependent on a Period object. The elements located directly at the node Confirmed Inbound Delivery are defined by the data type DeliveryElements. These elements include: UUID, ID, ProcessingTypeCode, ExecutionConfirmationWarehouseProviderLastChangeDateTime, TypeCode, DataOriginTypeCode, SystemAdministrativeData, and Status. Status can include Status/DeliveryProcessingStatusCode, Status/ConsistencyStatusCode, Status/ItemListConsistencyStatusCode, Status/ReleaseStatusCode, and Status/CancellationStatusCode.

UUID may be an alternative key, is a universal unique identifier for a business object derived from Delivery_Template, and may be based on datatype GDT: UUID. ID is an identification for Delivery_Template, and may be based on datatype GDT: BusinessTransactionDocumentID. ProcessingTypeCode is a coded representation of the processing of a Delivery_Template, and may be based on datatype GDT: BusinessTransactionDocumentProcessingTypeCode. ExecutionConfirmationWarehouseProviderLastChangeDateTime may be optional, is a point in time at which a last confirmation is received from a warehouse provider, and may be based on datatype GDT: GLOBAL_DateTime. TypeCode may be optional and may be based on datatype GDT: BusinessTransactionDocumentTypeCode. DataOriginTypeCode may be optional, is a coded representation of the origin of particular data, and may be based on datatype GDT: LogisticsTransactionDocumentDataOriginTypeCode. SystemAdministrativeData includes administrative data recorded by the system, such as system users and change times, and may be based on datatype GDT: SystemAdministrativeData. Status may be optional, is a current step in a life cycle of a Delivery, and may be based on datatype BOIDT: DeliveryStatus. Status/DeliveryProcessingStatusCode may be optional, is a description of a degree to which an execution of a delivery process has finished, can be determined from information about a site logistics process, and may be based on datatype GDT: ProcessingStatusCode, with a qualifier of Delivery. In some implementations, the DeliveryProcessingStatusCode element is not used in the projection Inbound Delivery. Status/ConsistencyStatusCode may be optional, and describes whether the root node of a delivery is consistent. The root node is consistent if the content of obligatory attributes is completely filled and if the content of all attributes includes no contradictions (e.g., all predefined constraints regarding the content are fulfilled). ConsistencyStatusCode may be based on datatype GDT: ConsistencyStatusCode. Status/ItemListConsistencyStatusCode may be optional, describes whether all items are consistent, and may be based on datatype GDT: ConsistencyStatusCode, with a qualifier of List. Status/ReleaseStatusCode may be optional, describes whether a delivery object has been released, and may be based on datatype GDT: ReleaseStatusCode. Status/CancellationStatusCode may be optional, is a coded representation of the status of a cancellation of a delivery object, and may be based on datatype GDT: CancellationStatusCode.

The following composition relationships to subordinate nodes exist: BusinessTransactionDocumentReference, with a cardinality of 1:CN; BusinessProcessVariantType, with a cardinality of 1:CN; Date, with a cardinality of 1:CN; DeliveryTerms, with a cardinality of 1:C; GoodsTagAssignment, with a cardinality of 1:CN; Item, with a cardinality of 1:CN; Location, with a cardinality of 1:CN; Logisticpackage, with a cardinality of 1:CN; Material, with a cardinality of 1:CN; Party, with a cardinality of 1:CN; TotalMeasure, with a cardinality of 1:CN; and TransportationTerms, with a cardinality of 1:C.

The following composition relationships to dependent objects exist: AccessControlList, with a cardinality of 1:1, which is a list of access groups that have access to an employment during a validity period; AttachmentFolder, with a cardinality of 1:C, which is an electronic document linked to a delivery that supports delivery processing; and TextCollection, with a cardinality of 1:C, which is a natural language text linked to a delivery that supports delivery processing.

The following inbound aggregation relationships may exist: Site Logistics Lot, from the business object Site Logistics Lot/node Site Logistics Lot, with a cardinality of C:C. The following inbound association relationships may exist: CreationIdentity, from the business object Identity/node Identity, with a cardinality of 1:CN, which identifies an identity that has created a Delivery; and LastChangeIdentity, from the business object Identity/node Identity, with a cardinality of 1:CN, which identifies an identity that has last changed a Delivery. The following specialization associations for navigation may exist to the business object Business Document Flow/node Business Document Flow: Business Document Flow, with a target cardinality of C, which enables navigation to a business document flow in which a delivery participates.

The following specialization associations for navigation may exist to the business object Business Document Message Monitoring View/node Business Document Message Monitoring View Business Document Message Monitoring View, with a target cardinality of CN, which may be filtered. The filter elements are defined by the data type BusinessDocumentMessageMonitorViewFilterElements. These elements include: MostRecentOnlyIndicator, BusinessDocumentMessageDirectionCode, and MultipleIndicator. MostRecentOnlyIndicator may be optional and may be based on datatype GDT: Indicator. BusinessDocumentMessageDirectionCode may be optional and may be based on datatype GDT: BusinessDocumentMessageDirectionCode. MultipleIndicator may be optional, indicates whether multiple messages may be returned, and may be based on datatype GDT: Indicator. In some implementations, MultipleIndicator is not true when the MostRecentOnlyIndicator is true.

The following specialization associations for navigation may exist to the node Business Process Variant Type: Customer Return Delivery, with a target cardinality of C; Intra Company Delivery, with a target cardinality of C; Own Goods Return Delivery, with a target cardinality of C; Supplier Delivery, with a target cardinality of C; Third Party Delivery, with a target cardinality of C; Without Delivery Notification, with a target cardinality of C; With Delivery Dispatch Advice Notification, with a target cardinality of C; and With Warehouse Provider, with a target cardinality of C.

The following specialization associations for navigation may exist to the node Business Transaction Document Reference: InboundDeliveryReference, with a target cardinality of C; OutboundDeliveryReference, with a target cardinality of C; SiteLogisticsRequestReference, with a target cardinality of C; OriginConfirmedInboundDeliveryReference, with a target cardinality of C; and CustomerinvoiceRequestReference, with a target cardinality of C.

The following specialization associations for navigation may exist: Arrival Period, to the node Date, with a target cardinality of C, Shipping Period, to the node Date, with a target cardinality of C; Delivery Goods Tag Assignment, to the node Goods Tag Assignment, with a target cardinality of CN; Ship From Location, to the node Location, with a target cardinality of C, which is a location that has a ship-from location role category assigned; and Ship to Location, with a target cardinality of C. The following specialization associations for navigation may exist to the node Material: Identified Logistic Unit Material, with a target cardinality of CN; Logistic Unit Material, with a target cardinality of CN; and Unpacked Material, with a target cardinality of CN, which represents materials not included in a Logistics package.

The following specialization associations for navigation may exist to the node Item: Packing Item, with a target cardinality of CN; Return Item, with a target cardinality of CN; Service Item, with a target cardinality of CN; Standard Item, with a target cardinality of CN; Text Item, with a target cardinality of CN; and Transfer Item, with a target cardinality of CN.

The following specialization associations for navigation may exist to the node Party: Buyer Party, with a target cardinality of C; Carrier Party, with a target cardinality of C; Freight Forwarder Party, with a target cardinality of C; Inbound Logistics Unit Party, with a target cardinality of C; Pickup Party, with a target cardinality of C, which is a party that has a pickup role category assigned; Product Recipient Party, with a target cardinality of 1; Seller Party, with a target cardinality of C; Vendor Party, with a target cardinality of 1; End Buyer Party, with a target cardinality of C; and Warehouse Provider Party, with a target cardinality of C.

The following specialization associations for navigation may exist to the node Total Measure: Gross Volume Measure, with a target cardinality of C; Gross Weight Measure, with a target cardinality of C; Net Volume Measure, with a target cardinality of C; Net Weight Measure, with a target cardinality of C; and Tare Weight Measure, with a target cardinality of C. The following specialization associations for navigation may exist to the business object Site Logistics Lot/node Site Logistics Lot: Site Logistic Lot, with a target cardinality of C.

The following specialization associations for navigation may exist to the business object Goods and Activity Confirmation/node Goods and Activity Confirmation: Goods and Activity Confirmation, with a target cardinality of CN, which may be filtered. The filter elements are defined by the data type ActiveGoodsAndActivityConfirmation. These elements include ActiveDocumentIndicator, which may be optional and may be based on datatype GDT: Indicator.

In some implementations, the following associations for navigation are not available in the derived business object Confirmed Inbound Delivery: Shipping Period, ExternalProcurementSellerParty, FreightListReference, OriginOutboundDeliveryReference, ThirdPartyDelivery, ConfirmedInboundDelivery, PickupParty, SupplierReturnDelivery, CustomerDelivery, OwnGoodsDelivery, MaterialGoodsTagAssignment, LogisticspackageGoodsTagAssignment, and DeliveryGoodsTagAssignment. In some implementations, the following associations for navigation are not available in the derived business object InboundDelivery: Shipping Period, ExternalProcurementSellerParty, FreightListReference, OriginOutboundDeliveryReference, ThirdPartyDelivery, InboundDeliveryReference, PickupParty, SupplierReturnDelivery, CustomerDelivery, OwnGoodsDelivery, WithoutDeliveryNotification, MaterialGoodsTagAssignment, LogisticspackageGoodsTagAssignment, and DeliveryGoodsTagAssignment. In some implementations, the following associations for navigation are not available in the derived business object Outbound Delivery: Return Item, ConfirmedInboundDeliveryReference, InboundDeliveryReference, SupplierDelivery, CustomerReturnDelivery, OwnGoodsReturnDelivery, and WithoutDeliveryNotificationDelivery. In some implementations, an Outbound Delivery may have an inbound aggregation from a SiteLogisticsLot.

A Cancel action can be used to stop the processing of an instance. The cancellation can be performed immediately and a Cancellation status can be set to “Canceled”. After the cancellation, no action except Revoke Cancellation is allowed. In some implementations, Site Logistics can no longer perform confirmations regarding a cancelled delivery document. In some implementations, follow-on process components Customer Invoicing, Supplier Invoicing, and Customer Return Processing are informed of the cancellation. The Cancel action can be used on a user interface in case of processes where a delivery object has been manually created. In other cases, the Cancel action can be triggered by Site Logistics objects.

A Cancel Finish action reverses a Finish action and can be executed if a corresponding Site Logistics Confirmation is canceled. After execution of the Cancel Finish action, a delivery business object is again changeable and can be updated by Site Logistics. A corresponding delivery request can be updated with completion data. The action Cancel Finish can be performed by Site Logistics objects in a same deployment unit.

A Cancel Release action can be used to cancel a release of an object. The system can send one or more messages informing of the cancel release to other deployment units and to a business partner depending on a scenario. The Cancel Release action can be performed manually by a user.

A Create With Reference action can be used to create a delivery based on a provided business object reference. The action elements are defined by the data type DeliveryCreateWithReferenceActionElements. These elements include ProcessingTypeCode, which may be optional and may be based on datatype GDT: BusinessTransactionDocumentProcessingTypeCode.

A Finish action can be processed to document that Site Logistics execution has finished a respective process. The Finish action can be executed when all of the processes that are relevant for delivery are completed in Site Logistics. Site Logistics can provide finalization/confirmation information for a corresponding delivery. In some implementations, a delivery is not changeable after execution of the Finish action. A corresponding delivery request can be updated with completion data. The Finish action can be performed by Site Logistics objects in a same deployment unit.

A Notify Of Fulfillment Process action can be processed after a change of confirmed quantities from Site Logistics in order to document a progress of Site Logistics execution. If a fulfilled quantity is zero, the status value can be set to ‘Not started’. If the fulfilled quantity is greater than zero, the status value can be set to ‘In process’. The Notify of Fulfillment Process action can be performed by Site Logistics objects in a same deployment unit.

A Release action can be used to release an object and to trigger a sending of messages. The system can send messages to other deployment units and to a business partner depending on the scenario. Action elements can be defined by the data type DeliveryReleaseActionElements. In an Inbound Delivery, the Release action can be performed manually by a user after entering data. In a Confirmed Inbound Delivery and an Outbound Delivery, the Release action can be triggered automatically when a Delivery Processing status has been first set to “Finished”. A Revoke Cancellation action can be used to revoke a cancellation of a delivery object.

A Query By Elements can be used to provide a list of Deliveries that satisfy selection criteria specified by query elements. The query elements are defined by the data type DeliveryElementsQueryElements. These elements include: ID, ItemID, SystemAdministrativeData, CreationBusinessPartnerCommonPersonNameGivenName, CreationBusinessPartnerCommonPersonNameFamilyName, LastChangeBusinessPartnerCommonPersonNameGivenName, LastChangeBusinessPartnerCommonPersonNameFamilyName, PartyBuyerPartyKey, PartySellerPartyKey, PartyProductRecipientPartyKey, PartyVendorPartyKey, PartyCarrierPartyKey, PartyFreightForwarderPartyKey, PartyInboundLogisticsUnitPartyKey, PartyOutboundLogisticsUnitPartyKey, PartyPartyKey, LocationLocationID, LocationShipToLocationID, LocationShipFromLocationID, TransportationTermsTransportModeCode, TransportationTermsTransportMeansID, ItemProductProductKey, SearchText, ArrivalDateTime, BusinessTransactionDocumentReferenceBusinessTransactionDocumentReferenceID, BusinessTransactionDocumentReferenceInboundDeliveryReference, BusinessTransactionDocumentReferenceOriginConfirmedInboundDeliveryReference, BusinessTransactionDocumentReferenceConfirmedInboundDeliveryReference, BusinessTransactionDocumentReferenceFreightListReference, BusinessTransactionDocumentReferenceOriginOutboundDeliveryReference, ItemBusinessTransactionDocumentReferencePurchaseOrderItemReference, ItemBusinessTransactionDocumentReferenceSalesOrderItemReference, ItemBusinessTransactionDocumentReferenceServiceOrderItemReference, ItemBusinessTransactionDocumentReferenceCustomerInvoiceItemReference, ItemBusinessTransactionDocumentReferenceInboundDeliveryRequestItemReference, ItemBusinessTransactionDocumentReferenceOutboundDeliveryRequestItemReference, ItemBusinessTransactionDocumentReferenceOutboundDeliveryItemReference, ItemBusinessTransactionDocumentReferenceInboundDeliveryItemReference, ItemBusinessTransactionDocumentReferenceOriginPurchaseOrderItemReference, ItemBusinessTransactionDocumentReferenceConfirmedInboundDeliveryItemReference, ItemBusinessTransactionDocumentReferenceProcurementReleaseOrder, ItemBusinessTransactionDocumentReferenceStockTransferOrderReference, ProcessingTypeCode, BusinessProcessVariantTypeCode, MaterialProductRequirementSpecificationKey, ConsistencyStatusCode, ReleaseStatusCode, CancellationStatusCode, MaterialIdentifiedStockKey, and ItemProductProductSerialNumberSerialID.

ID matches the ID field of a delivery, and may be based on datatype GDT: BusinessTransactionDocumentID. ItemID matches the ID field of a delivery item node, and may be based on datatype GDT: BusinessTransactionDocumentItemID SystemAdministrativeData may be based on datatype GDT: SystemAdministrativeData. CreationBusinessPartnerCommonPersonNameGivenName matches a given name stored in a business object Identity, and may be based on datatype GDT: LANGUAGEINDEPENDENT_MEDIUM_Name, with a qualifier of Given. CreationBusinessPartnerCommonPersonNameFamilyName matches a family name stored in the business object Identity, and may be based on datatype GDT: LANGUAGEINDEPENDENT_MEDIUM_Name, with a qualifier of Family. LastChangeBusinessPartnerCommonPersonNameGivenName matches a given name stored in the business object Identity, and may be based on datatype GDT: LANGUAGEINDEPENDENT_MEDIUM_Name, with a qualifier of Given. LastChangeBusinessPartnerCommonPersonNameFamilyName matches a family name stored in the business object Identity, and may be based on datatype GDT: LANGUAGEINDEPENDENT_MEDIUM_Name, with a qualifier of Family.

PartyBuyerPartyKey is an identifier for a BuyerParty, can be derived from the PartyRoleCode and the PartyKey of a Party node, and may be based on datatype KDT: PartyKey. PartyBuyerPartyKey can include PartyBuyerPartyKey/PartyTypeCode, which is a coded representation of a type of party, and may be based on datatype GDT: BusinessObjectTypeCode. PartyBuyerPartyKey may include PartyBuyerPartyKey/PartyID, which is an identifier for a party, and may be based on datatype GDT: PartyID. PartySellerPartyKey is an identifier for a SellerParty, can be derived from the PartyRoleCode and the PartyKey of a Party node, and may be based on datatype KDT: PartyKey. PartySellerPartyKey/PartyTypeCode can include a coded representation of a type of party, and may be based on datatype GDT: BusinessObjectTypeCode. PartySellerPartyKey may include PartySellerPartyKey/PartyID, which is an identifier for a party, and may be based on datatype GDT: PartyID. PartyProductRecipientPartyKey is an identifier for a ProductRecipientParty, can be derived from the PartyRoleCode and the PartyKey of a Party node, and may be based on datatype KDT: PartyKey. PartyProductRecipientPartyKey/PartyTypeCode is a coded representation of a type of party, and may be based on datatype GDT: BusinessObjectTypeCode. PartyProductRecipientPartyKey may include PartyProductRecipientPartyKey/PartyID, which is an identifier for a party, and may be based on datatype GDT: PartyID. PartyVendor PartyKey is an identifier for a Vendor Party, can be derived from the PartyRoleCode and the PartyKey of a Party node, and may be based on datatype KDT: PartyKey. PartyVendor PartyKey can include PartyVendor PartyKey/PartyTypeCode, which is a coded representation of a type of party, and may be based on datatype GDT: BusinessObjectTypeCode. PartyVendor PartyKey may include PartyVendor PartyKey/PartyID, which is an identifier for a party, and may be based on datatype GDT: PartyID. PartyCarrierPartyKey is an identifier for a CarrierParty, can be derived from the PartyRoleCode and the PartyKey of a Party node, and may be based on datatype KDT: PartyKey. PartyCarrierPartyKey may include PartyCarrierPartyKey/PartyTypeCode, which is a coded representation of a type of party, and may be based on datatype GDT: BusinessObjectTypeCode. PartyCarrierPartyKey may include PartyCarrierPartyKey/PartyID, which is an identifier for a party, and may be based on datatype GDT: PartyID. PartyFreightForwarderPartyKey is an identifier for a FreightForwarderParty, can be derived from the PartyRoleCode and the PartyKey of a Party node, and may be based on datatype KDT: PartyKey. PartyFreightForwarderPartyKey can include PartyFreightForwarderPartyKey/PartyTypeCode, which is a coded representation of a type of party, and may be based on datatype GDT: BusinessObjectTypeCode. PartyFreightForwarderPartyKey can include PartyFreightForwarderPartyKey/PartyID, which is an identifier for a party, and may be based on datatype GDT: PartyID. PartyInboundLogisticsUnitPartyKey may be based on datatype KDT: PartyKey. PartyInboundLogisticsUnitPartyKey can include PartyInboundLogisticsUnitPartyKey/PartyTypeCode, which is a coded representation of a type of party, and may be based on datatype GDT: BusinessObjectTypeCode. PartyInboundLogisticsUnitPartyKey can include PartyInboundLogisticsUnitPartyKey/PartyID, which is an identifier for a party, and may be based on datatype GDT: PartyID. In some implementations, PartyInboundLogisticsUnitPartyKey is allowed on instances of the derived business object InboundDeliveryRequest. PartyOutboundLogisticsUnitPartyKey may be based on datatype KDT: PartyKey. In some implementations, PartyOutboundLogisticsUnitPartyKey is allowed on instances of the derived business object OutboundDeliveryRequest. PartyPartyKey may be based on datatype KDT: PartyKey. PartyPartyKey may include PartyPartyKey/PartyTypeCode, which is a coded representation of a type of party, and may be based on datatype GDT: BusinessObjectTypeCode. PartyPartyKey may include PartyPartyKey/PartyID, which is an identifier for a party, and may be based on datatype GDT: PartyID.

LocationLocationID may be based on datatype GDT: LocationID. LocationShipToLocationID may be based on datatype GDT: LocationID, with a qualifier of ShipTo. LocationShipFromLocationID may be based on datatype GDT: LocationID, with a qualifier of ShipFrom. TransportationTermsTransportModeCode is an identifier for a TransportModeCode, can be derived from the element TransportModeCode of the TransportationTerms node, and may be based on datatype GDT: TransportModeCode. TransportationTermsTransportMeansID is an identifier for a TransportMeansID, can be derived from the element TransportMeans of a TransportationTerms node, and may be based on datatype GDT: TransportMeansID. ItemProductProductKey may be based on datatype KDT: ProductKey. ItemProductProductKey/ProductTypeCode is a coded representation of a product type such as a material or service, and may be based on datatype GDT: ProductTypeCode. ItemProductProductKey/ProductidentifierTypeCode is a coded representation of a product identifier type, and may be based on datatype GDT: ProductidentifierTypeCode. ItemProductProductKey/ProductID is an identifier for a product, and may be based on datatype GDT: ProductID.

SearchText includes free text including one or several word search terms used to search for a delivery, and may be based on datatype GDT: SearchText. For every query that includes SearchText as a query parameter, an application-specific subset of the other query parameters can be defined. A query result can be calculated using the following steps: the search terms can be assigned to the subset of query parameters in such a way that every search term is used exactly once in the assignment; several search terms may be assigned to the same query parameter; for each assignment, a query result can be calculated; and a total result can be the union of the results calculated per assignment.

ArrivalDateTime is a point in time when a delivery arrives, and may be based on datatype GDT: LOCALNORMALISED_DateTime, with a qualifier of Arrival. BusinessTransactionDocumentReferenceBusinessTransactionDocumentReferenceID may be based on datatype GDT: BusinessTransactionDocumentID. BusinessTransactionDocumentReferenceInboundDeliveryReference may be based on datatype GDT: BusinessTransactionDocumentReference. BusinessTransactionDocumentReferenceOriginConfirmedInboundDeliveryReference may be based on datatype GDT: BusinessTransactionDocumentReference. BusinessTransactionDocumentReferenceConfirmedInboundDeliveryReference may be based on datatype GDT: BusinessTransactionDocumentReference. BusinessTransactionDocumentReferenceFreightListReference may be based on datatype GDT: BusinessTransactionDocumentReference. BusinessTransactionDocumentReferenceOriginOutboundDeliveryReference may be based on datatype GDT: BusinessTransactionDocumentReference. ItemBusinessTransactionDocumentReferencePurchaseOrderItemReference may be based on datatype GDT: BusinessTransactionDocumentReference. ItemBusinessTransactionDocumentReferenceSalesOrderItemReference may be based on datatype GDT: BusinessTransactionDocumentReference. ItemBusinessTransactionDocumentReferenceServiceOrderItemReference may be based on datatype GDT: BusinessTransactionDocumentReference. ItemBusinessTransactionDocumentReferenceCustomerInvoiceItemReference may be based on datatype GDT: BusinessTransactionDocumentReference. ItemBusinessTransactionDocumentReferenceInboundDeliveryRequestItemReference may be based on datatype GDT: BusinessTransactionDocumentReference. ItemBusinessTransactionDocumentReferenceOutboundDeliveryRequestItemReference may be based on datatype GDT: BusinessTransactionDocumentReference. ItemBusinessTransactionDocumentReferenceOutboundDeliveryhemReference may be based on datatype GDT: BusinessTransactionDocumentReference. ItemBusinessTransactionDocumentReferenceInboundDeliveryhemReference may be based on datatype GDT: BusinessTransactionDocumentReference. ItemBusinessTransactionDocumentReferenceOriginPurchaseOrderItemReference may be based on datatype GDT: BusinessTransactionDocumentReference. ItemBusinessTransactionDocumentReferenceConfirmedInboundDeliveryhemReference may be based on datatype GDT: BusinessTransactionDocumentReference. ItemBusinessTransactionDocumentReferenceProcurementReleaseOrder may be based on datatype GDT: BusinessTransactionDocumentReference and in some implementations is allowed in the projection Outbound Delivery. ItemBusinessTransactionDocumentReferenceStockTransferOrderReference may be based on datatype GDT: BusinessTransactionDocumentReference and in some implementations, is allowed in the projection Outbound Delivery. ProcessingTypeCode is a coded representation of the processing of a Delivery_Template, and may be based on datatype GDT: BusinessTransactionDocumentProcessingTypeCode. BusinessProcessVariantTypeCode may be based on datatype GDT: BusinessProcessVariantTypeCode.

MaterialProductRequirementSpecificationKey may be based on datatype KDT: RequirementSpecificationKey. MaterialProductRequirementSpecificationKey can include MaterialProductRequirementSpecificationKey/RequirementSpecificationID, which is an identifier for a requirement specification that is unique within the system, and may be based on datatype GDT: RequirementSpecificationID. MaterialProductRequirementSpecificationKey can include MaterialProductRequirementSpecificationKey/RequirementSpecificationVersionID, which is an identifier for a version of a requirement specification, and may be based on datatype GDT: VersionID. ConsistencyStatusCode describes whether the root node of a delivery is consistent. The root node is consistent if content of obligatory attributes is completely filled and if content of all attributes includes no contradictions (e.g., all predefined constraints regarding the content are fulfilled). ConsistencyStatusCode may be based on datatype GDT: ConsistencyStatusCode. ReleaseStatusCode describes whether a delivery object has been released, and may be based on datatype GDT: ReleaseStatusCode. DeliveryProcessingStatusCode is a description of a degree to which an execution of a delivery process has finished, can be determined from information about a Site Logistics process, and may be based on datatype GDT: ProcessingStatusCode, with a qualifier of Delivery. CancellationStatusCode is a coded representation of a status of a cancellation of a delivery object, and may be based on datatype GDT: CancellationStatusCode. MaterialIdentifiedStockKey may be based on datatype KDT: IdentifiedStockKey. MaterialIdentifiedStockKey/ID may include ID, which may be based on datatype GDT: IdentifiedStockID. MaterialIdentifiedStockKey may include MaterialIdentifiedStockKey/MaterialKey, which is a grouping of elements that uniquely identifies a material, a sub-quantity of which is identified by an identified stock. MaterialKey may be based on datatype KDT: ProductKey. MaterialKey can include MaterialIdentifiedStockKey/MaterialKey/ProductTypeCode, which is a coded representation of a product type such as a material or service, and may be based on datatype GDT: ProductTypeCode. MaterialKey may include MaterialIdentifiedStockKey/MaterialKey/ProductidentifierTypeCode, which is a coded representation of a product identifier type, and may be based on datatype GDT: ProductidentifierTypeCode. MaterialKey may include MaterialIdentifiedStockKey/MaterialKey/ProductID, which is an identifier for a product, and may be based on datatype GDT: ProductID. ItemProductProductSerialNumberSerialID is an identifier for an individual product, can be referred to as a serial number, and may be based on datatype GDT: SerialID. A Select All query can be used to provide the NodeIDs of all instances of the node and can be used to enable an initial load of data for a Fast Search Infrastructure.

In some implementations, a ReleaseStatusCode is present in the projection InboundDelivery. In some implementations, the ProductRequirementSpecificationKey is present in the projections OutboundDelivery and ConfirmedInboundDelivery. In some implementations, the GoodsTagID is present in the projection OutboundDelivery. In some implementations, the ItemPartyExternalProcurementSellerPartyKey is present in the projection OutboundDelivery. In some implementations, DeliveryDateShippingDateTime is not present in the projections Confirmed Inbound Delivery and Inbound Delivery. In some implementations, DeliveryDateShippingOrPickupDateTime is not present in the projections Confirmed Inbound Delivery and Inbound Delivery.

Business Transaction Document Reference is a reference to a business document, such as a business document relevant to a delivery. The elements located directly at the node Business Transaction Document Reference are defined by the inline structure APDL_S_DEL_BTD_REFERENCE_EL. These elements include: BusinessTransactionDocumentReference and BusinessTransactionDocumentReference. BusinessTransactionDocumentReference is a unique reference to other business documents that are important for a delivery or to one or more line items within a same business document. BusinessTransactionDocumentReference may be based on datatype GDT: BusinessTransactionDocumentReference. BusinessTransactionDocumentRelationshipRoleCode may be optional, is a coded representation of a role a referenced document plays in relation to a delivery, and may be based on datatype GDT: BusinessTransactionDocumentRelationshipRoleCode.

The following inbound aggregation relationships may exist: InboundDelivery, from the business object Inbound Delivery/node Inbound Delivery, with a cardinality of C:C, and OutboundDelivery, from the business object Outbound Delivery/node Outbound Delivery, with a cardinality of C:CN, which can be from an Outbound Delivery node. The following specialization associations for navigation may exist to the node Confirmed Inbound Delivery: Parent, with a target cardinality of 1; and Root, with a target cardinality of 1. In some implementations, allowed inbound aggregation relationship of the BusinessTransactionDocumentReference depend on a business object derived from a Delivery template. In some implementations, a Confirmed Outbound Delivery may have an inbound aggregation from an Outbound Delivery. In some implementations, an Outbound Delivery may have an inbound aggregation from a Freight List. In some implementations, an Outbound Delivery may have an inbound aggregation from an external Outbound Delivery. In some implementations, a Confirmed Inbound Delivery may have an inbound aggregation from an Inbound Delivery. In some implementations, an Inbound Delivery may have an inbound aggregation from a Confirmed Inbound Delivery. In some implementations, an Outbound Delivery may have an inbound aggregation from an Inbound Delivery. In some implementations, an Outbound Delivery may have an inbound aggregation from a Confirmed Inbound Delivery.

Business Process Variant Type defines a character of a business process variant of an Item and represents a typical way of processing an Item within a process component from a business point of view. A Business Process Variant is a configuration of a Process Component. In some implementations, a Business Process Variant belongs to one process component. A process component is a software package that realizes a business process and exposes functionality of the process as services. The functionality can include business transactions. A process component can include one or more semantically related business objects. A business object can belong to a process component. The elements located directly at the node Business Process Variant Type are defined by the inline structure APDL_S_DEL_BPVT_EL. These elements include: BusinessProcessVariantTypeCode and MainIndicator. BusinessProcessVariantTypeCode is a coded representation of a business process variant type of a delivery, and may be based on datatype GDT: BusinessProcessVariantTypeCode. Example codes can include “With ASN”, and “With proof of delivery”. In some implementations, the following party role category codes are not available in the derived inbound delivery and confirmed inbound delivery business objects: ThirdPartyDirectShip. MainIndicator indicates whether a current BusinessProcessVariantType is the main type, and may be based on datatype GDT: Indicator, with a qualifier of Main.

The following specialization associations for navigation may exist to the node Confirmed Inbound Delivery: Parent, with a target cardinality of 1; and Root, with a target cardinality of 1. In some implementations, allowed codes include: Outbound Delivery Processing with Delivery Despatch Advice Notification, Inbound Delivery Processing with Delivery Despatch Advice Notification, Inbound Delivery Processing with Delivery Despatch Receiving Notification, Outbound Delivery Processing of Third-Party Deliveries, Outbound Delivery Processing of Intra Company Deliveries, Inbound Delivery Processing of Intra Company Deliveries, Inbound Delivery Processing with Warehouse Provider, and Outbound Delivery Processing with Warehouse Provider.

Date is a time specification based on a day, month, and year for a delivery. A date can be provided with various degrees of precision. For example, a date can be second-precise, minute-precise, or day-precise. The elements located directly at the node Date are defined by the inline structure APDL_S_DEL_DATE_EL. These elements include: PeriodRoleCode and DateTimePeriod. PeriodRoleCode is a coded representation of semantics of a period in a delivery, and may be based on datatype GDT: PeriodRoleCode. Codes can include ArrivalPeriod, which is a period in which goods arrive; ShippingPeriod, which is a period in which goods are shipped; and PickupPeriod, which is a period in which goods are collected. In some implementations, the following code value is only available in the projection outbound delivery: Shipping Period. DateTimePeriod is a time point with relevance to a delivery, and may be based on datatype GDT: UPPEROPEN_LOCALNORMALISED_DateTimePeriod. The following specialization associations for navigation to the node Confirmed Inbound Delivery: Parent, with a target cardinality of 1; and Root, with a target cardinality of 1.

Delivery Terms include conditions and agreements negotiated when a sales order is placed that are valid for shipment or for services and activities used for shipment. The elements located directly at the node Delivery Terms are defined by the inline structure APDL_S_DEL_DEL_TERMS_EL. These elements include Incoterms, which are contract formulations for delivery conditions that correspond to rules defined by the International Chamber of Commerce (ICC), and may be based on datatype GDT: Incoterms. The following specialization associations for navigation may exist to the node Confirmed Inbound Delivery: Parent, with a target cardinality of 1; and Root, with a target cardinality of 1.

Goods Tag Assignment is an assignment to a Goods Tag. Goods tags can be assigned to a material. Such an assignment can be subsequently used for tracking and tracing purposes. The elements located directly at the node Goods Tag Assignment are defined by the inline structure APDL_S_DEL_GOODS_TAG_ASSIGN_EL. These elements include: UUID, GoodsTagID, GoodsTagUUID, MaterialUUID, LogisticspackageUUID, and SystemAdministrativeData. UUID may be an alternative key and may be based on datatype GDT: UUID. GoodsTagID is an identifier for a goods tag, and may be based on datatype GDT: GoodsTagID. GoodsTagUUID is a universally unique identifier for a goods tag for referencing purposes, and may be based on datatype GDT: UUID. MaterialUUID is a unique identification of a Material node to which a goods tag assignment belongs, and may be based on datatype GDT: UUID. LogisticspackageUUID is a unique identification of a Logistic package node to which a goods tag assignment belongs, and may be based on datatype GDT: UUID. SystemAdministrativeData includes administrative data recorded by the system, such as system users and change times, and may be based on datatype GDT: SystemAdministrativeData.

The following inbound aggregation relationships may exist: Logisticpackage, from the business object Confirmed Inbound Delivery/node Logistic package, with a cardinality of C:CN, which is a logistic package to which a goods tag is assigned; Material, from the business object Confirmed Inbound Delivery/node Material, with a cardinality of C:CN, which is a material to which a goods tag is assigned; and GoodsTag, from the business object Goods Tag/node Goods Tag, with a cardinality of C:CN.

The following inbound association relationships may exist: CreationIdentity, from the business object Identity/node Identity, with a cardinality of 1:CN, which identifies an identity that has created an assignment of a goods tag; and LastChangeIdentity, from the business object Identity/node Identity, with a cardinality of 1:CN, which identifies an identity that has last changed an assignment of a goods tag. The following specialization associations for navigation may exist to the node Confirmed Inbound Delivery: Parent, with a target cardinality of 1; and Root, with a target cardinality of 1. In some implementations, MaterialUUI and LogisticpackageUUID are not each simultaneously filled.

A Query By Goods Tag UUID query can be used to provide a list of Goods Tag Assignments that satisfy selection criteria specified by query elements. The query elements are defined by the inline structure: APDL_S_DEL_GTA_QU_GT_UUID_EL. These elements include GoodsTagUUID, which is a universally unique identifier for a goods tag instance and may be based on datatype GDT: UUID.

Item represents a quantity of a product included in a delivery with additional information about delivery status and existing references to preceding business documents and/or information in textual form regarding the delivery. An Item includes an identifier. Item occurs in the following specializations: Packing Item, Text Item, Return Item, Standard Item, ServiceItem, and TransferItem. A specialization type can be implemented by a type Attribute. The elements located directly at the node Item are defined by the data type DeliveryItemElements. These elements include: UUID, TypeCode, ID, ProcessingTypeCode, FollowUpInvoicingDueNotificationRequirementCode, FollowUpCustomerInvoiceRequestRequestRequirementCode, SystemAdministrativeData, CustomerReturnReasonCode, ExternallyOwnedStockIndicator, ReturnFollowupActivityCode, and Status.

UUID may be an alternative key, is a universal unique identifier of an Item, can be used to refer to an Item, and may be based on datatype GDT: UUID. TypeCode is a coded representation of a type of an item of a Delivery_Template, and may be based on datatype GDT: BusinessTransactionDocumentItemTypeCode. Example codes correspond to Delivery Standard Item, Delivery Text Item, Delivery Packing Item, and Delivery Return Item. ID is an identification for an Item, can be used to refer an Item, and may be based on datatype GDT: BusinessTransactionDocumentItemID A ProcessingTypeCode is a coded representation of the processing of an item of a Delivery_Template, and may be based on datatype GDT: BusinessTransactionDocumentItemProcessingTypeCode. FollowUpInvoicingDueNotificationRequirementCode is a coded representation of the necessity of an Invoicing Due Notification as a follow-up message, and may be based on datatype GDT: FollowUpMessageRequirementCode. Example codes include codes corresponding to: Required, meaning that a follow-up message is a requirement for a further process; and Forbidden, meaning that a follow-up message is forbidden and cannot be received or processed.

FollowUpCustomerInvoiceRequestRequestRequirementCode is a coded representation of the necessity of an Customer Invoice Request Request as a follow-up message, and may be based on datatype GDT: FollowUpMessageRequirementCode. Example codes include codes corresponding to: Required, meaning that a follow-up message is a requirement for a further process; and Forbidden, meaning that a follow-up message is forbidden and cannot be received or processed. SystemAdministrativeData includes administrative data for an item recorded by the system, such as system users and change times, and may be based on datatype GDT: SystemAdministrativeData. CustomerReturnReasonCode is a coded representation of a reason why a customer returns goods, and may be based on datatype GDT: CustomerReturnReasonCode. ExternallyOwnedStockIndicator indicates whether a stock is owned externally, may be based on datatype GDT: Indicator, and can be used to specify that a quantity of a product that is held in company stock belongs to a customer or a supplier. ReturnFollowupActivityCode may be optional and may be based on datatype GDT: ReturnFollowUpActivityCode. Status may be optional, is a current step in a life cycle of an Item, and may be based on datatype BOIDT: DeliveryItemStatus. Status can include Status/ConsistencyStatusCode, which may be optional, is a coded representation of a consistency status of an object, and may be based on datatype GDT: ConsistencyStatusCode. Status can include Status/CancellationStatusCode, which may be optional, is a coded representation of a status of a cancellation, and may be based on datatype GDT: CancellationStatusCode.

The following composition relationships to subordinate nodes exist: ItemBusinessProcessVariantType, in a 1:1 cardinality relationship; ItemBusinessTransactionDocumentReference, in a 1:CN cardinality relationship; ItemHierarchyRelationship, in a 1:CN cardinality relationship; ItemParty, in a 1:CN cardinality relationship; ItemProduct, in a 1:C cardinality relationship; ItemQuantity, in a 1:CN cardinality relationship; and ItemQuantityDiscrepancy, in a 1:CN cardinality relationship.

The following composition relationships to dependent objects exist: ItemAttachmentFolder, with a cardinality of 1:C, which is an electronic document linked to an item that supports delivery processing; and ItemTextCollection, with a cardinality of 1:C, which is natural language text linked to an Item that supports delivery processing. The following inbound aggregation relationships may exist: SiteLogisticsLotMaterialOutput, from the business object Site Logistics Lot/node Material Output, with a cardinality of C:CN, which is a material output of a site logistics lot. The following inbound association relationships may exist: CreationIdentity, from the business object Identity/node Identity, with a cardinality of 1:CN, which identifies an identity that has created an Item; and LastChangeIdentity, from the business object Identity/node Identity, with a cardinality of 1:CN, which identifies an identity that has last changed an Item.

The following specialization associations for navigation may exist: Business Document Flow, to the business object Business Document Flow/node Business Document Flow, with a target cardinality of C, which enables navigation to a business document flow in which a delivery item participates; Parent, to the node Confirmed Inbound Delivery, with a target cardinality of 1; Root, to the node Confirmed Inbound Delivery, with a target cardinality of 1; MainItemBusinessProcessVariantType, to the node Item Business Process Variant Type, with a target cardinality of 1; Material, to the node Material, with a target cardinality of CN; and ItemSiteLogisticsLotMaterialOutputItemReference, to the business object Site Logistics Lot/node Material Output, with a target cardinality of CN, which represents goods belonging to materials of an Item.

The following specialization associations for navigation may exist to the node Item Business Transaction Document Reference: ItemAssignedConfirmedInboundDeliveryReference, with a target cardinality of C; ItemCustomerInvoiceItemReference, with a target cardinality of C; ItemCustomerReturnItemReference, with a target cardinality of C; ItemInboundDeliveryItemReference, with a target cardinality of C; ItemInboundDeliveryRequestItemReference, with a target cardinality of C; ItemOriginPurchaseOrderItemReference, with a target cardinality of C; ItemOutboundDeliveryItemReference, with a target cardinality of C; ItemOutboundDeliveryRequestItemReference, with a target cardinality of CN; ItemPurchaseOrderItemReference, with a target cardinality of C; ItemServiceOrderItemReference, with a target cardinality of C; ItemSalesOrderItemReference, with a target cardinality of C; ItemSiteLogisticsRequestItemReference, with a target cardinality of C; ItemOriginConfirmedInboundDeliveryItemReference, with a target cardinality of C; and ItemCustomerinvoiceRequestItemReference, with a target cardinality of C.

The following specialization associations for navigation may exist to the node Item Party: BuyerItemParty, with a target cardinality of C; LogisticsRequestResponsibleItemParty, with a target cardinality of C; SellerItemParty, with a target cardinality of C; and End Buyer Party, with a target cardinality of C. The following specialization associations for navigation may exist to the node Item Quantity: DeliveryNoteItemQuantity, with a target cardinality of C; DeliveryItemQuantity, with a target cardinality of C; and ReturnToSupplierItemQuantity, with a target cardinality of CN.

In some implementations, an association for navigation to node ItemBusinessTransactionDocumentReference:ItemPurchasingContractReference is allowed on the projection Outbound Delivery, ItemProcurementReleaseOrderReference is allowed on the projection Outbound Delivery, and a semantical target cardinality for ItemOutboundDeliveryRequestReference is allowed on the projection Outbound Delivery is: C. In some implementations, an association for navigation to node ItemParty:ExternalProcurementSellerP arty is only allowed on the projection Outbound Delivery. In some implementations, an association for navigation to node Quantity:DeliveryNoteQuantity is allowed on the projection Confirmed Inbound Delivery.

A Cancel action stops the processing of an item instance and a cancellation is triggered. The cancellation can be performed directly and a Cancellation Status can be set to “Canceled”. After the cancellation, Site Logistics no longer performs confirmations regarding the cancelled delivery item. The Cancel action can be used on a user interface in a case of processes where a delivery object has been created manually (e.g., Inbound Delivery). In other cases (e.g., Outbound Delivery, Confirmed Inbound Delivery) the Cancel action can be triggered by Site Logistics objects in a same deployment unit when a confirmation of a corresponding Site Logistics Lot has been revoked. A Revoke Cancellation action can be used to revoke a cancellation of a Delivery object.

A Query By Elements query can be used to provide a list of Delivery Items that satisfy selection criteria specified by query elements. The query elements are defined by the inline structure: APDL_S_DEL_IT_EL_QU_EL. These elements include: DeliveryID, ID, SystemAdministrativeData, CreationBusinessPartnerCommonPersonNameGivenName, CreationBusinessPartnerCommonPersonNameFamilyName, LastChangeBusinessPartnerCommonPersonNameGivenName, LastChangeBusinessPartnerCommonPersonNameFamilyName, PartyBuyerPartyKey, PartySellerPartyKey, DeliveryPartyProductRecipientPartyKey, ProductProductKey, SearchText, DeliveryDateArrivalDateTime, ItemBusinessTransactionDocumentReferencePurchaseOrderItemReference, ItemBusinessTransactionDocumentReferenceSalesOrderItemReference, ItemBusinessTransactionDocumentReferenceServiceOrderItemReference, ItemBusinessTransactionDocumentReferenceCustomerInvoiceItemReference, ItemBusinessTransactionDocumentReferenceInboundDeliveryRequestItemReference, ItemBusinessTransactionDocumentReferenceOutboundDeliveryRequestItemReference, ItemBusinessTransactionDocumentReferenceOutboundDeliveryItemReference, ItemBusinessTransactionDocumentReferenceInboundDeliveryItemReference, ItemBusinessTransactionDocumentReferenceOriginPurchaseOrderItemReference, ItemBusinessTransactionDocumentReferenceConfirmedInboundDeliveryItemReference, DeliveryLocationShipToLocationID, DeliveryMaterialProductRequirementSpecificationKey, DeliveryMaterialIdentifiedStockKey, ProcessingTypeCode, DeliveryReleaseStatusCode, WithWarehouseProviderBusinessProcessVariantTypeCode, DeliveryCancellationStatusCode, CancellationStatusCode, DeliveryTypeCode, ItemBusinessTransactionDocumentReferenceOriginConfirmedInboundDeliveryItemReference, and ProductSerialNumberSerialID.

DeliveryID may be based on datatype GDT: BusinessTransactionDocumentID. ID may be based on datatype GDT: BusinessTransactionDocumentItemID SystemAdministrativeData may be based on datatype GDT: SystemAdministrativeData. CreationBusinessPartnerCommonPersonNameGivenName matches a given name stored in the business object Identity, and may be based on datatype GDT: LANGUAGEINDEPENDENT_MEDIUM_Name, with a qualifier of Given. CreationBusinessPartnerCommonPersonNameFamilyName matches a family name stored in the business object Identity, and may be based on datatype GDT: LANGUAGEINDEPENDENT_MEDIUM_Name, with a qualifier of Family. LastChangeBusinessPartnerCommonPersonNameGivenName matches a given name stored in the business object Identity, and may be based on datatype GDT: LANGUAGEINDEPENDENT_MEDIUM_Name, with a qualifier of Given. LastChangeBusinessPartnerCommonPersonNameFamilyName may be based on datatype GDT: LANGUAGEINDEPENDENT_MEDIUM_Name, with a qualifier of Family. PartyBuyerPartyKey may be derived from the PartyRoleCode and the PartyKey of the ItemParty node, and may be based on datatype KDT: PartyKey. PartyBuyerPartyKey can include PartyBuyerPartyKey/PartyTypeCode, which is a coded representation of a type of party, and may be based on datatype GDT: BusinessObjectTypeCode. PartyBuyerPartyKey can include PartyBuyerPartyKey/PartyID, which is an identifier for a party, and may be based on datatype GDT: PartyID. PartySellerPartyKey may be derived from the PartyRoleCode and the PartyKey of the ItemParty node, and may be based on datatype KDT: PartyKey. PartySellerPartyKey can include PartySellerPartyKey/PartyTypeCode, which is a coded representation of a type of party, and may be based on datatype GDT: BusinessObjectTypeCode. PartySellerPartyKey can include PartySellerPartyKey/PartyID, which is an identifier for a party, and may be based on datatype GDT: PartyID. DeliveryPartyProductRecipientPartyKey may be based on datatype KDT: PartyKey.

ProductProductKey may be based on datatype KDT: ProductKey. ProductProductKey can include ProductProductKey/ProductTypeCode, which is a coded representation of a product type such as a material or service, and may be based on datatype GDT: ProductTypeCode. ProductProductKey can include ProductProductKey/ProductidentifierTypeCode, which is a coded representation of a product identifier type, and may be based on datatype GDT: ProductidentifierTypeCode. ProductProductKey may include ProductProductKey/ProductID, which is an identifier for a product, and may be based on datatype GDT: ProductID.

SearchText includes free text including one or several word search terms used to search for a delivery, and may be based on datatype GDT: SearchText. For every query that includes the SearchText as a query parameter an application-specific subset of the other query parameters can be defined. A query result can be calculated using the following steps: the search terms can be assigned to the subset of query parameters in such a way that every search term is used exactly once in the assignment; several search terms may be assigned to a same query parameter; and for each assignment, a query result can be calculated. A total result can be a union of the query results calculated per assignment.

DeliveryDateArrivalDateTime may be based on datatype GDT: LOCALNORMALISED_DateTime, with a qualifier of Arrival. ItemBusinessTransactionDocumentReferencePurchaseOrderItemReference may be based on datatype GDT: BusinessTransactionDocumentReference. ItemBusinessTransactionDocumentReferenceSalesOrderItemReference may be based on datatype GDT: BusinessTransactionDocumentReference. ItemBusinessTransactionDocumentReferenceServiceOrderItemReference may be based on datatype GDT: BusinessTransactionDocumentReference. ItemBusinessTransactionDocumentReferenceCustomerInvoiceItemReference may be based on datatype GDT: BusinessTransactionDocumentReference. ItemBusinessTransactionDocumentReferenceInboundDeliveryRequestItemReference may be based on datatype GDT: BusinessTransactionDocumentReference. ItemBusinessTransactionDocumentReferenceOutboundDeliveryRequestItemReference may be based on datatype GDT: BusinessTransactionDocumentReference. ItemBusinessTransactionDocumentReferenceOutboundDeliveryItemReference may be based on datatype GDT: BusinessTransactionDocumentReference. ItemBusinessTransactionDocumentReferenceInboundDeliveryItemReference may be based on datatype GDT: BusinessTransactionDocumentReference. ItemBusinessTransactionDocumentReferenceOriginPurchaseOrderItemReference may be based on datatype GDT: BusinessTransactionDocumentReference. ItemBusinessTransactionDocumentReferenceConfirmedInboundDeliveryItemReference may be based on datatype GDT: BusinessTransactionDocumentReference. DeliveryLocationShipToLocationID may be based on datatype GDT: LocationID, with a qualifier of ShipTo. DeliveryMaterialProductRequirementSpecificationKey may be based on datatype KDT: RequirementSpecificationKey.

DeliveryMaterialProductRequirementSpecificationKey can include DeliveryMaterialProductRequirementSpecificationKey/RequirementSpecificationID, which is an identifier for a requirement specification that is unique within a system, and may be based on datatype GDT: RequirementSpecificationID. DeliveryMaterialProductRequirementSpecificationKey can include DeliveryMaterialProductRequirementSpecificationKey/RequirementSpecificationVersionID, which is an identifier for a version of a requirement specification, and may be based on datatype GDT: VersionID. DeliveryMaterialIdentifiedStockKey may be based on datatype KDT: IdentifiedStockKey. DeliveryMaterialIdentifiedStockKey/ID can include DeliveryMaterialIdentifiedStockKey, which may be based on datatype GDT: IdentifiedStockID. DeliveryMaterialIdentifiedStockKey can include DeliveryMaterialIdentifiedStockKey/MaterialKey, which is a grouping of elements that uniquely identifies a material, a sub-quantity of which is identified by an identified stock, and may be based on datatype KDT: ProductKey. DeliveryMaterialIdentifiedStockKey/MaterialKey can include DeliveryMaterialIdentifiedStockKey/MaterialKey/ProductTypeCode, which is a coded representation of a product type such as a material or service, and may be based on datatype GDT: ProductTypeCode. DeliveryMaterialIdentifiedStockKey/MaterialKey can include DeliveryMaterialIdentifiedStockKey/MaterialKey/ProductidentifierTypeCode, which is a coded representation of a product identifier type, and may be based on datatype GDT: ProductidentifierTypeCode. DeliveryMaterialIdentifiedStockKey/MaterialKey can include DeliveryMaterialIdentifiedStockKey/MaterialKey/ProductID, which is an identifier for a product, and may be based on datatype GDT: ProductID. ProcessingTypeCode may be based on datatype GDT: BusinessTransactionDocumentProcessingTypeCode. DeliveryReleaseStatusCode may be based on datatype GDT: ReleaseStatusCode. WithWarehouseProviderBusinessProcessVariantTypeCode may be based on datatype GDT: BusinessProcessVariantTypeCode. DeliveryCancellationStatusCode may be based on datatype GDT: CancellationStatusCode. CancellationStatusCode may be based on datatype GDT: CancellationStatusCode. DeliveryTypeCode may be based on datatype GDT: BusinessTransactionDocumentTypeCode. ItemBusinessTransactionDocumentReferenceOriginConfirmedInboundDeliveryhemReference may be based on datatype GDT: BusinessTransactionDocumentReference. ProductSerialNumberSerialID is an identifier for an individual product, can be referred to as a serial number, and may be based on datatype GDT: SerialID.

In some implementations, the parameter DeliveryLocationShipFromLocationID is available in the projection Outbound Delivery. In some implementations, the ProductRequirementSpecificationKey is present in the projections OutboundDelivery and ConfirmedInboundDelivery. In some implementations, the attribute BusinessTransactionDocumentReferenceInboundDeliveryItemReference is present in the projections OutboundDelivery and ConfirmedInboundDelivery. In some implementations, the parameter DeliveryPartyVendor PartyKey is available in the projection Inbound Delivery. In some implementations, DeliveryDateShippingDateTime is not present in the projections Confirmed Inbound Delivery and Inbound Delivery. In some implementations, DeliveryDateShippingOrPickupDateTime is not present in the projections Confirmed Inbound Delivery and Inbound Delivery.

An ItemBusinessProcessVariantType defines the character of a business process variant of an Item and represents a way of processing an Item within a process component from a business point of view. A Business Process Variant is a configuration of a process component. A Business Process Variant can belong to one process component. A process component is a software package that realizes a business process and exposes functionality of the process as services. The functionality can include one or more business transactions. A process component can include one or more semantically related business objects. A business object can belong to one process component. The elements located directly at the node Item Business Process Variant Type are defined by the inline structure: APDL_S_DEL_IT_BPVT_EL. These elements include: BusinessProcessVariantTypeCode and MainIndicator. BusinessProcessVariantTypeCode is a coded representation of a business process variant type of a delivery item, and may be based on datatype GDT: BusinessProcessVariantTypeCode. Example codes include “Of expected delivery”, “Of unexpected delivery”, :Of requested delivery”, and “Of unrequested delivery”. MainIndicator indicates whether a current BusinessProcessVariantType is the main type, and may be based on datatype GDT: Indicator, with a qualifier of Main.

The following specialization associations for navigation may exist: Root, to the node Confirmed Inbound Delivery, with a target cardinality of 1; and Parent, to the node Item, with a target cardinality of 1. In some implementations, exactly one of the instances of the ItemBusinessProcessVariantType is allowed to be indicated as main. In some implementations, an InboundDelivery may have the following codes: “Of expected delivery”, and “Of unexpected delivery”. In some implementations, an OutboundDelivery may have the following codes: “Of requested delivery”, and “Of unrequested delivery”.

Item Business Transaction Document Reference is a reference to a business document or a business document item relevant to a delivery item. The elements located directly at the node Item Business Transaction Document Reference are defined by the inline structure: APDL_S_DEL_IT_BTD_REF_EL. These elements include: BusinessTransactionDocumentReference and BusinessTransactionDocumentRelationshipRoleCode. BusinessTransactionDocumentReference is a reference to an occurrence to one or more business documents that are important for a delivery or a reference to an item within a same business document. BusinessTransactionDocumentReference may be based on datatype GDT: BusinessTransactionDocumentReference. BusinessTransactionDocumentRelationshipRoleCode may be optional, is a coded representation of a role that a referenced document or referenced document item plays in relation to a delivery, and may be based on datatype GDT: BusinessTransactionDocumentRelationshipRoleCode.

The following inbound aggregation relationships may exist: CustomerInvoiceItem, from the business object Customer Invoice/node Item, with a cardinality of C:CN, which is an item in a customer invoice; CustomerRequirementItem, from the business object Customer Requirement/node External Request Item, with a cardinality of C:CN, which is an item of a Customer Requirement; InboundDeliveryRequestItem, from the business object Inbound Delivery Request/node Item, with a cardinality of C:CN, which is an item in an inbound delivery request; InboundDeliveryItem, from the business object Inbound Delivery/node Item, with a cardinality of C:C, which is an item in an inbound delivery; OutboundDeliveryRequestItem, from the business object Outbound Delivery Request/node Item, with a cardinality of C:CN, which is an item in an outbound delivery request; OutboundDeliveryItem, from the business object Outbound Delivery/node Item, with a cardinality of C:C, which is an item in an outbound delivery; ProcurementReleaseOrderItem, from the business object Procurement Release Order/node Item, with a cardinality of C:CN, which is an item of a Procurement Release Order; PurchaseOrderItem, from the business object Purchase Order/node Item, with a cardinality of C:CN, which is an item in a purchase order; PurchasingContractItem, from the business object Purchasing Contract/node Item, with a cardinality of C:CN, which is an item of a Purchasing Contract; SalesOrderItem, from the business object Sales Order/node Item, with a cardinality of C:CN, which is an item in a sales order; and ServiceOrderItem, from the business object Service Order/node Item, with a cardinality of C:CN, which is an item in a service order.

The following specialization associations for navigation may exist: Root, to the node Confirmed Inbound Delivery, with a target cardinality of 1; and Parent, to the node Item, with a target cardinality of 1. In some implementations, the allowed inbound aggregation relationships of the ItemBusinessTransactionDocumentReference depend on an Item specialization and the business object that is derived from the Delivery_Template.

In some implementations, for a Standard Item, the following aggregation relationships are allowed: 1) for Confirmed Outbound Delivery: SalesOrderItem, OutboundDeliveryRequestItem, OutboundDeliveryItem, and ServiceOrderItem; 2) for Outbound Delivery SalesOrderItem, OutboundDeliveryRequestItem, and ServiceOrderItem; 3) for Confirmed Inbound Delivery: PurchaseOrderItem, InboundDeliveryRequestItem, InboundDeliveryItem, ServiceOrderItem, CustomerInvoiceItem, and OutboundDeliveryRequestItem; and 4) for Inbound Delivery: PurchaseOrderItem, InboundDeliveryRequestItem, ServiceOrderItem, CustomerInvoiceItem, and ConfirmedInboundDeliveryItem

In some implementations, for a Return Item, the following aggregation relationships are allowed: 1) for Confirmed Outbound Delivery: PurchaseOrderItem, OutboundDeliveryRequestItem, and OutboundDeliveryItem; 2) for Outbound Delivery: PurchaseOrderItem, and OutboundDeliveryRequestItem; 3) for Confirmed Inbound Delivery: SalesOrderItem, CustomerReturnItem, InboundDeliveryRequestItem, InboundDeliveryItem, and ServiceOrderItem; and 3) for Inbound Delivery: SalesOrderItem, CustomerReturnItem, InboundDeliveryRequestItem, OutboundDeliveryItem, ConfirmedInboundDeliveryItem, and ServiceOrderItem.

In some implementations, for a Service Item, the following aggregation relationships are allowed: 1) for Confirmed Inbound Delivery: CustomerReturnItem, InboundDeliveryRequestItem, InboundDeliveryItem, and ServiceOrderItem; and 2) for Inbound Delivery CustomerReturnItem, InboundDeliveryRequestItem, OutboundDeliveryItem, ConfirmedInboundDeliveryItem, and ServiceOrderItem.

In some implementations, for a Text Item or a Packing Item. the following aggregation relationships are allowed: 1) for Confirmed Outbound Delivery: OutboundDeliveryRequestItem, and OutboundDeliveryItem; 2) for Outbound Delivery, OutboundDeliveryRequestItem; 3) for Confirmed Inbound Delivery: InboundDeliveryRequestItem, and InboundDeliveryItem; and 4) for Inbound Delivery: InboundDeliveryRequestItem, and ConfirmedInboundDeliveryItem.

Item Hierarchy Relationship represents a relationship between a delivery item and a higher-level delivery item. These relationships can result in item hierarchies. A hierarchy relationship can be assigned to a certain hierarchy type, for example, bills of materials or grouping. The elements located directly at the node Item Hierarchy Relationship are defined by the inline structure: APDL_S_DEL_JT_HIER_RELSHP_EL. These elements include: TypeCode and ParentItemUUID. TypeCode is a coded representation of a business type of a hierarchical relationship between items of a delivery, and may be based on datatype GDT: BusinessTransactionDocumentItemHierarchyRelationshipTypeCode. ParentItemUUID is a universal unique identifier of a hierarchically higher-level Item within the DeliveryRequest_Template, and may be based on datatype GDT: UUID.

The following inbound aggregation relationships may exist: ParentItem, from the business object Confirmed Inbound Delivery/node Item, with a cardinality of 1:CN, which is an Item that is a parent of a particular item. The following specialization associations for navigation may exist: Root, to the node Confirmed Inbound Delivery, with a target cardinality of 1; and Parent, to the node Item, with a target cardinality of 1.

Item Party is a natural or legal person, organization, organizational unit, or group that is involved in a delivery item processing in a party role. An item party may 1) store a reference to a business partner or an associated specialization, for example, customer, supplier, or employee; and 2) store a reference to one of the following specializations of an organizational unit: Company, CostCentre, or ReportingLineUnit. In some implementations, an item party may exist without reference to a business partner or an organizational unit. The elements located directly at the node Item Party are defined by the inline structure: APDL_S_DEL_IT_PARTY_EL.

These elements include: PartyKey, PartyUUID, RoleCategoryCode, RoleCode, AddressReference, DeterminationMethodCode, MainIndicator, and Name. PartyKey is a key of a Party in a PartyRole in a business document or a master data object, and may be based on datatype KDT: PartyKey. PartyKey may include PartyKey/PartyTypeCode, which is a coded representation of a type of party, and may be based on datatype GDT: BusinessObjectTypeCode. PartyKey may include PartyKey/PartyID, which is an identifier for a party, and may be based on datatype GDT: PartyID. PartyUUID is a universally unique identifier for a business partner, an organizational unit, or an associated specialization, and may be based on datatype GDT: UUID. RoleCategoryCode may be optional, is a party role category of an ItemParty in a business document or a master data object, and may be based on datatype GDT: PartyRoleCategoryCode. Example codes include “BuyerParty”, which is a party who purchases a good or service; “SellerParty”, which is a party who sells a good or service; and “LogisticsRequestResponsibleParty”, which is a party that is responsible for a logistics request of an item. In some implementations, the ThirdPartySellerParty party role category code is not available in the derived confirmed inbound delivery business object. In some implementations, the ThirdPartySellerParty party role category code is not available in the derived inbound delivery business object. RoleCode may be optional, is a party role of an ItemParty in a business document or a master data object, and may be based on datatype GDT: PartyRoleCode. AddressReference includes information to reference an address of a Party, and may be based on datatype GDT: PartyAddressReference. DeterminationMethodCode may be optional, is a method describing how a party is determined, and may be based on datatype GDT: PartyDeterminationMethodCode. MainIndicator indicates whether an ItemParty is emphasized in a group of parties with a same PartyRole, and may be based on datatype GDT: Indicator, with a qualifier of Main. Name is a name of an ItemParty, and may be based on datatype GDT: LONG_Name.

The following composition relationships to subordinate nodes exist: ItemPartyContactParty, with a cardinality of 1:CN. The following inbound aggregation relationships may exist: Party, from the business object Party/node Party, with a cardinality of C:CN, which is a referenced party in master data. The following specialization associations for navigation may exist: Address Snapshot, to the business object Address Snapshot/node Root, with a target cardinality of C; Root, to the node Confirmed Inbound Delivery, with a target cardinality of 1; Parent, to the node Item, with a target cardinality of 1; MainItemPartyContactParty, to the node Item Party Contact Party, with a target cardinality of C; Used Address Overview, to the business object Used Address/node Overview, with a target cardinality of C, which can be the same as the association to UsedAddress-Root; and Used Address, to the business object Used Address/node Used Address, with a target cardinality of C, which can be an address used for a Party. Used Address can be a referenced address of a master data object. As another example, Used Address can be a PartyAddress used via a composition relationship. A determination can be made as to which of type of Used Address is used by means of the PartyAddressHostTypeCode element. If the Used Address is a referenced address of a master data object, a node ID of a node in the master data object can be determined via the PartyTypeCode, PartyAddressUUID and PartyAddressHostTypeCode elements. If the Used Address is a PartyAddress, UsedAddress can be informed of the BusinessObjectTypeCode, BusinessObjectNodeTypeCode and Node ID of a Party element.

In some implementations, there may be one aggregation relationship to the business partner, the organizational unit, or to associated specializations. In some implementations, if the PartyUUID exists, the PartyTypeCode also exists. In some implementations, Parties may be referenced via a Transformed Object Party that represents at least one of the following business objects: Company, CostCentre, SalesUnit, ServiceUnit, PurchasingUnit, ReportingLineUnit, Supplier, Customer, Employee, or BusinessPartner. In some implementations, there may be one association to an address. The address can be a master data address of a business partner, organizational unit, or associated specialization referenced by a PartyUUID. Parties in various roles may be optionally used in business objects derived from the Delivery_template.

Item Party Contact Party is a natural person or organizational unit that can be contacted for an item party. The contact may be a contact person or, for example, a secretary's office. Communication data for the contact can be available. The elements located directly at the node Item Party Contact Party are defined by the inline structure APDL_S_DEL_IT_PRT_CNTCT_PRT_EL. These elements include: PartyKey, PartyUUID, AddressReference, DeterminationMethodCode, MainIndicator, and Name. PartyKey is a key of a party in a PartyRole in a business document or a master data object, and may be based on datatype KDT: PartyKey. PartyKey can include PartyKey/PartyTypeCode, which is a coded representation of a type of party, and may be based on datatype GDT: BusinessObjectTypeCode. PartyKey can include PartyKey/PartyID, which is an identifier for a party, and may be based on datatype GDT: PartyID. PartyUUID is a universally unique identifier of a contact in a PartyRole in a business document or a master data object, and may be based on datatype GDT: UUID. AddressReference includes information to reference an address of a Party, and may be based on datatype GDT: PartyAddressReference. DeterminationMethodCode may be optional, is a method for how a party is determined, and may be based on datatype GDT: PartyDeterminationMethodCode. MainIndicator indicates whether an ItemPartyContactParty is emphasized in a group of contact parties with a same PartyRole, and may be based on datatype GDT: Indicator, with a qualifier of Main. Name is a name of an ItemPartyContactParty, and may be based on datatype GDT: LONG_Name.

The following inbound aggregation relationships may exist: Address Snapshot, from the business object Address Snapshot/node Root, with a cardinality of CN:CN; and Party, from the business object Party/node Party, with a cardinality of C:CN, which is a referenced party in master data. The following specialization associations for navigation may exist: Root, to the node Confirmed Inbound Delivery, with a target cardinality of 1; Parent, to the node Item Party, with a target cardinality of 1; Used Address Overview, to the business object Used Address/node Overview, with a target cardinality of C, which can be the same as an association to UsedAddress-Root; and Used Address, to the business object Used Address/node Used Address, with a target cardinality of C, which is a used address for a party and may be a referenced address of a master data object or an address referenced via a composition to a PartyAddress. In some implementations, there may be one association to an address. The address can be a master data address of a business partner, organizational unit, or an associated specialization referenced by a PartyUUID.

Item Product is an identification, description and classification of a product in a confirmed or a completed delivery. The elements located directly at the node Item Product are defined by the inline structure APDL_S_DEL_IT_PROD_EL. These elements include: ProductKey, ProductSellerID, ProductStandardID, ProductBuyerID, ProductProductRecipientID, ProductVendorID, IdentifiedStockUUID, IdentifiedStockKey, IdentifiedStockTypeCode, ProductUUID, ProductRequirementSpecificationKey, ProductRequirementSpecificationVersionUUID, and SerialidentifierProvisionRequirementCode.

ProductKey is a unique identifier of a product, and may be based on datatype KDT: ProductKey. ProductKey can include ProductKey/ProductTypeCode, which is a coded representation of a product type such as a material or service, and may be based on datatype GDT: ProductTypeCode. ProductKey can include ProductKey/ProductidentifierTypeCode, which is a coded representation of a product identifier type, and may be based on datatype GDT: ProductidentifierTypeCode. ProductKey can include ProductKey/ProductID, which is an identifier for a product, and may be based on datatype GDT: ProductID. ProductSellerID may be optional, is a unique identifier of a product, can be assigned by a seller, and may be based on datatype GDT: ProductPartyID. ProductStandardID is a unique identifier of a product whereby an identification sheet used is managed by an agency, and may be based on datatype GDT: ProductStandardID. ProductBuyerID may be optional, is a unique identifier of a product assigned by a purchaser, and may be based on datatype GDT: ProductPartyID. ProductProductRecipientID may be optional, is a unique identifier of a product assigned by a goods recipient, and may be based on datatype GDT: ProductPartyID. ProductVendorID may be optional, is a unique identifier of a product assigned by a vendor, and may be based on datatype GDT: ProductPartyID. IdentifiedStockUUID is a universal unique identifier of an identified stock, and may be based on datatype GDT: UUID.

IdentifiedStockKey is a unique identifier of an identified stock, and may be based on datatype KDT: IdentifiedStockKey. IdentifiedStockKey can include IdentifiedStockKey/ID, and may be based on datatype GDT: IdentifiedStockID. IdentifiedStockKey can include IdentifiedStockKey/MaterialKey, is a grouping of elements that uniquely identifies a material, a sub-quantity of which is identified by an identified stock, and may be based on datatype KDT: ProductKey. IdentifiedStockKey/MaterialKey can include IdentifiedStockKey/MaterialKey/ProductTypeCode, which is a coded representation of a product type such as a material or service, and may be based on datatype GDT: ProductTypeCode. IdentifiedStockKey/MaterialKey can include IdentifiedStockKey/MaterialKey/ProductidentifierTypeCode, which is a coded representation of a product identifier type, and may be based on datatype GDT: ProductidentifierTypeCode. IdentifiedStockKey/MaterialKey can include IdentifiedStockKey/MaterialKey/ProductID, which is an identifier for a product, and may be based on datatype GDT: ProductID. IdentifiedStockTypeCode is a type of an identified stock, and may be based on datatype GDT: IdentifiedStockTypeCode. ProductUUID is a universal unique identifier of a product in a delivery request, and may be based on datatype GDT: UUID. ProductRequirementSpecificationKey is a key structure of a requirement specification that combines an identifier of a requirement specification and a corresponding VersionID, and may be based on datatype KDT: RequirementSpecificationKey. ProductRequirementSpecificationKey can include ProductRequirementSpecificationKey/RequirementSpecificationID, which is an identifier for a requirement specification that is unique within a system, and may be based on datatype GDT: RequirementSpecificationID. ProductRequirementSpecificationKey may include ProductRequirementSpecificationKey/RequirementSpecificationVersionID, which is an identifier for a version of a requirement specification, and may be based on datatype GDT: VersionID. ProductRequirementSpecificationVersionUUID is a universally unique identifier of a version of a requirement specification, and may be based on datatype GDT: UUID. SerialidentifierProvisionRequirementCode may be optional, is a coded representation of a requirement to provide a serial identifier serial number, and may be based on datatype GDT: SerialidentifierProvisionRequirementCode.

The following composition relationships to subordinate nodes exist: Item Product Serial Number, with a cardinality of 1:CN. The following inbound aggregation relationships may exist: IdentifiedStock, from the business object Identified Stock/node Identified Stock, with a cardinality of C:CN, which is an identified stock that is requested; Material, from the business object Material/node Material, with a cardinality of C:CN, which is a material that is requested; and ProductRequirementSpecification, from the business object Product Requirement Specification/node Product Requirement Specification, with a cardinality of C:CN, which is a product requirement specification. The following specialization associations for navigation may exist: Root, to the node Confirmed Inbound Delivery, with a target cardinality of 1; Parent, to the node Item, with a target cardinality of 1; and Material Overview, to the business object Material/node Overview, with a target cardinality of C.

Item Product Serial Number is a serial number of an individual product used in an item product of a delivery. The elements located directly at the node Item Product Serial Number are defined by the inline structure APDL_S_DEL_IT_PROD_SERI_NO_EL. These elements include: IndividualProductUUID, IndividualProductSerialIDKey, and DeliveryMaterialUUID. IndividualProductUUID is a universally unique identifier for an individual product to which a serial number belongs, and may be based on datatype GDT: UUID. IndividualProductSerialIDKey is a grouping of elements that uniquely identifies a serial number of an individual product, and may be based on datatype KDT: IndividualProductSerialIDKey. IndividualProductSerialIDKey can include IndividualProductSerialIDKey/ReferenceProductUUID, which may be based on datatype GDT: UUID. IndividualProductSerialIDKey can include IndividualProductSerialIDKey/SerialID, which may be based on datatype GDT: SerialID. DeliveryMaterialUUID is a universally unique identifier for a material in a delivery, and may be based on datatype GDT: UUID. The following inbound aggregation relationships may exist: Delivery Material, from the business object Confirmed Inbound Delivery/node Material, with a cardinality of C:CN, which is a material in a delivery that includes a serial number; and Individual Product, from the business object IndividualProduct/node Root, with a cardinality of C:CN, which is an individual product that uniquely identifies a serial number in a delivery. The following specialization associations for navigation may exist: Root, to the node Confirmed Inbound Delivery, with a target cardinality of 1; and Parent, to the node Item Product, with a target cardinality of 1.

Item Quantity is a quantity of a product to be delivered, for example, a delivery quantity in a sales unit, or a delivery quantity in a delivery unit. The elements located directly at the node Item Quantity are defined by the inline structure: APDL_S_DEL_IT_QUANT_EL. These elements include: Quantity, QuantityTypeCode, QuantityRoleCode, and QuantityOriginCode. Quantity is a quantity with a corresponding unit of measure, and may be based on datatype GDT: Quantity. QuantityTypeCode is a coded representation of a type of a quantity, and may be based on datatype GDT: QuantityTypeCode. QuantityRoleCode is a coded representation of a role of a quantity, and may be based on datatype GDT: QuantityRoleCode. DeliveryQuantity is an example code. QuantityOriginCode may be optional, is a coded representation of an origin of a quantity value, and may be based on datatype GDT: QuantityOriginCode. The following specialization associations for navigation may exist: Root, to the node Confirmed Inbound Delivery, with a target cardinality of 1; and Parent, to the node Item, with a target cardinality of 1.

Item Quantity Discrepancy is a quantity discrepancy between an expected and confirmed quantity and a cause or reason for the discrepancy. The elements located directly at the node Item Quantity Discrepancy are defined by the inline structure: APDL_S_DEL_IT_QUANT_DISCR_EL. These elements include: QuantityTypeCode, QuantityDiscrepancyCode, and Quantity. QuantityTypeCode is a coded representation of a type of a quantity, and may be based on datatype GDT: QuantityTypeCode. QuantityDiscrepancyCode is a coded representation of a cause or reason for a quantity discrepancy, and may be based on datatype GDT: QuantityDiscrepancyCode. Quantity is a quantity of a discrepancy, and may be based on datatype GDT: Quantity. The following specialization associations for navigation may exist: Root, to the node Confirmed Inbound Delivery, with a target cardinality of 1; and Parent, to the node Item, with a target cardinality of 1. In some implementations, the Item Quantity Discrepancy node is present in the projections ConfirmedInboundDelivery and ConfirmedOutboundDelivery.

A location is a physical place which is part of a delivery process in a LocationRole. A location may: store a reference to a business object location; store a reference to an address; store a reference to a business partner or an associated specialization, for example customer, supplier or employee; or store a reference to a Reporting Line Unit specialization of an organizational unit. A location role describes a role of a location in a delivery process. The elements located directly at the node Location are defined by the data type DeliveryLocationElements. These elements include: LocationID, LocationUUID, AddressReference, RoleCode, RoleCategoryCode, and DeterminationMethodCode.

AddressReference can include AddressReference/AddressHostUUID, AddressReference/AddressHostTypeCode, AddressReference/InstalledBaseID, AddressReference/InstallationPointID, and AddressReference/PartyKey. LocationID may be optional, is an identifier of a Location in a LocationRole, and may be based on datatype GDT: LocationID. LocationUUID may be optional, is a universally unique identifier for a location, business partner, organizational unit, or an associated specialization, and may be based on datatype GDT: UUID. AddressReference may be optional, includes information to reference an address of a Location, and may be based on datatype BOIDT: ObjectNodeLocationAddressReference. AddressReference/AddressHostUUID may be optional, is a universally unique identifier for an address of a business partner, an organizational unit, an associated specialization, the business object InstalledBase, or the business object InstallationPoint, and may be based on datatype GDT: UUID. AddressReference/AddressHostTypeCode may be optional, is a coded representation of an address host type of an address referenced by the AddressUUID or an address included using a Location Address composition, and may be based on datatype GDT: AddressHostTypeCode. AddressReference/InstalledBaseID may be optional, is an identifier for an installed base that references an address using the AddressUUID, and may be based on datatype GDT: InstalledBaseID. AddressReference/InstallationPointID may be optional, is an identifier for an installation point that references an address using the AddressUUID, and may be based on datatype GDT: InstallationPointID. AddressReference/PartyKey may be optional, is an alternative identifier of a party that represents a business partner, or of an organizational unit that references an address using the AddressUUID, and may be based on datatype KDT: PartyKey. AddressReference/PartyKey can include AddressReference/PartyKey/PartyTypeCode, which is a coded representation of a type of party, and may be based on datatype GDT: BusinessObjectTypeCode. AddressReference/PartyKey can include AddressReference/PartyKey/PartyID, which is an identifier for a party, and may be based on datatype GDT: PartyID. RoleCode is a location role of a Location, and may be based on datatype GDT: LocationRoleCode. RoleCategoryCode is a location role category of a Location, and may be based on datatype GDT: LocationRoleCategoryCode. In some implementations, the code ShipFromLocation is used, which is a location from which a good is shipped. In some implementations, the code ShipToLocation is used, which is a location to which a good is shipped. DeterminationMethodCode may be optional, is a method describing how a location is determined, and may be based on datatype GDT: LocationDeterminationMethodCode.

The following composition relationships to subordinate nodes exist: Location Alternative Identification, with a cardinality of 1:CN. The following inbound aggregation relationships may exist: InstallationPointAddressInformation, from the business object Installation Point/node Address Information, with a cardinality of C:CN, which is AddressInformation of an installation point corresponding to a Location; InstalledBaseAddressInformation, from the business object Installed Base/node Address Information, with a cardinality of C:CN, which is AddressInformation of an Installed Base corresponding to a Location; Location, from the business object Location/node Location, with a cardinality of C:CN, which is a location corresponding to a Location; and PartyAddressInformation, from the business object Party/node Address Information, with a cardinality of C:CN, which is AddressInformation of a representative of a Business Partner or Organizational Centre corresponding to a Location. The following specialization associations for navigation may exist: Address Snapshot, to the business object Address Snapshot/node Root, with a target cardinality of C; Parent, to the node Confirmed Inbound Delivery, with a target cardinality of 1; Root, to the node Confirmed Inbound Delivery, with a target cardinality of 1; Used Address Overview, to the business object Used Address/node Overview, with a target cardinality of C; which may be the same as an association to UsedAddress-Root; and Used Address, to the business object Used Address/node Used Address, with a target cardinality of C, which is an address used for a location. The address can be a referenced address of a master data object or an address that is integrated via the composition relationship LocationAddress. A determination can be made as to which address applies, by examining the value of the element AddressHostTypeCode.

In some implementations, one aggregation or composition relationship to the dependent object exists. In some implementations, if there is an aggregation relationship to the business object Location, the LocationID attribute is filled with the identifier of the business object Location and other identification fields, such as PartyID, InstalledBaseID and InstallationPointID, can remain blank. In some implementations, if the address of a party is referenced representative of a business partner or an OrganisationalCentre, the PartyID attribute is filled with the identifier of a Party and other ID fields, such as LocationID, InstalledBaseID and InstallationPointID, can remain blank. In some implementations, a reference is stored in the AddressUUID attribute. In some implementations, if there is an aggregation relationship to the address of an InstalledBase, the InstalledBaseID attribute is filled with the ID of the InstalledBase and other ID fields, such as LocationID, PartyID and InstallationPointID, can remain blank. A reference can be stored in the AddressUUID InstalledBaseAddressInformationUUID attribute. In some implementations, if there is an aggregation relationship to the address of an InstallationPoint, the InstallationPointID attribute can be filled with the ID of the InstallationPoint and other ID fields, such as LocationID, PartyID and InstalledBaseID, can remain blank. A reference can be stored in the AddressUUID attribute. In some implementations, if an address is referenced via the element AddressUUID, then elements AddressBusinessObjectTypeCode and AddressHostTypeCode are also filled.

Location Alternative Identification is an alternative identification to an identified location in a Location node. The elements located directly at the node Location Alternative Identification are defined by the inline structure: APDL_S_DEL_LOC_ALT_IDENT. These elements include: LocationID, LocationidentifierTypeCode, IdentifiedByPartyRoleCode, and IdentifiedByPartyRoleCategoryCode. LocationID is an alternative identifier of a location identified in Location, and may be based on datatype GDT: LocationID. LocationidentifierTypeCode may be optional, is a coded representation of a type of Location identifier, and may be based on datatype GDT: LocationidentifierTypeCode. IdentifiedByPartyRoleCode may be optional, is a role code of a party that identifies a location, and may be based on datatype GDT: PartyRoleCode, with a qualifier of IdentifiedBy. IdentifiedByPartyRoleCategoryCode may be optional, is a role category code of a party that identifies a location, and may be based on datatype GDT: PartyRoleCategoryCode, with a qualifier of IdentifiedBy. The following specialization associations for navigation may exist: Root, to the node Confirmed Inbound Delivery, with a target cardinality of 1; and Parent, to the node Location, with a target cardinality of 1. In some implementations, either the LocationidentifierTypeCode or both type codes IdentifiedByPartyRoleCategoryCode and IdentifiedByPartyRoleCode are filled.

A Logistic package is a physical unit that includes a packaging material load carrier, additional packaging material, and a product to be packed of type “material”. The elements located directly at the node Logistic package are defined by the inline structure APDL_S_DEL_LOG_PACK_EL. These elements include: UUID, TypeCode, LogisticUnitUUID, LogisticUnitID, ParentLogisticpackageUUID, QuantityTypeCode, Quantity, and LogisticUnitQuantityVariationCode.

UUID may be an alternative key, is a generally unique identification of a Logisticpackage node for referencing purposes, and may be based on datatype GDT: UUID. A TypeCode is a coded representation of a type of a packing unit as it is used in logistics for storing and shipping goods, and may be based on datatype GDT: LogisticpackageTypeCode. Example codes include Logistic Unit which is a non-identifiable, physical, logistical unit, such as unlabeled boxes, and Identified Logistic Unit, which is an identifiable, physical unit, such as a clearly labeled container or palette. LogisticUnitUUID is a generally unique identification of a Logistic Unit, and may be based on datatype GDT: UUID. LogisticUnitID is an identification of a logistic unit, and may be based on datatype GDT: LogisticUnitID. ParentLogisticpackageUUID is a generally unique identification of a parent Logisticpackage, and may be based on datatype GDT: UUID. QuantityTypeCode is a type of quantity that is based on a measurable characteristic of an object or physical phenomenon, and may be based on datatype GDT: QuantityTypeCode. Quantity is a number of Logistic Units, and may be based on datatype GDT: INTEGER Quantity. LogisticUnitQuantityVariationCode may be optional, is a coded representation of a logistic unit's quantity variation for quantity-based processing, and may be based on datatype GDT: LogisticUnitQuantityVariationCode. The following composition relationships to subordinate nodes exist: LogisticpackageMeasure, with a cardinality of 1:CN. The following inbound aggregation relationships may exist: IdentifiedLogisticUnit, from the business object Identified Logistic Unit/node Identified Logistic Unit, with a cardinality of C:CN, which is from the Identified Logistic Unit node Root; and LogisticUnit, from the business object Logistic Unit/node Logistic Unit, with a cardinality of C:CN, which is from the business object LogisticUnit node Root. A Parent Logistic Package inbound association relationship may exist from the business object Confirmed Inbound Delivery/node Logistic package, with a cardinality of C:CN, which is a Logistic package that is a parent of a logistic package. The following specialization associations for navigation may exist: Parent, to the node Confirmed Inbound Delivery, with a target cardinality of 1; Root, to the node Confirmed Inbound Delivery with a target cardinality of 1; Logistic package, to the node Logistic package, with a target cardinality of CN; and Material, to the node Material, with a target cardinality of CN, which represents goods included in a Logistic package's materials. The following specialization associations for navigation may exist to the node Logistic package Measure: GrossVolumeLogisticpackageMeasure, with a target cardinality of C; GrossWeightLogisticpackageMeasure, with a target cardinality of C; HeightLogisticpackageMeasure, with a target cardinality of C; LengthLogisticpackageMeasure, with a target cardinality of C; NetVolumeLogisticpackageMeasure, with a target cardinality of C; NetWeightLogisticpackageMeasure, with a target cardinality of C; TareWeightLogisticpackageMeasure, with a target cardinality of C; and WidthLogisticpackageMeasure, with a target cardinality of C. In some implementations, either LogisticUnitUUID or IdentifiedLogisticUnitUUID are filled. In some implementations, an association for navigation to GoodsTagAssignment is only available in the derived projection Outbound Delivery.

Logistic Package Measure is a measure used with a Logistic package. The elements located directly at the node Logistic package Measure are defined by the inline structure APDL_S_DEL_LOG_PACK_MEAS_EL. These elements include: Measure, MeasureTypeCode, and QuantityOriginCode. Measure is a physical measurement with a corresponding unit of measure, and may be based on datatype GDT: Measure. MeasureTypeCode is a coded representation of a type of a measure, and may be based on datatype GDT: MeasureTypeCode. QuantityOriginCode is a coded representation of an origin of a measure value, and may be based on datatype GDT: QuantityOriginCode. The following specialization associations for navigation may exist: Root, to the node Confirmed Inbound Delivery, with a target cardinality of 1; and Parent, to the node Logistic package, with a target cardinality of 1.

Material is an identification, description and classification of materials in a confirmed or a completed delivery. In addition to materials ordered, Material also includes packing materials, for example, load carriers or auxiliary packing material. Material includes materials included in a handling unit or logistic unit and materials not included in a handling unit or logistic unit. A Material rather than a product can be referred to because a material is physically grouped or packed. The elements located directly at the node Material are defined by the inline structure: APDL_S_DEL_MAT_EL. These elements include: UUID, ProductUUID, ProductKey, ItemUUID, LogisticpackageUUID, IdentifiedStockUUID, IdentifiedStockKey, IdentifiedStockTypeCode, ProductRequirementSpecificationKey, and ProductRequirementSpecificationVersionUUID.

UUID may be an alternative key, is a generally unique identification of a Material node for referencing purposes, and may be based on datatype GDT: UUID. ProductUUID is a generally unique identification of a product, and may be based on datatype GDT: UUID. ProductKey is a unique identifier of a material, and may be based on datatype KDT: ProductKey. ProductKey can include ProductKey/ProductTypeCode, which is a coded representation of a product type, such as a material or service, and may be based on datatype GDT: ProductTypeCode. ProductKey can include ProductKey/ProductidentifierTypeCode, which is a coded representation of a product identifier type, and may be based on datatype GDT: ProductidentifierTypeCode. ProductKey can include ProductKey/ProductID, which is an identifier for a product, and may be based on datatype GDT: ProductID. ItemUUID is a generally unique identification of an item to which a material refers, and may be based on datatype GDT: UUID. LogisticpackageUUID is a generally unique identification of a Logistic package node to which a material belongs, and may be based on datatype GDT: UUID. IdentifiedStockUUID is a universal unique identifier of an identified stock, and may be based on datatype GDT: UUID. I

IdentifiedStockKey is a unique identifier of an identified stock, and may be based on datatype KDT: IdentifiedStockKey. IdentifiedStockKey can include IdentifiedStockKey/ID, which may be based on datatype GDT: IdentifiedStockID. IdentifiedStockKey can include IdentifiedStockKey/MaterialKey, which is a grouping of elements that uniquely identifies a material, a sub-quantity of which is identified by the identified stock, and may be based on datatype KDT: ProductKey. IdentifiedStockKey/MaterialKey can include IdentifiedStockKey/MaterialKey/ProductTypeCode, which is a coded representation of a product type, such as a material or service, and may be based on datatype GDT: ProductTypeCode. IdentifiedStockKey/MaterialKey can include IdentifiedStockKey/MaterialKey/ProductidentifierTypeCode, which is a coded representation of a product identifier type, and may be based on datatype GDT: ProductidentifierTypeCode. IdentifiedStockKey/MaterialKey can include IdentifiedStockKey/MaterialKey/ProductID, which is an identifier for a product, and may be based on datatype GDT: ProductID. IdentifiedStockTypeCode is a type of an identified stock, and may be based on datatype GDT: IdentifiedStockTypeCode. ProductRequirementSpecificationKey is a key structure of a requirement specification that combines an identifier of a requirement specification and a corresponding VersionID, and may be based on datatype KDT: RequirementSpecificationKey. ProductRequirementSpecificationKey may include ProductRequirementSpecificationKey/RequirementSpecificationID, is an identifier for a requirement specification that is unique within a system, and may be based on datatype GDT: RequirementSpecificationID. ProductRequirementSpecificationKey may include ProductRequirementSpecificationKey/RequirementSpecificationVersionID, which is an identifier for a version of a requirement specification, and may be based on datatype GDT: VersionID. ProductRequirementSpecificationVersionUUID is a universally unique identifier of a version of a requirement specification, and may be based on datatype GDT: UUID.

The following composition relationships to subordinate nodes exist: MaterialMeasure, with a cardinality of 1:CN; MaterialQuantity, with a cardinality of 1:CN; and MaterialQuantityDiscrepancy, with a cardinality of 1:CN. The following inbound aggregation relationships may exist: Item, from the business object Confirmed Inbound Delivery/node Item, with a cardinality of C:CN, which can be related to the assigning of one or several materials of a Material node to a delivery item whereby no material is assigned to delivery items of a specialization TextItem. Not every material of the Material node might be assigned to a delivery item, for example, a packing that is not relevant to invoicing. The following inbound aggregation relationships may exist: Logisticpackage, from the business object Confirmed Inbound Delivery/node Logistic package, with a cardinality of C:CN, which assigns one or several materials of a Material node to a logistic package; IdentifiedStock, from the business object Identified Stock/node Identified Stock, with a cardinality of C:CN, which is an Identified Stock that is requested; Material, from the business object Material/node Material, with a cardinality of C:CN, which is a Material that is requested; ProductRequirementSpecification, from the business object Product Requirement Specification/node Product Requirement Specification, with a cardinality of C:CN, which is a product requirement specification. The following specialization associations for navigation may exist: Parent, to the node Confirmed Inbound Delivery, with a target cardinality of 1; Root, to the node Confirmed Inbound Delivery, with a target cardinality of 1; Goods Tag Assignment, to the node Goods Tag Assignment, with a target cardinality of CN; ProductRequirementSpecification, to business object ProductRequirementSpecification/node Root, with a target cardinality of CN; Item Product Serial Number, to the node Item Product Serial Number, with a target cardinality of CN, which is a product serial number that is included in a material; DeliveryMaterialQuantity, to the node Material Quantity, with a target cardinality of C, Restricted Material Quantity, to the node Material Quantity, with a target cardinality of C; and Material Overview, to the business object Material/node Overview, with a target cardinality of C. The following specialization associations for navigation may exist to the node Material Measure: GrossVolumeMaterialMeasure, with a target cardinality of C; GrossWeightMaterialMeasure, with a target cardinality of C; HeightMaterialMeasure, with a target cardinality of C; LengthMaterialMeasure, with a target cardinality of C; NetVolumeMaterialMeasure, with a target cardinality of C; NetWeightMaterialMeasure, with a target cardinality of C; TareWeightMaterialMeasure, with a target cardinality of C; and WidthMaterialMeasure, with a target cardinality of C. In some implementations, either ItemUUID or LogisticpackageUUID is provided.

Material Measure represents measurements of a material. Measurements can be, for example, weight, length, or volume. The elements located directly at the node Material Measure are defined by the inline structure: APDL_S_DEL_MAT_MEAS_EL. These elements include: Measure, MeasureTypeCode, and QuantityOriginCode. Measure is a physical measurement with a corresponding unit of measure, and may be based on datatype GDT: Measure. MeasureTypeCode is a coded representation of a type of a measure, and may be based on datatype GDT: MeasureTypeCode. QuantityOriginCode may be optional, is a coded representation of an origin of a measure value, and may be based on datatype GDT: QuantityOriginCode. The following specialization associations for navigation may exist: Root, to the node Confirmed Inbound Delivery, with a target cardinality of 1; and Parent, to the node Material, with a target cardinality of 1.

Material Quantity is a quantity of material used for a delivery. A material can be managed in several, non-transferable units of measure or catch weight. The elements located directly at the node Material Quantity are defined by the inline structure: APDL_S_DEL_MAT_QUANT_EL. These elements include: Quantity, QuantityTypeCode, QuantityRoleCode, and QuantityOriginCode. Quantity is a quantity with a corresponding unit of measure, and may be based on datatype GDT: Quantity. QuantityTypeCode is a coded representation of a type of a quantity, and may be based on datatype GDT: QuantityTypeCode. QuantityRoleCode is a coded representation of a role of a quantity, and may be based on datatype GDT: QuantityRoleCode. An example code is DeliveryQuantity. QuantityOriginCode may be optional, is a coded representation of an origin of a quantity value, and may be based on datatype GDT: QuantityOriginCode. The following specialization associations for navigation may exist: Root, to the node Confirmed Inbound Delivery, with a target cardinality of 1; and Parent, to the node Material, with a target cardinality of 1. In some implementations, a complete delivery quantity of all materials from a Material that refer to a material in an ItemProduct correspond to a delivery quantity in the element ItemQuantity.

Material Quantity Discrepancy is a quantity discrepancy between an expected and a confirmed quantity and a cause or reason for the discrepancy. The elements located directly at the node Material Quantity Discrepancy are defined by the inline structure: APDL_S_DEL_MAT_QUANT_DISCR_EL. These elements include: QuantityTypeCode, QuantityDiscrepancyCode, and Quantity. QuantityTypeCode is a coded representation of a type of a quantity, and may be based on datatype GDT: QuantityTypeCode. QuantityDiscrepancyCode is a coded representation of a cause or reason for a quantity discrepancy, and may be based on datatype GDT: QuantityDiscrepancyCode. Quantity is a quantity of a discrepancy, and may be based on datatype GDT: Quantity. The following specialization associations for navigation may exist to the node Confirmed Inbound Delivery: Root, with a target cardinality of 1; and Parent, to the node Material. with a target cardinality of 1.

Party is a natural or legal person, organization, organizational unit, or group that is involved in a delivery processing in a party role. A party may: store a reference to a business partner or one of its specializations, for example, customer, supplier, employee; store a reference to one of the following specializations of an organizational unit: Company, Cost Centre, or Reporting Line Unit; and exist without reference to a business partner or an organizational unit. The elements located directly at the node Party are defined by the data type DeliveryPartyElements. These elements include: PartyKey, PartyUUID, RoleCategoryCode, RoleCode, AddressReference, DeterminationMethodCode, MainIndicator, and Name.

PartyKey may be optional, is a key of a Party in a PartyRole in a business document or a master data object, and may be based on datatype KDT: PartyKey. PartyKey can include PartyKey/PartyTypeCode, which is a coded representation of a type of party, and may be based on datatype GDT: BusinessObjectTypeCode. PartyKey can include PartyKey/PartyID, which is an identifier for a party, and may be based on datatype GDT: PartyID. PartyUUID may be optional, is a universally unique identifier for a business partner, an organizational unit, or an associated specialization, and may be based on datatype GDT: UUID. RoleCategoryCode may be optional, is a Party Role Category of a Party in a business document or a master data object, and may be based on datatype GDT: PartyRoleCategoryCode. Example codes include BuyerParty, which is a party who purchases a good or service; SellerParty, which is a party who sells a good or service; ProductRecipientParty, which is a party to whom a good is delivered or for whom a service is provided; Vendor Party, which is a party who delivers a good or who provides a service; CarrierParty, which is a party responsible for a shipment of a good; FreightForwarderParty, which is a party responsible for organizing a shipment of a good; InboundLogisticsUnitParty, which is a party that is responsible for managing an inbound logistics process; and OutboundLogisticsUnitParty, which is a party that is responsible for managing an outbound logistics process. RoleCode may be optional, is a party role of a Party in a business document or a master data object, and may be based on datatype GDT: PartyRoleCode. AddressReference may be optional, includes information to reference an address of a Party, and may be based on datatype GDT: PartyAddressReference. DeterminationMethodCode may be optional, is a method describing how a party is determined, and may be based on datatype GDT: PartyDeterminationMethodCode. MainIndicator indicates whether a Party is emphasized in a group of parties with a same PartyRole, and may be based on datatype GDT: Indicator, with a qualifier of Main. Name may be optional, is a name of a Party, and may be based on datatype GDT: Name.

The following composition relationships to subordinate nodes exist: Party Alternative Identification, with a cardinality of 1:CN; and PartyContactParty, with a cardinality of 1:CN. The following inbound aggregation relationships may exist: Party, from the business object Party/node Party, with a cardinality of C:CN, which is a referenced Party in master data. The following specialization associations for navigation may exist: Address Snapshot, to the business object Address Snapshot/node Root, with a target cardinality of C; Parent, to the node Confirmed Inbound Delivery, with a target cardinality of 1; Root, to the node Confirmed Inbound Delivery, with a target cardinality of 1; MainPartyContactParty, to the node Party Contact Party, with a target cardinality of C, which is a party marked as a main contact; Used Address Overview, to the business object Used Address/node Overview, with a target cardinality of C, which may be the same as an association to UsedAddress-Root; and Used Address, to the business object Used Address/node Used Address, with a target cardinality of C, which is an address used for a Party.

In some implementations, if the PartyUUID exists, the PartyTypeCode also exists. Parties may be referenced via the Transformed Object Party, and may represent at least one of the following business objects: Company, CostCentre, SalesUnit, ServiceUnit, PurchasingUnit, ReportingLineUnit, Supplier, Customer, Employee, or BusinessPartner. In some implementations, there is one association to the address. The address can be a master data address of a business partner, organizational unit, or an associated specialization referenced by PartyUUID. BuyerParty, SellerParty and ThirdPartySellerParty can serve as default values for an ItemParty node.

Party Alternative Identification is an alternative identification to an identified party in a Party node. The elements located directly at the node Party Alternative Identification are defined by the inline structure: APDL_S_DEL_PRT_ALT_IDENT. These elements include: PartyID, PartyidentifierTypeCode, IdentifiedByPartyRoleCode, and IdentifiedByPartyRoleCategoryCode. PartyID is an identifier of an alternative identified party, and may be based on datatype GDT: NOALPHANUMERICCONVERSION_PartyID. PartyidentifierTypeCode is a coded representation of a type of identifier for a party, and may be based on datatype GDT: PartyidentifierTypeCode. IdentifiedByPartyRoleCode may be optional, is a role code of a party that identifies a party, and may be based on datatype GDT: PartyRoleCode, with a qualifier of IdentifiedBy. IdentifiedByPartyRoleCategoryCode may be optional, is a role category code of a party that identifies a party, and may be based on datatype GDT: PartyRoleCategoryCode, with a qualifier of IdentifiedBy. The following specialization associations for navigation may exist: Root, to the node Confirmed Inbound Delivery, with a target cardinality of 1; and Parent, to the node Party, with a target cardinality of 1. In some implementations, either the PartyidentifierTypeCode or both IdentifiedByPartyRoleCode and IdentifiedByPartyRoleCategoryCode are filled.

Party Contact Party is a natural person or organizational unit that can be contacted for a party. The contact may be a contact person or, for example, a secretary's office. Communication data for the contact can be available. The elements located directly at the node Party Contact Party are defined by the inline structure: APDL_S_DEL_CNTCT_PRT_EL. These elements include: PartyKey, PartyUUID, AddressReference, DeterminationMethodCode, MainIndicator, and Name. PartyKey is a key of a Party in as PartyRole in a business document or a master data object, and may be based on datatype KDT: PartyKey. PartyKey can include PartyKey/PartyTypeCode, which is a coded representation of a type of party, and may be based on datatype GDT: BusinessObjectTypeCode. PartyKey may include PartyKey/PartyID, which is an identifier for a party, and may be based on datatype GDT: PartyID. PartyUUID is a universally unique identifier of a contact in a PartyRole in a business document or a master data object, and may be based on datatype GDT: UUID. AddressReference includes information to reference an address of a Party, and may be based on datatype GDT: PartyAddressReference. DeterminationMethodCode may be optional, is a method describing how a party is determined, and may be based on datatype GDT: PartyDeterminationMethodCode. MainIndicator indicates whether a PartyContactParty is emphasized in a group of contact parties with a same PartyRole, and may be based on datatype GDT: Indicator, with a qualifier of Main. Name is a name of a PartyContactParty, and may be based on datatype GDT: LONG_Name. The following inbound aggregation relationships may exist: Address Snapshot, from the business object Address Snapshot/node Root, with a cardinality of CN:CN; and Party, from the business object Party/node Party, with a cardinality of C:CN, which is a referenced Party in master data. The following specialization associations for navigation may exist: Root, to the node Confirmed Inbound Delivery, with a target cardinality of 1; Parent, to the node Party, with a target cardinality of 1; Used Address Overview, to the business object Used Address/node Overview, with a target cardinality of C, which may be equal to an association to UsedAddress-Root; and Used Address, to the business object Used Address/node Used Address, with a target cardinality of C, which is a Used address for a Party which may be a referenced address of a master data object or an address referenced via the composition to PartyAddress. In some implementations, there is one association to the address. The address can be a master data address of a business partner, organizational unit, or an associated specialization referenced by PartyUUID.

Total Measure includes total measurements of a delivery that can be calculated from a physical grouping of materials. Example total measures are weight and volume. The elements located directly at the node Total Measure are defined by the inline structure: APDL_S_DEL_TOTAL_MEAS_EL. These elements include: Measure, MeasureTypeCode, and QuantityOriginCode. Measure is a physical measurement with a corresponding unit of measure, and may be based on datatype GDT: Measure. MeasureTypeCode is a coded representation of a type of a measure, and may be based on datatype GDT: MeasureTypeCode. QuantityOriginCode may be optional, is a coded representation of an origin of a measure value, and may be based on datatype GDT: QuantityOriginCode. The following specialization associations for navigation may exist to the node Confirmed Inbound Delivery: Parent, with a target cardinality of 1; and Root, with a target cardinality of 1.

Transportation Terms are conditions and agreements negotiated when an order is placed that are valid for transportation or for services and activities required for transportation. The elements located directly at the node Transportation Terms are defined by the inline structure: APDL_S_DEL_TRANSP_TERMS_EL. These elements include: TransportServiceLevelCode, TransportModeCode, TransportMeans, Description, and TransportTracking. TransportServiceLevelCode is a coded representation of agreed or defined services in terms of a transport of a delivery as part of an ordered service, such as refrigeration or overnight delivery, and may be based on datatype GDT: TransportServiceLevelCode. TransportModeCode may be optional, is a coded representation of a transport mode of a delivery, and may be based on datatype GDT: TransportModeCode. TransportMeans is a description of a means of transport, which may include information to identify a means of transport, and may be based on datatype GDT: TransportMeans. Description is a natural-language representation of characteristics of transport conditions of a delivery, and may be based on datatype GDT: LONG_Description, with a qualifier of TransportationTerms. TransportTracking is an identifier for tracking deliveries, and may be based on datatype GDT: TransportTracking. The following specialization associations for navigation may exist to the node Confirmed Inbound Delivery: Parent, with a target cardinality of 1; and Root, with a target cardinality of 1.

A number of implementations have been described. Nevertheless, it will be understood that various modifications may be made without departing from the spirit and scope of the disclosure. Accordingly, other implementations are within the scope of the following claims.

1. A computer readable medium including program code for providing a message-based interface for exchanging information about confirmation of goods received, the medium comprising:
program code for receiving via a message-based interface derived from a common business object model, where the common business object model includes business objects having relationships that enable derivation of message-based interfaces and message packages, the message-based interface exposing at least one service as defined in a service registry and from a heterogeneous application executing in an environment of computer systems providing message-based services, a first message for providing a confirmation by a warehouse provider of goods received, the first message including a first message package derived from the common business object model, the first message package hierarchically organized in memory based on the common business object model, the first message package including:
an inbound delivery execution confirmation message entity; and
an inbound delivery execution package including an inbound delivery execution entity, a party package, an arrival period package, and an item package, wherein the inbound delivery execution entity includes an identifier (ID), a vendor ID, a type code, and a sender last change date time, wherein the party package includes a vendor party entity and a product recipient party entity, wherein the arrival period package includes an arrival date time period entity, wherein the item package includes at least one item entity and a product information package, wherein each item entity includes an item entity ID, an item entity vendor ID, an item entity delivery quantity, and an item entity delivery quantity type code, and wherein the product information package includes a product entity;
program code for processing the first message according to the hierarchical organization of the first message package, where processing the first message includes unpacking the first message package based on the first message package's structure and the first message package's derivation from the common business object model, wherein the particular structure of the first message package is used at least in part to identify the purpose of the first message; and
program code for sending a second message to the heterogeneous application responsive to the first message, where the second message includes a second message package derived from the common business object model to provide consistent semantics with the first message package.

2. The computer readable medium of claim 1, wherein the inbound delivery execution entity further includes at least one of the following: a freight forwarder party entity from the party package, a ship to location entity from a location package, a text collection entity from a text collection package, an attachment folder entity from an attachment folder package, and at least one material entity from a product information package.

3. The computer readable medium of claim 1, wherein the inbound delivery execution entity further includes at least one of the following: international commercial terms (Incoterms), a gross volume measure, and a gross weight measure.

4. A distributed system operating in a landscape of computer systems providing message-based services defined in a service registry, the system comprising:
at least one processor operable to execute computer readable instructions embodied on non-transitory media;
a graphical user interface executable by the at least one processor and comprising computer readable instructions, embedded on non-transitory media, for providing a confirmation by a warehouse provider of goods received, the instructions using a request;
a first memory storing a user interface controller executable by the at least one processor for processing the request and involving a message including a message package derived from a common business object model, where the common business object model includes business objects having relationships that enable derivation of message-based service interfaces and message packages, the message package hierarchically organized based on the common business object model, the hierarchical organization of the message package including:
an inbound delivery execution confirmation message entity; and
an inbound delivery execution package including an inbound delivery execution entity, a party package, an arrival period package, and an item package, wherein the inbound delivery execution entity includes an identifier (ID), a vendor ID, a type code, and a sender last change date time, wherein the party package includes a vendor party entity and a product recipient party entity, wherein the arrival period package includes an arrival date time period entity, wherein the item package includes at least one item entity and a product information package, wherein each item entity includes an item entity ID, an item entity vendor ID, an item entity delivery quantity, and an item entity delivery quantity type code, and wherein the product information package includes a product entity; and
a second memory, remote from the graphical user interface, storing a plurality of service interfaces executable by the at least one processor and derived from the common business object model to provide consistent semantics with messages derived from the common business object model, wherein one of the service interfaces is operable to process the message via the service interface according to the hierarchical organization of the message package, where processing the message includes unpacking the first message package based on the message package's structure and the message package's derivation from the common business object model, wherein the particular structure of the message package is used at least in part to identify the purpose of the message.

5. The distributed system of claim 4, wherein the first memory is remote from the graphical user interface.

6. The distributed system of claim 4, wherein the first memory is remote from the second memory.
